(19) United States
(12) Patent Application Publication
(10) Pub. No.: US 2007/0201130 A1
(43) Pub. Date: Aug. 30, 2007

(54) Living-specimen observation and measurement system and living-specimen observation and measurement method

(76) Inventors: Akiko Fujinoki, Tokorozawa-shi (JP); Kayuri Muraki, Hachioji-shi (JP)

Correspondence Address: KENYON & KENYON LLP, ONE BROADWAY, NEW YORK, NY, 10004, US

(21) Appl. No.: 11/701,621

(22) Filed: Feb. 2, 2007

(30) Foreign Application Priority Data
Feb. 7, 2006 (JP) 2006-030317

(51) Int. Cl. G02B 21/34

(52) U.S. Cl. 359/398

(57) ABSTRACT

The present invention provides a living-specimen observation and measurement system for storing a predetermined observation condition and controlling the predetermined observation condition based on an activity specific to a living specimen. The predetermined observation condition is information (items) about, for example, observation and culturing. More specifically, the predetermined observation condition includes the type of a living specimen, the incubation temperature, the pH, the seeding concentration, the cell density, time elapsed from seeding, the fluorochrome type, the fluorochrome concentration, the presence of delivered drug, the amount of light radiated onto the living specimen (e.g., irradiation light intensity per cell, irradiation light illuminance, etc.), the wavelength of irradiation light, the continuity of irradiation light (CW, pulse frequency, pulse width), the duration of a single irradiation, the number of observations, the observation interval, and so forth. A living specimen denotes, for example, a living tissue (biological tissue) and a living cell (biological cell). The living specimen may be cultured cells or tissues extracted from a living organism. Alternatively, the living specimen may be a living organism for in-vivo (in the body a living organism) examination.

### BACKGROUND OF THE INVENTION

1. Field of the Invention

The present invention relates to a living-specimen observation and measurement system and to a living-specimen observation and measurement method for observing and measuring living specimens over time.

This application is based on Japanese Patent Application No. 2006-030317, the content of which is incorporated herein by reference.

2. Description of Related Art

Systems for observing and measuring (hereinafter, referred to simply as “observing”) living specimens over time provide various functions. More specifically, these systems provide techniques for culturing a group of cells originating from a particular single cell; culturing and observing cells while identifying interacting cells during cell culturing; culturing cells while maintaining a constant cell concentration; dispersing substances which interact with cells, for example, drugs such as signal substances, to only particular cells of a group of cultured cells to observe differences between cells to which such signal substances have been dispersed and other cells; and so forth.

In order to achieve these techniques, typical systems for observing living specimens include a cell culture vessel provided with a cell culture section having a well formed on a substrate, a semipermeable membrane covering the top surface of the cell culture section, and a culture-medium replacing section disposed above the semipermeable membrane; means for supplying a cell culture medium to the cell culture vessel; and micro-optical means for observing cells in the cell culture section for an extended period of time.

Fluorescence endoscopes are also used to examine living organisms. In these fluorescence endoscopes, a fluorescent agent is injected into a living organism and a fluorescence image is detected to diagnose, from the fluorescence image, a disease state (the type of the disease or the degree of progression of the disease) related to, for example, degeneration or cancer of living tissues.

The activities of living specimens easily deteriorate and are affected by the environment. For example, some living specimens are so sensitive to light that they are easily killed if exposed to light for a certain period of time. In other words, some living specimens are characterized in that their activities are degraded due to light. In short, irradiation light is toxic to some living specimens.

### BRIEF SUMMARY OF THE INVENTION

The present invention provides the following solutions.

According to one aspect of the present invention, a living-specimen observation and measurement system stores a predetermined observation condition and controls the predetermined observation condition based on an activity of a living specimen.

According to another aspect of the present invention, a living-specimen observation and measurement system includes: a culture unit configured to hold a living specimen; an illumination unit configured to guide irradiation light to the culture unit; an imaging unit configured to acquire an image of the culture unit; and a processing unit including a storage section for storing an acquired image or a predetermined observation condition, an arithmetic section, and a control section for controlling the culture unit, the illumination unit, and the imaging unit. The arithmetic section executes the step of obtaining a degree of activity of the living specimen, the step of obtaining a phototoxicity value based on the predetermined observation condition, and the step of obtaining a threshold. The control section controls at least one of the culture unit, the illumination unit, and the imaging unit based on the threshold.

According to still another aspect of the present invention, a living-specimen observation and measurement system observes a living specimen by controlling a predetermined observation condition, wherein the predetermined observation condition is set so as to produce a phototoxicity value smaller than a threshold obtained from an activity of the living specimen.

According to yet another aspect of the present invention, a living-specimen observation and measurement method includes storing a predetermined observation condition and controlling the predetermined observation condition based on an activity of a living specimen.

According to the present invention, deterioration in activity of the living specimen can be prevented from the start to the end of observation. In other words, the activity of the living specimen can be maintained for observation at such a level that does not adversely affect an observation result from the start to the end of observation. Therefore, the living specimen can be observed while maintaining the degree of activity at the time the observation was started. Furthermore, even if the degree of activity decreases since the start of observation, the living specimen can still be observed by suppressing the amount of decrease at a level that does not adversely affect an observation result. In this manner, the activity of the living specimen can be maintained for observation at such a level that does not adversely affect an observation result. Consequently, an observation result with high reliability can be obtained.

Furthermore, since deterioration in activity of the living specimen can be prevented, the living specimen can be observed accurately in real time for both short-term and long-term observation. In fluorescence observation in particular, the amount of fluorescence emitted from the living specimen can be observed accurately for an extended period of time.

In addition, observation can be continued or aborted depending on the level of activity of the living specimen. Thus, the living specimen is prevented from being killed.

### BRIEF DESCRIPTION OF THE SEVERAL VIEWS OF THE DRAWINGS

FIG. 1 is a block diagram depicting a living-cell observation and measurement system according to one embodiment of the present invention.

FIG. 2 shows observation conditions, registered in a database, that do not cause phototoxicity.

FIG. 3 shows factors contributing to phototoxicity.

FIG. 4 shows a database indicating observation conditions and their corresponding levels of contribution to phototoxicity.

FIG. 5 is a diagram showing a phototoxicity determination condition.

FIG. 6 is a diagram depicting an apparatus structure shown on a screen as a graphic image.

FIG. 7A is a diagram depicting an apparatus structure shown on a screen as a graphic image, including a block containing a condenser lens, a transmitted-illumination projection tube, and a transmission light source.

FIG. 7B is a diagram depicting an apparatus structure shown on a screen as a graphic image, including a block containing an objective lens, an epi-illumination projection tube, and an epi-illumination light source.

FIG. 8 is a diagram depicting the same apparatus structure shown as a graphic image, where the objective lens, epi-illumination projection tube, and epi-illumination light source are highlighted as a result of the epi-illumination method being selected.

FIGS. 9A and 9B illustrate a setting operation for a block shown as a graphic image.

FIGS. 10A and 10B illustrate a setting operation for a block shown as a graphic image.

FIGS. 11A and 11B illustrate a setting operation for a block shown as a graphic image.

FIGS. 12A and 12B illustrate a setting operation for a block shown as a graphic image.

FIG. 13 illustrates a setting operation for a block shown as a graphic image.

FIGS. 14A and 14B illustrate a setting operation for a block shown as a graphic image.

FIG. 15 is a diagram depicting a plurality of blocks indicating optical filters in the block containing the epi-illumination projection tube.

FIG. 16 is a diagram illustrating a method of selecting a fluorochrome concentration.

FIG. 17A is a part of a flowchart illustrating a procedure for setting observation conditions, where all numerical values for the observation conditions can be input freely.

FIG. 17B is a part of a flowchart illustrating a procedure for setting observation conditions, where all numerical values for the observation conditions can be input freely.

FIGS. 18A to 18H show examples of actual setting screens for the same setting procedure.

FIG. 19A is a part of a flowchart illustrating a procedure for setting observation conditions, where some numerical values for the observation conditions can be input freely and other numerical values are selected.

FIG. 19B is a part of a flowchart illustrating a procedure for setting observation conditions, where some numerical values for the observation conditions can be input freely and other numerical values are selected.

FIGS. 20A to 20G show examples of actual setting screens for the same setting procedure.

FIG. 21A is a part of a flowchart illustrating a procedure for setting observation conditions, where all numerical values for the observation conditions are selected.

FIG. 21B is a part of a flowchart illustrating a procedure for setting observation conditions, where all numerical values for the observation conditions are selected.

FIGS. 22A to 22G show examples of actual setting screens for the same setting procedure.

FIG. 23A is a part of a flowchart illustrating a procedure for setting observation conditions, where only the initial observation result is fed back.

FIG. 23B is a part of a flowchart illustrating a procedure for setting observation conditions, where only the initial observation result is fed back.

FIGS. 24A and 24B show a modification to the setting procedure illustrated in FIGS. 23A and 23B.

FIG. 25A is a part of a flowchart illustrating a procedure for setting observation conditions, where the observation result is fed back each time.

FIG. 25B is a part of a flowchart illustrating a procedure for setting observation conditions, where the observation result is fed back each time.

FIGS. 26A and 26B show a modification to the setting procedure illustrated in FIGS. 25A and 25B.

FIGS. 27A and 27B show a modification to the setting procedure illustrated in FIGS. 25A and 25B.

FIG. 28A is a part of a flowchart illustrating a procedure for setting observation conditions, where information about cell activity is measured and fed back to observation conditions.

FIG. 28B is a part of a flowchart illustrating a procedure for setting observation conditions, where information about cell activity is measured and fed back to observation conditions.

FIG. 29A is a part of a flowchart illustrating a procedure for setting observation conditions, where information about fluorescence fading is fed back to observation conditions.

FIG. 29B is a part of a flowchart illustrating a procedure for setting observation conditions, where information about fluorescence fading is fed back to observation conditions.

FIG. 30 is a diagram depicting an observation period.

FIG. 31A is a diagram showing the relationship between irradiation and observation processes, where the periods of time (time intervals) are the same.

FIG. 31B is a diagram showing the relationship between irradiation and observation processes, where the periods of time (time intervals) are different.

FIG. 32A is a diagram depicting the relationship between activity and phototoxicity resistance.

FIG. 32B is a diagram depicting the relationship between the amounts of change in the degree of activity and phototoxicity values.

FIG. 33A is a diagram depicting changes in the degree of activity over time with different phototoxicity values.

FIG. 33B is a diagram depicting the relationship between the degree of activity and a threshold.

FIG. 34 is a diagram depicting the relationship between phototoxicity values and a threshold.

FIG. 35 is a diagram depicting the relationship between a previous observation process and a subsequent observation process.

### DETAILED DESCRIPTION OF THE INVENTION

Before proceeding with a description of a living-specimen observation and measurement system or a living-specimen observation and measurement method (hereinafter, referred to as “this system”), terms used in this specification will be defined.

“Living Specimen”

“Living specimens” indicate living tissues (biological tissues), living cells (biological cells), and so forth. Living tissues or cells may be cultured tissues or cells or tissues or cells extracted from a living organism. Alternatively, living tissues or cells may be tissues or cells for in-vivo (in the body of a living organism) examination.

“Predetermined Observation Conditions”

“Predetermined observation conditions” are, for example, observation-related information (items). More specifically, observation-related information includes the amount of light radiated onto a living specimen (e.g., irradiation light intensity per cell, irradiation light illuminance, etc.), the duration of a single irradiation, the number of irradiations, the irradiation interval, the continuity of irradiation light (whether the irradiation light is continuous oscillation (luminescence) or pulsed oscillation (luminescence), and the pulse frequency or pulse width in the case of pulsed oscillation), the wavelength of irradiation light, the irradiation dose and irradiation area, the duration of a single observation, the number of observations, the observation interval, the duration of a single imaging operation, the number of imaging operations, the imaging interval, and so forth.

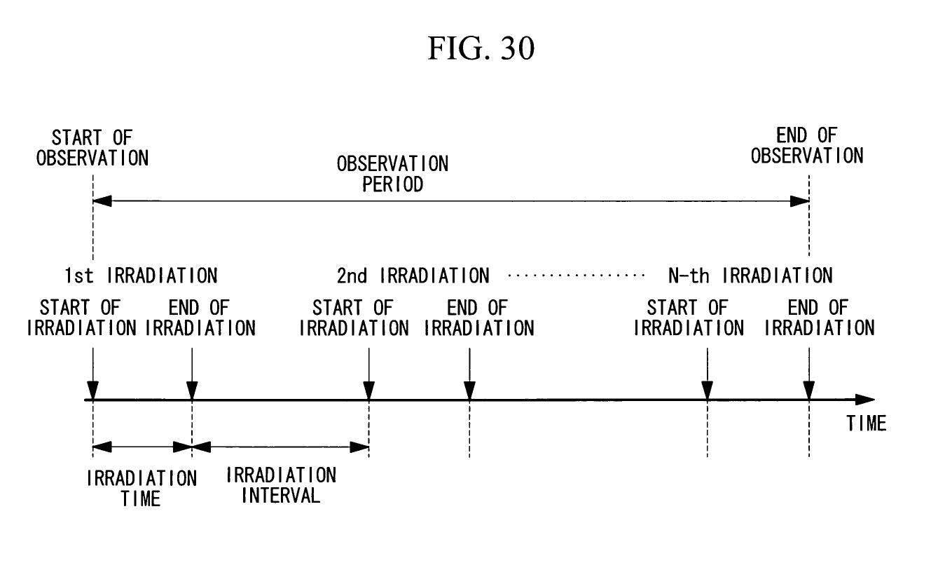

New information derived from combinations of the above-described observation-related items of information is also included in the predetermined observation conditions. For example, an observation period can be calculated using the expression below based on the relationship shown in FIG. 30:
Observation period=(duration of a single irradiation+irradiation interval)×number of irradiations.

In this case, if an observation (imaging) is carried out for every irradiation, the number of irradiations is equal to the number of observations (the number of imaging operations). Therefore, the observation period can also be represented using the following expression:
Observation period=(duration of a single irradiation+irradiation interval)×number of observations (image acquisitions).

In FIG. 30, an observation and the first irradiation are started at the same time, and the observation and the N-th irradiation are ended at the same time. However, an observation and the first irradiation do not need to be started at the same time, and the observation and the N-th irradiation do not need to be ended at the same time. More specifically, the first irradiation may be started after an observation has been started. In addition, the observation may be ended after the N-th irradiation has been ended.

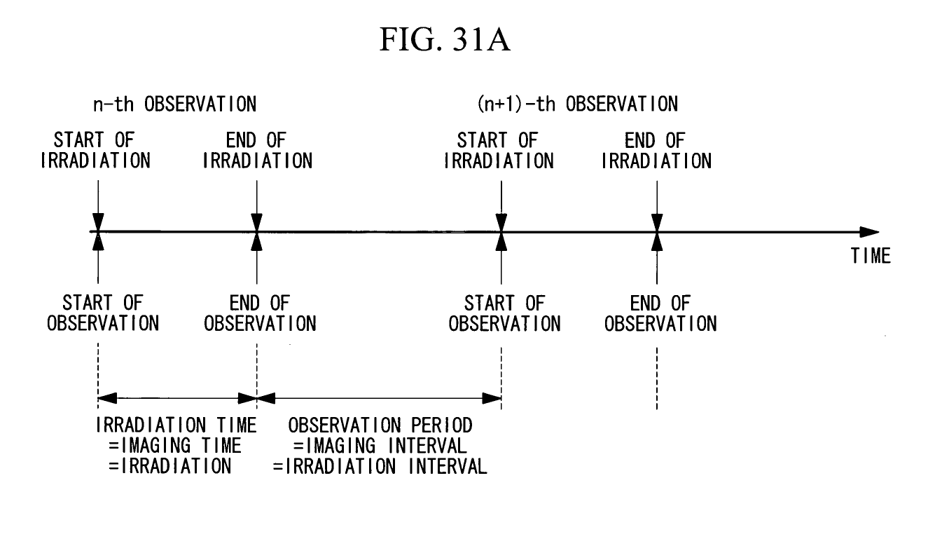

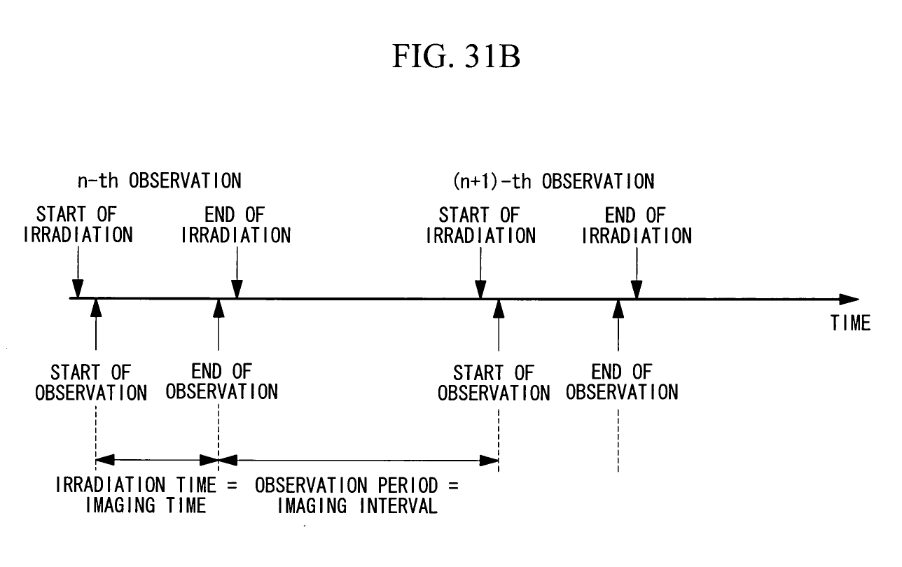

In the observation shown in FIG. 31A, an irradiation and the observation are started at the same time and the irradiation and the observation are ended at the same time. In this case, the irradiation time (for a single irradiation) becomes equal to the observation time (for a single observation), and the irradiation interval (for a single irradiation) becomes equal to the observation interval (for a single observation). However, an observation may be carried out such that the irradiation start time may differ from the observation start time and the irradiation end time may differ from the observation end time. In this case, the irradiation time (for a single irradiation) differs from the observation time (for a single observation), and the irradiation interval (for a single irradiation) differs from the observation interval (for a single observation). The total irradiation time and the total observation time are represented using the expressions below, respectively:
Total irradiation time=duration of a single irradiation×number of irradiations,
Total observation time=duration of a single observation×number of observations.

The total irradiation time is equal to the total observation time in FIG. 31A, but the total irradiation time differs from the total observation time in FIG. 31B.

In FIG. 31B, an observation is started after an irradiation has been started, and the observation is ended before the irradiation is ended. However, an observation may be started before an irradiation is started, and the observation may be ended after the irradiation has been ended.

The amount of light can be represented in the form of a radiant quantity or a luminous quantity. The radiant quantity is represented as one of the radiant flux, the radiant intensity, the radiance, the irradiance, and the radiant exitance, or as a combination of these quantities. The luminous quantity is represented as one of the luminous flux, the luminous intensity, the luminance, the illuminance, the luminous emittance, and the light quantity, or as a combination of these quantities.

The above-described observation-related information is determined according to the type of the light source, the type of the excitation filter, the type of the relay optical system, the type of the objective lens, the type of the condenser lens, the types of various filters (including an ND filter and an absorption filter), and so forth. For example, the wavelength of the irradiation light is one of the observation-related information items. This wavelength of irradiation light is automatically determined according to the type of the selected light source and the type of the selected excitation filter. A light source and an excitation filter are components that constitute this system. In this manner, the wavelength of irradiation light, which is a predetermined observation condition, is determined according to the light source and the absorption filter, i.e., components constituting this system. Therefore, such components constituting this system can also be regarded as predetermined observation conditions.

As described above, the light source, the excitation filter, the relay optical system, the objective lens, the condenser lens, and various filters are all components constituting this system, and are indispensable for predetermined observation conditions. Therefore, these components themselves are also included in the predetermined observation conditions.

An image suitable for observation can be acquired by adjusting the amount of light entering the imaging unit or adjusting the imaging time. Means for adjusting the amount of light and the imaging time include an electronic shutter of the imaging unit. Therefore, the imaging unit can also be included in the predetermined observation conditions. Alternatively, a mechanical shutter may be provided separately from the imaging unit. In such a case, the mechanical shutter is also included in the predetermined observation conditions.

Living specimen information includes the type (name) of the living specimen, the tissue density of the living specimen, the environment for culturing the living specimen (temperature, humidity, pH of the culture medium, carbon dioxide concentration), the adhesive state of living tissue, whether the living specimen is cultured tissue or noncultured tissue, the presence of a drug delivered to the living specimen, the type of the delivered drug, the concentration of the living specimen when it is seeded, the time elapsed since the living specimen has been seeded, and so forth. The contents of the living specimen information are already determined when observation is started. Therefore, the living specimen information is basically not included in the observation conditions. However, the culture environment may be changed, for example, during observation. Therefore, the living specimen information may be included in the observation conditions.

Fluorochrome information includes the type of the fluorochrome, the concentration of the fluorochrome, and so forth. The contents of this fluorochrome information are also already determined when observation is started. Therefore, fluorochrome information is basically not included in the observation conditions. However, the concentration of the fluorochrome may be change during, for example, observation. Therefore, fluorochrome information can also be included in the observation conditions.

In this manner, predetermined observation conditions include (1) components themselves constituting this system (e.g., laser, objective lens, ND filter, CCD, etc.); (2) observation-related information; and (3) numerical values quantitatively representing observation-related information and characteristics of components themselves (e.g., a value of 10 mW (amount of light) or a value of 488 nm (wavelength of irradiation light) in the former case and a value of 4% (light reduction rate of ND filter) in the latter case). In some cases, the predetermined observation conditions include living specimen information and fluorochrome information.

In the current description, “predetermined observation conditions” are referred to just as “observation conditions.”

“Phototoxicity”

“Phototoxicity” is defined as “a phenomenon wherein light excites a certain type of substance to cause a photochemical reaction that damages living tissue, such as the skin or eyes.” (Saishin Igaku Dai-Jiten (Contemporary and Comprehensive Medical Encyclopedia), 2nd edition, Ishiyaku Publishers, Inc.) As described above, at least two factors, i.e., light and a certain type of substance (causative agent or phototoxic substance) are associated with phototoxicity. Therefore, according to this definition, phototoxicity can be represented using information about light and information about such a certain type of substance.

On the other hand, this system recognizes light as a main factor affecting the activity of a living specimen. For this reason, in the description of this system, “phototoxicity” is interpreted as “toxicity of irradiation light.” Therefore, phototoxicity is represented by excluding “information about a causative agent (phototoxic substance).” The degree of phototoxicity represented in the form of a numerical value is called a phototoxicity value.

In this system, objects that are damaged by phototoxicity are not limited to particular living tissues such as the skin or eyes. Cells constituting living tissues are included as objects damaged by phototoxicity.

“Degree of Activity”

The “degree of activity” is the level of activity of a living specimen represented in the form of a numerical value. Factors that cause the activity of a living specimen to decrease include, for example, active oxygen occurring in cells due to light irradiation and heat generated in cells due to light irradiation. Whichever factor decreases the activity of a living specimen, the living specimen is not killed immediately upon exposure to light, but the activity gradually declines. If the amount of light is very large (phototoxicity is very intense), the living specimen may be killed instantly: this case is not assumed in the current description, however. Thus, a living specimen can be regarded as having a certain level of resistance to phototoxicity. The resistance of a living specimen to this phototoxicity is called “phototoxicity resistance.” The degree of phototoxicity resistance represented in the form of a numerical value is called the phototoxicity resistance value.

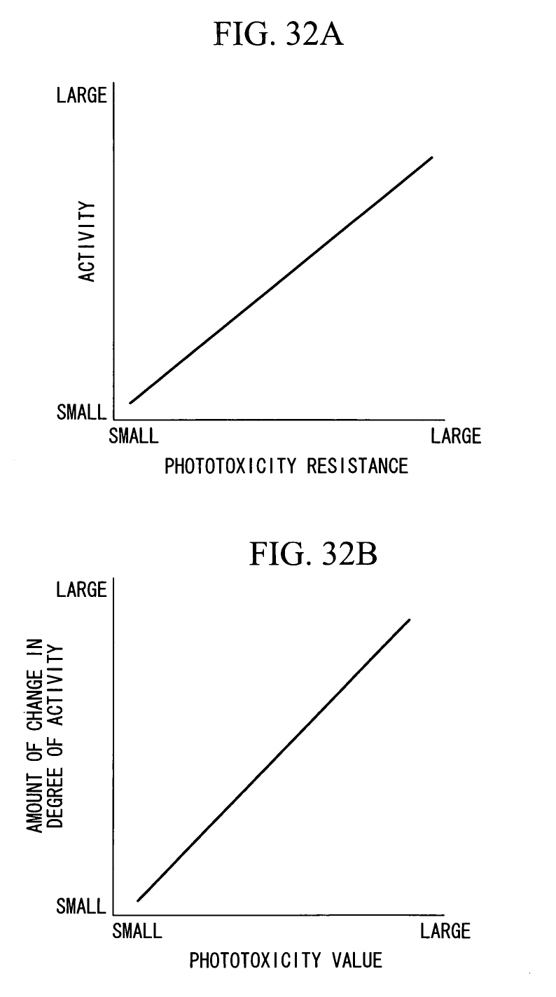

The phototoxicity resistance has a correlation with the activity of a living specimen. More specifically, the higher the phototoxicity resistance, the higher the activity, and the lower the phototoxicity resistance, the lower the activity. Therefore, phototoxicity resistance values and the degrees of activity have a relationship as shown in, for example, FIG. 32A. From this relationship, the activity of a living specimen can also be represented as the phototoxicity resistance (phototoxicity resistance value). Although the term “activity” or “degree of activity” is mainly used in the current description, the terms “activity” and “degree of activity” can be safely replaced with the term “phototoxicity resistance” or “phototoxicity resistance value”. Although the relationship between the activity and the phototoxicity resistance of a living specimen is linear in FIG. 32A, this relationship may be nonlinear.

A correlation can be recognized also between the phototoxicity value and the degree of activity of a living specimen. More specifically, the larger the phototoxicity value, the larger the amount of change (rate of deterioration) in the degree of activity, and the smaller the phototoxicity value, the smaller the amount of change in the degree of activity. Therefore, the phototoxicity value and the amount of change in the degree of activity have a relationship as shown in, for example, FIG. 32B. Although the relationship between the phototoxicity value and the amount of change in the degree of activity is linear in FIG. 32B, this relationship may be nonlinear.

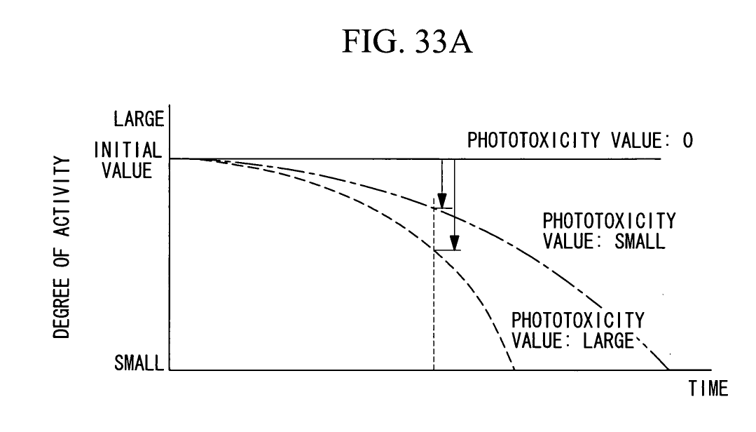

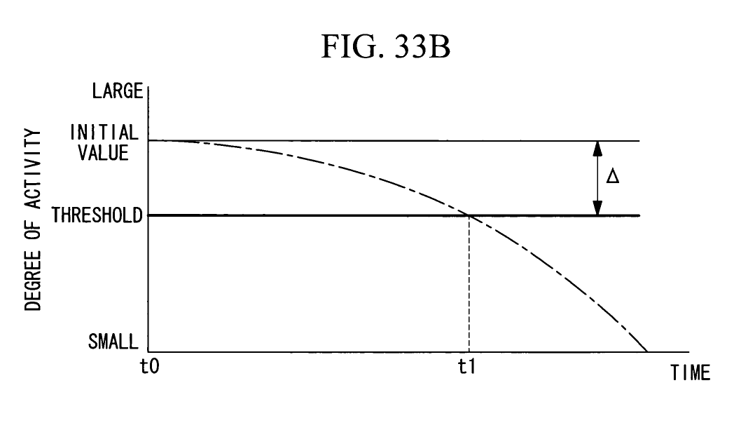

The relationship between the phototoxicity value and the degree of activity is represented as shown in, for example, FIG. 33A, where the horizontal axis corresponds to time. The solid line corresponds to a case where the phototoxicity value is zero, the chain lines correspond to a case where the phototoxicity value is small, and the broken lines correspond to a case where the phototoxicity value is large. In the case where the phototoxicity value is zero, the degree of activity remains at the initial value. In the cases where the phototoxicity value is not zero, the degree of activity gradually decreases over time. In the graph of FIG. 33A, other factors (factors other than phototoxicity) that cause the activity of a living specimen to decrease are not considered.

“Threshold”

The term “threshold” is a numerical value indicating a limit at which a living specimen can keep a predetermined level of activity. As described above, living specimens have resistance to phototoxicity, that is, phototoxicity resistance. The phototoxicity resistance has a correlation with the activity of a living specimen. Therefore, whether a living specimen can keep a predetermined activity is determined according to the degree of activity, the phototoxicity value, and the threshold.

The relationship among the degree of activity, the phototoxicity value, and the threshold is as shown in, for example, FIG. 33B. As shown in FIG. 33B, a threshold can be set for the degree of activity. The degree of activity changes more rapidly in the case where the phototoxicity value is large than in the case where the phototoxicity value is small (FIG. 33A). For this reason, the activity starts to change earlier in the case where the phototoxicity value is large than in the case where the phototoxicity value is small. Therefore, the degree of activity falls below the threshold in a shorter period of time than in the case where phototoxicity value is small.

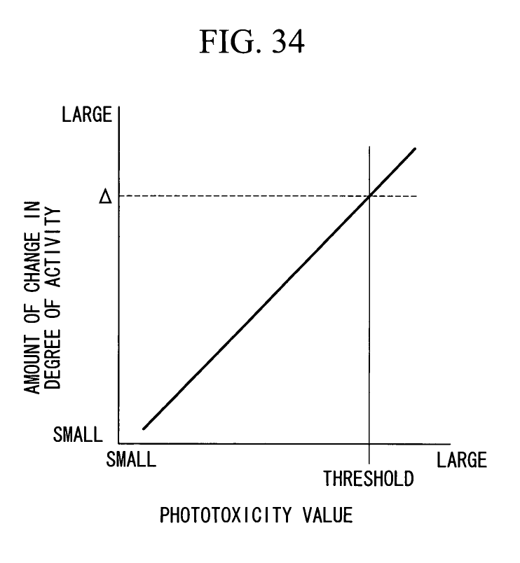

In FIG. 33B, the difference between the initial value of the degree of activity and the threshold (Δ) is a permissible amount of change in the degree of activity. Thus, a threshold can be set for the phototoxicity value based on a graph representing the relationship between the phototoxicity value and the amount of change in the degree of activity, as shown in FIG. 34. In this case, the threshold can be represented using a phototoxicity value.

The threshold can be derived from the degree of activity itself. Alternatively, the threshold may be obtained from the result of an arithmetic operation or estimation being performed based on the degree of activity. Information about the degree of activity is also necessary if a threshold is to be set for the phototoxicity value. Consequently, the degree of activity needs to be obtained to obtain a threshold.

A predetermined level of activity indicates activity of a level that does not affect an observation result (i.e., that allows an observation result to be obtained with high reliability). The reliability of an observation result differs depending on, for example, the objective of observation and the personal point of view of the operator, and therefore, criteria for setting the threshold also differ depending on such factors.

Degraded activity of a living specimen indicates an activity of the living specimen that is lower than the threshold. For example, referring to FIG. 33B, the activity gradually decreases in the segment from t₀ to t₁. However, the degree of activity in this segment is above the threshold. Therefore, no degraded activity of a living specimen is recognized in this segment. Degraded activity of the living specimen is seen in the segment after t₁.

“Observation Method”

The term “observation method” indicates a method of observing a living specimen using light. Examples of the observation method include a fluoroscopy method, a bright field method, a phase contrast method, a Hofmann method, a inclined illumination method, a differential interference method, a dark field method, and so forth. Observation methods other than those described above can also be employed as long as a living specimen can be observed. A confocal technique and a non-confocal technique can be employed as a detection technique for these observation methods.

“Storage”

The term “storage” refers to the process of registering, storing, or recording information obtained in this system or information for controlling this system into a memory or a database. Examples of information obtained in this system include images of a living specimen. Examples of information for controlling this system include observation conditions. In this system, observation conditions may be set before observation is carried out, observation conditions may be changed during observation, and new observation conditions may be added. In any case, storing and recording observation conditions that have been set, changed, or added is included in the term “storage.”

“Control”

The term “control” refers to the process of operating components constituting this system based on stored observation conditions. Components can be operated based not only on stored observation conditions but also on information other than observation conditions. Therefore, it is sufficient that components are allowed to operate at least based on stored observation conditions.

In order to operate this system, components required to operate this system need to be selected from among the components constituting this system. For example, this system includes a transmission optical system and an epi-illumination optical system as an optical system for emitting irradiation light (illumination optical system). When a living specimen is to be observed by fluoroscopy in this system, the epi-illumination optical system is selected from among these two options, that is, the transmission optical system and the epi-illumination optical system. Furthermore, a light source and an optical filter used for the epi-illumination optical system are selected. Thus, the term “control” includes selecting the components themselves of this system.

For the selected components, parameters belonging to the components may be additionally selected. As described above, parameters belonging to components also serve as observation-related information. For example, some light sources emit multi-wavelength light. If such a light source is selected, the wavelength of irradiation light needs to be selected from among a plurality of wavelengths. The wavelength of irradiation light is, on one hand, one parameter associated with the light source and is also, on the other hand, observation-related information. Thus, the term “control” includes selecting parameters of components, that is, observation-related information.

For observation-related information, it is sometimes necessary to set a numerical value quantitatively representing the observation-related information. For example, if the selected light source (laser) can output blue light up to 30 mW, a value of 10 mW is set as the amount of light (observation-related information) radiated on the living specimen. Thus, the term “control” includes setting a numerical value of observation-related information.

As described above, (1) components themselves constituting this system, (2) observation-related information (parameters belonging to components), and (3) numerical values quantitatively representing observation-related information are all included in the observation conditions. Therefore, control of observation conditions includes selecting (including adding and deleting), setting, and changing these observation conditions and inputting numerical values. Moreover, forcibly terminating observation is also included in the term “control.”

Operating modes of this system will now be described.

This system stores predetermined observation conditions and also controls predetermined observation conditions based on the activity of a living specimen.

Control of the observation conditions may be carried out by the operator or by the system automatically. For control of observation conditions, observation conditions that have been selected, set, or changed are first stored in a storage section. Then, the observation conditions are evaluated based on the activity of the living specimen. Based on the evaluation result, the system prompts the operator to perform new control of observation conditions. Alternatively, the system automatically performs new control of observation conditions. Alternatively, the system controls observation conditions so that only observation conditions that do not degrade the activity of the living specimen can be set.

This control of observation conditions may be carried out before the start of observation or may be carried out during observation (in real time). Control may be carried out irrespective of an observation result or may be carried out based on an observation result obtained during observation. If control of observation conditions is carried out during observation, observation is subsequently carried out based on the newly controlled observation conditions. Evaluation may be carried out each time one observation condition is controlled or may be carried out after all observation conditions have been controlled.

More preferable operating modes will now be described.

This system includes observation conditions and their degrees of contribution in a database. This degree of contribution is set for each observation condition and represented in the form of a numerical value. In this manner, the effectiveness of controlled observation conditions (i.e., whether the observation conditions allow observation) can be evaluated based on the database.

The database may include a plurality of combinations of observation conditions. In this case, it is assumed that combinations of observation conditions (combinations of degrees of contribution) do not decrease the activity of a living specimen. Therefore, the effectiveness of controlled observation conditions can be simply determined merely by matching the combination of the controlled observation conditions against combinations of observation conditions registered in the database.

The database may include a plurality of combinations of observation conditions and phototoxicity values. This phototoxicity value is provided for each combination. Therefore, it can be simply determined whether controlled observation conditions degrade the activity of the living specimen from the corresponding phototoxicity value and the phototoxicity resistance specific to the living specimen. It is not necessary to assume that combinations of observation conditions (combinations of degrees of contribution) do not degrade the activity of the living specimen.

According to the above-described structure, observation conditions that do not degrade the activity of the living specimen can be controlled based on the database. As a result, an observation result with high reliability can be obtained. Furthermore, long-term observation of a living specimen is possible. In addition, the operator himself/herself can control the observation conditions so that more optimal observation conditions are attained based on the degree of contribution represented in the form of a numerical value.

The system may include a function for obtaining a phototoxicity value based on observation conditions. In the subsequent description, the term “obtain” includes to “calculate,” “estimate,” and “predict.” To obtain a phototoxicity value, a predetermined arithmetic operation is required. Therefore, the system preferably includes an arithmetic section as a function for obtaining a phototoxicity value.

A phototoxicity value may be obtained based on a unique expression (user-specified arithmetic expression). In this case, the unique expression can be represented as a function that includes at least two of six variables (wavelength of irradiation light, duration of a single irradiation, amount of light radiated onto the living specimen, irradiation interval, number of irradiations, and continuity of irradiation light). If all variables are used, the unique expression D shown below is obtained.
D=f (λ,t, I, b, n, p)
where λ denotes the wavelength of irradiation light, t denotes the duration of a single irradiation, I denotes the amount of light radiated onto the living specimen, b denotes the irradiation interval, n denotes the number of irradiations, and p denotes the continuity of irradiation light.

The wavelength of irradiation light can be represented not only as a single wavelength but also as a certain range (wavelength band). One of the six variables may be represented as, for example, a function n(λ), where the variable of this function is another of the six variables. (In n(λ), the number of irradiations is represented as a function of the wavelength of irradiation light).

During the period from the first irradiation to the second irradiation, the living specimen is not exposed to irradiation light. During this period, the activity of the living specimen does not decrease. Rather, the activity may be enhanced. Therefore, basically, the irradiation interval can be regarded as a parameter related to the activity of a living specimen. If the activity of the living specimen is enhanced, it may be regarded that the phototoxicity value has become relatively small. This is why the irradiation interval is included in the above-described unique expression D as a parameter for obtaining a phototoxicity value.

In this manner, the unique expression D is a function having a plurality of observation conditions as variables. Each of these observation conditions is represented in the form of a numerical value. Such a numerical value can be obtained directly from the specifications of a component itself or may be represented in the form of the degree of contribution or a coefficient.

For example, assume that a laser with a rated output of 30 mW (specifications) is selected as a light source. Also assume that a value of 15 mW has been set as the amount of light (observation condition) to be radiated onto the living specimen. In this case, it follows that the numerical value obtained directly from the specifications of the component itself is 15 mW. In this manner, the set numerical value representing an observation condition is obtained directly from the specifications of a component itself.

Next, the degree of contribution and the coefficient can be obtained by converting the numerical value obtained directly from the specifications of the component itself. In the above-described example, the numerical value obtained directly from the specifications of the component itself is 15 mW. A degree of contribution of 5.4 and a coefficient of 0.5 are obtained by performing conversion based on this value of 15 mW.

The degree of contribution will now be described. The light source used is assumed to be a laser, where the amount of light radiated onto the living specimen is gradually increased. As a result, it is assumed that the activity of the living specimen starts to decrease at 5 mW and the living specimen is killed at 30 mW. Under this assumption, if the degree of contribution in the case where the activity of the living specimen exhibits no decrease is 1 and the degree of contribution in the case where the living specimen is killed is 10, then the degree of contribution corresponding to 5 mW is 1 and the degree of contribution corresponding to 30 mW is 10. Here, assume that the relationship between the amount of light radiated onto the living specimen and the phototoxicity value is linear (directly proportional). Then, it follows that the degree of contribution corresponding to, for example, 15 mW is calculated as (10−1)/(30−5)×15=5.4. In this manner, the degree of contribution corresponding to 15 mW can be obtained.

On the other hand, the coefficient corresponding to 15 mW is calculated as 0.5 if the coefficient corresponding to 30 mW is normalized to 1. In this conversion method, however, the time when the activity of the living specimen starts to decrease (at 5 mW) is not counted in the calculation of the coefficient. As with the degree of contribution, a coefficient can be obtained based on a conversion method taking into consideration the time when the activity of the living specimen starts to decrease. Furthermore, it is needless to say that the described conversion method for obtaining the coefficient may also be employed to obtain the degree of contribution.

Alternatively, a coefficient may be obtained through a predetermined conversion of the degree of contribution stored in the database. If the database is constructed with discrete data, the degree of contribution and the coefficient may be obtained by interpolation.

Once a phototoxicity value is obtained, the system obtains optimal observation conditions from this phototoxicity value and the activity specific to the living specimen. Thereafter, the system carries out observation by automatically controlling the obtained observation conditions.

A phototoxicity value can be obtained (predicted in this case) by using observation conditions associated with observation carried out in the past.

According to the above-described structure, the system itself can obtain a phototoxicity value based on stored observation conditions. Therefore, the control of observation conditions by the operator can be simplified. In other words, the ease of use of the system can be enhanced. Furthermore, an observation result with high reliability can be obtained.

The system may include a function for representing the activity in the form of a numerical value.

When a phototoxicity value is obtained, whether or not the phototoxicity value affects the activity of the living specimen can be evaluated from the phototoxicity value and the activity of the living specimen. For this purpose, the system preferably includes a function for representing the activity in the form of a numerical value. With this function, the degree of activity of the living specimen can be obtained.

The degree of activity of the living specimen depends on the living state of the living specimen. The living state of the living specimen depends on, for example, the culture environment, the presence of a drug, and so forth. Since these factors constitute living specimen information or fluorochrome information, the degree of activity of the living specimen can be obtained based on such living specimen information and fluorochrome information. Since living specimen information and fluorochrome information may be represented in the form of a numerical value, the degree of activity of the living specimen can be obtained using a predetermined calculation expression. For this purpose, an arithmetic operation needs to be performed. Therefore, the system preferably includes an arithmetic section as a function for obtaining the degree of activity.

Alternatively, since the living specimen exhibits a different external shape according to the degree of activity, the degree of activity can also be obtained by observing the external shape. Furthermore, the degree of activity can also be obtained by measuring the amount of light coming from the living specimen. Therefore, the system preferably includes a measurement function section as a function for representing the degree of activity in the form of a numerical value (obtaining the degree of activity).

In this manner, the degree of activity of the living specimen can be obtained from a calculation expression using living specimen information and fluorochrome information or from an observation result of the living specimen.

It is preferable that the degree of activity of the living specimen be obtained during observation. This is because the degree of activity of the living specimen can be obtained more accurately if it can be measured actually during observation. By doing so, observation conditions can be controlled more appropriately.

Methods for obtaining the degree of activity through actual measurement include, for example, a method of measuring the absorbance using an MMT reagent. An alternative method includes a method of obtaining the degree of activity through observation of the morphology of the living specimen. In either method, the measurement function section is used. This measurement function section is provided in the culture environment.

In this manner, the degree of activity can be obtained by using, for example, a reagent or by observing the morphology of the living specimen.

With the above-described structure, the degree of activity can be represented in the form of a numerical value based on an observation value or an observed image. Therefore, when observation conditions are to be controlled by the operator based on the activity, the operator can perform this control more easily. In other words, the ease of use of the system can be enhanced. If the degree of activity is to be obtained by the system, it can be obtained in a short period of time. This allows observation conditions to be confirmed in real time.

The degree of activity obtained based on the operator's experience can be used to correct the degree of activity obtained by the system. In this manner, the degree of activity can be obtained more accurately by using the degrees of activity obtained by the operator and the system. As a result, an observation result with high reliability can be obtained.

If the activity of the living specimen deteriorates during observation, the operator may be warned or observation may be terminated forcibly. As a result, the living specimen can be prevented from exhibiting deterioration in activity or being killed.

The system may include a function for determining phototoxicity.

As described with reference to the database, this system can have combinations of observation conditions in the database. If it is assumed that no combinations of observation conditions decrease the activity, any combination of observation conditions can be selected. If this is the case, it is not necessary to determine the phototoxicity.

On the other hand, if a phototoxicity value and the degree of activity can be obtained, the phototoxicity can be determined from this phototoxicity value and the degree of activity. Therefore, the system preferably includes a function for determining phototoxicity. The function for determining phototoxicity may be provided as an independent function, or alternatively, the function for determining phototoxicity may be provided in common with the function for obtaining a phototoxicity value or the function for obtaining the degree of activity.

Determination of phototoxicity includes (1) determination as to whether phototoxicity exists and (2) determination of the degree of phototoxicity if phototoxicity exists.

A determination criterion is required to perform determination. The determination criterion may be set as a threshold. As described above, the threshold is a value obtained based on the degree of activity.

The threshold may be (1) the degree of activity before observation is started or (2) a value smaller than the degree of activity before observation is started (e.g., 80% of the degree of activity before observation is started). This threshold can be retained in the database, like the degree of contribution. Alternatively, this threshold can be obtained through, for example, an arithmetic operation or estimation, as with the degree of activity.

By doing so, if a phototoxicity value obtained based on an observation condition exceeds or is expected to exceed the threshold, the system can determine that this observation condition involves the danger of degrading the activity of the living specimen. Thereafter, the operator can be prompted to perform new control (selection, setting, or change) of the observation condition or the observation condition can be controlled automatically, thus allowing measurement without degrading the activity.

Furthermore, if the system itself includes a determination function, observation under optimal observation conditions that do not degrade the activity is always ensured. In addition, observation conditions can be controlled automatically in real time. Therefore, the ease of use of the system can be enhanced. Furthermore, an observation result with high reliability can be obtained.

Phototoxicity may be determined based on a determination criterion set by the operator.

As described above, the threshold can be obtained from the degree of activity. The degree of activity of the living specimen can be obtained through observation of the morphology of the living specimen. In the observation of the morphology of the living specimen, the morphology of the living specimen is acquired as an image. Thereafter, the degree of activity can be obtained by analyzing the imaged morphology. Such analysis can be carried out through image processing or based on the operator's experience. In the latter case, the determination criterion can be regarded as being set by the operator. In this manner, the operator's experience can be exploited if phototoxicity can be determined based on a determination criterion set by the operator.

A determination criterion, that is, a threshold, is eventually obtained (set) by the system, even if the degree of activity is obtained based on the operator's experience. However, since the degree of activity is obtained based on the operator's experience, the determination criterion can also be regarded as being set by the operator.

Furthermore, irrespective of whether image processing or operator experience has been adopted, the process of the operator setting a threshold different from the threshold eventually obtained by the system (i.e., the threshold eventually obtained by the system is not used) is also included in “the ability of the operator to set a determination criterion.”

Determination criteria may differ greatly depending on the objective of the observation. Therefore, with the function for allowing the operator to set a determination criterion, observation (automatic observation) in accordance with the operator's objective is possible. As a result, this system can be applied to a wider range of objects to be measured.

A measurement history of observation conditions in the past and their corresponding phototoxicity values may be stored so that phototoxicity determination criteria are updated based on the measurement history.

The system preferably includes a function for producing observation history data during the period of time from the start to the end of observation. At this time, it is more preferable if observation conditions, phototoxicity values, degrees of activity, and thresholds are recorded automatically as observation history data. The system automatically updates the database based on this observation history data before the start of the subsequent observation.

If observation ends with a single irradiation, the phototoxicity value, degree of activity, and threshold in the single irradiation are recorded. If observation ends with N irradiations, the phototoxicity value, degree of activity, and threshold are recorded for every irradiation. If the irradiation conditions are the same, it is sufficient to record one phototoxicity value, one degree of activity, and one threshold, irrespective of the number of irradiations. Thereafter, the phototoxicity value, the degree of activity, or the threshold is updated based on this record.

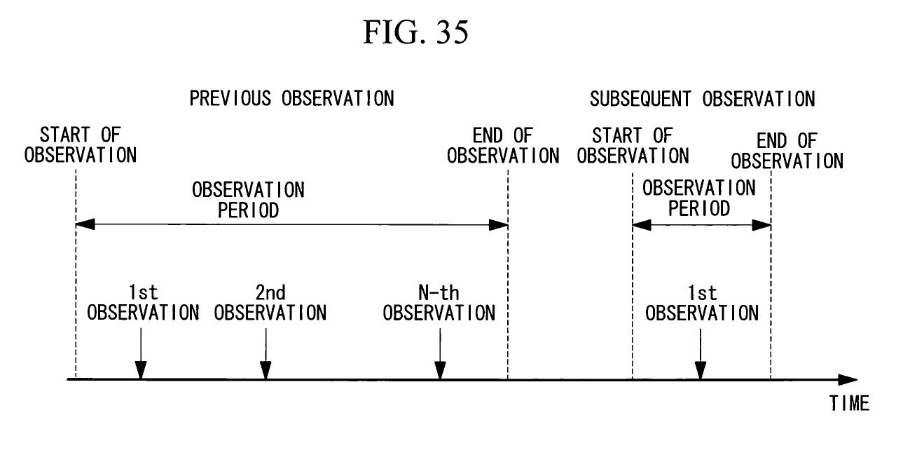

If observation ends with a single irradiation, the term “subsequent observation” indicates a new observation that is carried out after the single irradiation has ended. If observation ends with N irradiations, the term “subsequent observation” indicates a new observation that is carried out after the N irradiations have ended. FIG. 35 is a diagram depicting the relationship between two observation processes. The preceding observation involves a plurality of irradiations, whereas the subsequent observation involves a singe irradiation. In this example, the preceding observation and the subsequent observation have completely different observation conditions, including the number of irradiations.

If the database includes the degrees of contribution (or coefficients) and phototoxicity values, the phototoxicity values are updated. For example, assume that the observation conditions in the first observation constitute the duration of a single irradiation, the amount of light radiated onto the living specimen, and the irradiation interval, where the degrees of contribution corresponding to the respective conditions are t₁, I₁, and b₁. Also assume that the phototoxicity value resulting from this combination of observation conditions is x₁. Furthermore, assume that when observation is carried out with these observation conditions, the activity of the living specimen has deteriorated. In this case, the phototoxicity value is not appropriate, and therefore, the phototoxicity value x₁ in the database is updated with a new phototoxicity value x₂. Thereafter, observation conditions are controlled with this updated phototoxicity value, and the subsequent observation is carried out.

For the unique expression D, the expression format of the expression is updated. Assume that the unique expression D is represented, for example, as the following expression:
D=f(λ,t, I, b, n, p)=(t×I×n×p)/(λ×b²).

In the first observation, if the observation conditions are t₁, I₁, n₁, p₁, λ₁, and b₁, then the phototoxicity value D₁ is obtained based on the following expression:
D₁=(t₁×I₁×n₁×p₁)/(λ₁×b₁²).

Then, assume that when observation is carried out under these observation conditions, the activity of the living specimen has degraded. In this case, since the expression is not appropriate (the expression underestimates the phototoxicity value), the unique expression is updated with, for example, the expression shown below:
D=f(λ,t, I, b, n, p)=(t×I×n×p)/(λ×b).

Thereafter, observation conditions are controlled with a phototoxicity value calculated based on this updated unique expression, and the subsequent observation is carried out. In this example, although observation condition b² itself is updated to b, arithmetic operators between observation conditions may be updated. Updating may be deletion or addition (if the number of first observation conditions is five or less) of observation conditions.

Although updating the phototoxicity value has been described above, the degree of activity or the threshold can also be updated in the same manner. The operator himself/herself may be allowed to record the phototoxicity value, the degree of activity, or the threshold. In addition, the database or the unique expression D may be updated manually.

With the above-described structure, a more accurate phototoxicity value, degree of activity, or threshold can be obtained, and deterioration in activity of the living specimen can be prevented more reliably. Therefore, more accurate observation can be carried out. Furthermore, the determination accuracy can be enhanced by the operator himself/herself during observation in accordance with the operator's objective of observation.

The observation conditions can include observation-related information.

Observation-related information includes the amount of light radiated onto the living specimen, the duration of a single irradiation, the number of irradiations, the irradiation interval, continuity of irradiation light (whether the irradiation light is continuous oscillation (luminescence) or pulsed oscillation (luminescence), and the pulse frequency or pulse width in the case of pulsed oscillation), and information related to irradiation light, such as the wavelength and the irradiation dose of the irradiation light.

With this structure, information about the irradiation light (i.e., phototoxicity value) can be controlled so as to perform the intended observation without degrading the activity of the living specimen.

Observation conditions can include a combination of the dose of a single irradiation and the total irradiation dose.

The dose of a single irradiation and the total irradiation dose are defined as follows:
Dose of a single irradiation=amount of light radiated onto the living specimen×duration of a single irradiation,
Total irradiation dose=dose of a single irradiation×number of observations.

The dose of a single irradiation (total amount of light radiated onto the living specimen over time) required for observation is substantially constant. Therefore, if the amount of light radiated onto the living specimen is large, then the duration of a single irradiation can be reduced. In contrast, if the amount of light radiated onto the living specimen is small, then the irradiation time can be extended. Control of the irradiation dose is important for preventing deterioration in the activity of the living specimen. The dose of a single irradiation is critical for short-term observation, whereas the total irradiation dose is critical for long-term observation.

Therefore, deterioration in activity of the living specimen can be prevented for both short-term observation and long-term observation by setting a combination of the dose of a single irradiation and the total irradiation dose as observation conditions and by controlling these observation conditions. Control of the dose of a single irradiation refers to control of the amount of light and the irradiation time on the specimen surface. More specifically, control of the dose of a single irradiation means controlling the power supply (delivered electrical current) to the light source such as an LED, an LD, or an arc lamp. This is to directly control the amount of light radiated onto the living specimen.

An ND filter is disposed between the light source and the specimen surface while maintaining the amount of light radiated onto the living specimen constant. The amount of light radiated onto cells may be adjusted by inserting or removing the ND filter or replacing the ND filter with another ND filter. This is to indirectly control the amount of light radiated onto the living specimen.

Control of irradiation time can be achieved by turning on/off the supply power, by using a shutter, etc.

With the above-described structure, deterioration in activity of the living specimen can be prevented for long-term and short-term observation.

The observation conditions can include the irradiation time.

The irradiation time of irradiation light directly contributes to the activity of the living specimen. Therefore, it is important to set the irradiation time to a minimum required value. The irradiation time includes the duration of a single irradiation and the total irradiation time. The total irradiation time is the product of the duration of a single irradiation and the number of observations. Therefore, if the duration of a single irradiation can be controlled, the total irradiation time can be controlled.

Control of the irradiation time can be achieved by, for example, controlling a current value to the light source or mechanically blocking the light path. If it is determined that deterioration in the activity of the living specimen is minor, control of the irradiation time may be omitted during observation to place priority upon the processing speed.

With the above-described structure, observation can be completed in a shorter period of time for long-term and short-term observation while still maintaining the activity of the living specimen.

The observation conditions can include the irradiation interval.

The irradiation interval is the period of time from the end of one irradiation to the start of the subsequent irradiation. A plurality of irradiation light conditions is related to phototoxicity. For example, even though the amount of irradiation light is large, the activity of the living specimen itself is enhanced if the irradiation interval is relatively long. Therefore, the impact of phototoxicity on the living specimen is relatively low. Therefore, it is important to control the irradiation interval. For example, if deterioration in the activity of the living specimen is expected, the irradiation interval is controlled by controlling the shutter or controlling the supply of electrical current to the light source.

The irradiation interval may be controlled by changing the irradiation light from pulsed irradiation to continuous irradiation for the purpose of high-speed observation or vice versa. If the activity of the living specimen is decreased abruptly, the irradiation interval may be changed.

With the above-described structure, the activity of the living specimen can be maintained for long-term and short-term observation.

The observation conditions can include the illuminance.

Phototoxicity is affected by a combination of a plurality of parameters associated with observation-related information. For example, even with the same irradiation dose, characteristics of phototoxicity change depending on the amount of light. For this reason, a luminous quantify, particularly the illuminance, is controlled based on the finally set irradiation interval.

More specifically, control of the illuminance can be achieved by adjusting, for example, the light source or the filter. The illuminance may also be controlled by increasing the irradiation light intensity for the purpose of high-speed observation.

With the above-described structure, the activity of the living specimen can be maintained for long-term and short-term observation of the activity.

The observation conditions can include the pulse frequency or the pulse width of the irradiation light.

For this purpose, irradiation light is preferably pulsed light. The term “pulsed light” includes light waves whose intensity continuously changes, such as sinusoidal waves and sawtooth waves, as well as light waves whose brightness changes in a step-wise manner (intermittently), such as those represented by the σ function.

For irradiation with pulsed irradiation light, the living specimen is irradiated two or more times. Therefore, light whose energy is sufficiently low can be used as irradiation light. By doing so, deterioration in the activity of the living specimen can be suppressed. Furthermore, fluorescence can be prevented from fading. As a result, a sufficiently bright observation image can be acquired. It is known that pulsed light irradiation exhibits lower phototoxicity than continuous irradiation in terms of the total irradiation energy. Therefore, phototoxicity can be reduced by controlling the pulse frequency or the pulse width.

Light sources for producing such irradiation light include, for example, a strobe light source and a pulsed laser. Furthermore, the light source may be realized by a light source generating light with constant brightness (a continuous emission light source) provided with a modulation apparatus that modulates light from this continuous emission light source to form pulsed light. Alternatively, an LED may be used. In this case, a pulsed light source with superior stability and high-speed performance can be achieved by modulating the input electrical power (voltage and current) at high speed.

With the above-described structure, the activity of the living specimen can be maintained for long-term and short-term observation.

The observation conditions can include the irradiation area.

For example, the irradiation area is restricted according to the observation area. The living specimen is prevented from being exposed to more irradiation light than necessary by irradiating a minimum required area. Control of the irradiation area can be achieved by means of the optical system (objective lens, condenser lens) or the field stop (irradiation-field stop).

With the above-described structure, unwanted irradiation is prevented, and deterioration in activity of the living specimen can be prevented for long-term and short-term observation.

This system includes a culture unit for holding a living specimen; an illumination unit for guiding irradiation light to the culture unit; an imaging unit for acquiring an image of the culture unit; and a processing unit provided with a storage section for storing acquired images and predetermined observation conditions, an arithmetic section for performing predetermined arithmetic operations, and a control section for controlling the culture unit, the illumination unit, and the imaging unit. The arithmetic section executes the step of obtaining the degree of activity specific to the living specimen, the step of obtaining a phototoxicity value based on predetermined observation conditions, and the step of obtaining a threshold. Based on the threshold, the control section can control at least one of the culture unit, the illumination unit, and the imaging unit.

With the above-described structure, observation under optimal conditions that do not decrease the activity of the living specimen is always ensured. Therefore, an observation result with high reliability can be obtained. Furthermore, observation conditions can be controlled automatically in real time. Therefore, the ease of use of the system can be enhanced.

This system is a living-specimen observation and measurement system for controlling predetermined observation conditions to allow a living specimen to be observed. The predetermined observation conditions can be set so as to produce a phototoxicity value lower than a threshold calculated based on the activity specific to the living specimen.

With the above-described structure, observation under optimal conditions that do not decrease the activity is always ensured merely by controlling the observation conditions. Furthermore, observation under optimal conditions that do not decrease the activity of the living specimen is always ensured. Therefore, an observation result with high reliability can be obtained.

### EMBODIMENT

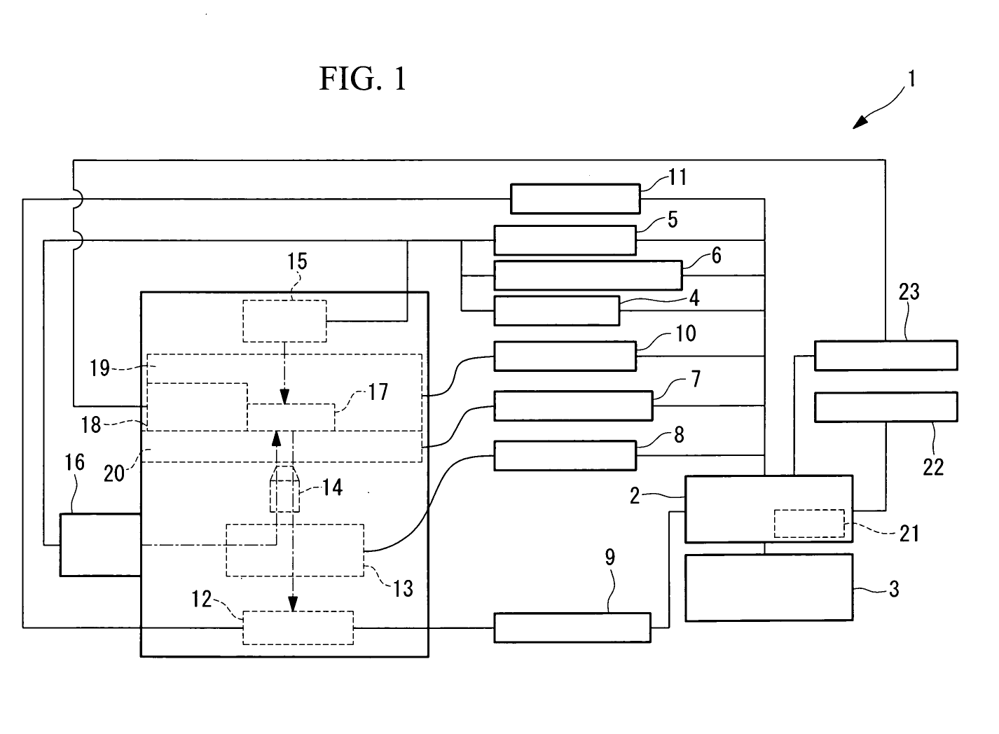

A living-specimen observation and measurement system according to one embodiment of the present invention will now be described with reference to FIGS. 1 to 29. FIG. 1 is a block diagram depicting a living-specimen observation system according to this embodiment, showing the overall structure of an observation and measurement system for observing a living cell (hereinafter, referred to as a living-cell observation and measurement system 1).

The living-cell observation and measurement system 1 includes various types of control sections, various types of arithmetic sections, a storage section, and an observation section. The various types of control sections include a central control section 2, an irradiation-field control section 4, an irradiation-time control section 5, an irradiation-energy control section 6, a stage control section 7, an irradiation-wavelength control section 8, a culture-environment control section 10, and an imaging control section 11. The various types of arithmetic sections include a phototoxicity-value arithmetic section 22 and an activity arithmetic section 23. The storage section includes a data storage memory 9. The observation section includes an imaging unit 12, a wavelength selection unit 13, an objective lens 14, a transmitted illumination unit 15, an epi-illumination unit 16, a culture unit 19, and a stage 20. The culture unit 19 includes a culture vessel 17 and an activity monitoring unit 18. The living-cell observation and measurement system 1 includes a user interface 3.

The operator controls observation conditions via this user interface 3. Observation conditions are sent to the phototoxicity-value arithmetic section 22 via the central control section 2. The phototoxicity-value arithmetic section 22 calculates a phototoxicity value based on observation conditions or with reference to a database of the data storage memory 9. On the other hand, the activity arithmetic section 23 obtains the degree of activity with reference to information from the activity monitoring unit 18 or information in the data storage memory 9. The phototoxicity value and the degree of activity are sent to the central control section 2, which obtains a threshold and determines phototoxicity.

If the phototoxicity value is smaller than the threshold, the central control section 2 instructs the various types of control sections (except the central control section 2) to carry out observation based on the observation conditions. As a result, observation is started. On the other hand, if the phototoxicity value is larger than the threshold, the central control section 2 prompts the operator to re-control observation conditions via the user interface 3. Alternatively, observation conditions that allow observation to be carried out are automatically controlled, and observation is started.

<Various Types of Control Sections>

Each control section will now be described in detail.

The central control section 2 is a controller for centrally managing all devices associated with observation and culturing. The various types of control sections (except the central control section 2), the various types of arithmetic sections, the data storage memory 9, and the user interface 3 are all connected to the central control section 2. The central control section 2 issues an instruction to each device and also receives information from each device to start or terminate observation and culture living cells.

The central control section 2 obtains a threshold based on the phototoxicity value output from the phototoxicity-value arithmetic section 22 and the degree of activity output from the activity arithmetic section 23. The central control section 2 is provided with a determination section 21. The determination section 21 determines whether the activity of the living cell is degraded based on the phototoxicity value and the threshold. Thereafter, the central control section 2 carries out a control operation based on the determination result.

The culture-environment control section 10 includes a control function for forming and maintaining an environment required to culture living cells. The culture-environment control section 10 is connected to the culture unit 19. The culture unit 19 is a space (area) where an environment suitable for culturing living cells is maintained. Environmental factors affecting the culture environment include CO₂, humidity, pH, salt concentration, and temperature for mammalian living cells, for example. These environmental factors are set by the operator. A temperature of 37° C., a CO₂ concentration of 5% (pH 6.8 to 7.2), and saturated humidity are basic and common environmental settings. The culture unit 19 is shielded from ambient light. Thus, living cells are exposed only to light required for observation.

The imaging control section 11 controls when to perform imaging and the imaging time in the imaging unit 12. The imaging control section 11 is connected to the imaging unit 12. The imaging unit 12 can be realized by, for example, a CCD camera or a photomultiplier tube. If the imaging unit 12 is realized by a photomultiplier tube, irradiation light is formed at a spot which is scanned on living cells.

The irradiation-time control section 5 controls the duration of a single irradiation of irradiation light, the irradiation interval, the number of irradiations, and the irradiation light continuity. Specific control includes, for example, control of the shutter. The duration of a single irradiation, the irradiation interval, the number of irradiations, and the irradiation light continuity can be controlled by blocking or unblocking irradiation light using the shutter. Since the illumination units include a light source, this light source itself may serve as control means. More specifically, the duration of a single irradiation, the irradiation interval, the number of irradiations, and the irradiation light continuity can be controlled by controlling (turning on/off) electrical power (voltage and current) to be supplied to the light source.

The irradiation-energy control section 6 controls the amount of light to be radiated on the living cells. Specific control includes, for example, control of the ND filter. The amount of light radiated onto the living cells can be controlled by providing or removing ND filters with different light reduction rates in the light path. Alternatively, a disc whose light reduction rate differs in the circumferential direction may be rotated in the light path. Since the illumination units include a light source, this light source itself may serve as control means. More specifically, the duration of a single irradiation, the irradiation interval, the number of irradiations, and the irradiation light continuity can be controlled by controlling (changing) the electrical power (voltage and current) to be supplied to the light source.

The irradiation-field control section 4 controls (restricts) the irradiation area of irradiation light according to the observation area set by the operator.

The irradiation-field control section 4, the irradiation-time control section 5, and the irradiation-energy control section 6 are connected to at least one of the transmitted illumination unit 15 and the epi-illumination unit 16.

The irradiation-wavelength control section 8 controls the wavelength of irradiation light to be radiated onto living cells. The irradiation-wavelength control section 8 is connected to the wavelength selection unit 13. Specific control includes control of the optical filter. The wavelength of irradiation light radiated onto the living cells can be controlled by providing or removing optical filters with different spectral transmittance characteristics in the light path. Since the illumination units include a light source, this light source itself may serve as control means. More specifically, the wavelength of irradiation light can be controlled by controlling (changing) the electrical power (voltage and current) to be supplied to the light source.

The stage control section 7 controls the positions of living cells. The stage control section 7 is connected to the stage 20. In order to observe living cells, the living cells need to be located within the field of view of the objective lens 14. The living cells are held in the culture vessel 17. The culture vessel 17 is mounted on the stage 20. Therefore, the living cells can be located within the field of view of the objective lens 14 by moving the stage 20.

<Observation Section>

The transmitted illumination unit 15 and the epi-illumination unit 16 each include a light source and an optical system. The transmitted illumination unit 15 and the epi-illumination unit 16 each include a field stop, an aperture stop, and an ND filter. The field stop also serves to restrict the irradiation field. Furthermore, a diffuser plate, a color filter, and so forth can be provided in the transmitted illumination unit 15 and the epi-illumination unit 16.

The transmitted illumination unit 15 is used mainly for morphology observation. On the other hand, the epi-illumination unit 16 is used mainly for fluoroscopy. The transmitted illumination unit 15 and the epi-illumination unit 16 each include a light source and an illumination optical system. The light source is realized by, for example, a halogen lamp, a mercury lamp, a xenon lamp, a laser, or an LED. It is sufficient that the living-cell observation and measurement system 1 includes at least one of the transmitted illumination unit 15 and the epi-illumination unit 16.

The light source is preferably capable of delivering pulsed oscillation, in addition to continuous oscillation (CW light). For pulsed oscillation, the light source is realized by a strobe light source or a pulsed laser. To achieve pulsed light, a continuous emission light source and a modulation apparatus may be combined to realize the light source. The modulation apparatus includes a function for modulating light from the continuous emission light source to form pulsed light. Alternatively, the electrical power of the light source itself may be controlled. For example, when using an LED, stable and high-speed pulsed light can be delivered by modulating electrical power (voltage) at high speed. Furthermore, a pulsed light source with superior stability and high-speed performance can be realized.

The culture unit 19 includes the culture vessel 17 and the activity monitoring unit 18. The culture vessel 17 is used to culture and hold living cells.

The activity monitoring unit 18 includes a function for obtaining the activity of the living cells. The activity monitoring unit 18 is a measurement function section and is connected to the activity arithmetic section 23. To obtain the activity of the living cells, control cells are measured instead of the living cells serving as the object to be observed. The degree of activity of the living cells can also be obtained by measuring the living cells themselves serving as the object to be observed. In this case, it is not necessary to provide the activity monitoring unit 18.

One culture vessel 17 is disposed in the culture environment. Two culture areas are defined in the culture vessel 17. The living cells, serving as the object to be observed, reside in one culture area (culture area A) of the above-described two culture areas. Control cells reside in the other culture area (culture area B). The control cells are held under the same culture conditions and observation conditions as those in the culture area A. The activity monitoring unit 18 is disposed adjacent to the culture area B. While the living cells in the culture area A are observed, the activity monitoring unit 18 performs measurement for obtaining the degree of activity of the control cells.

One method for obtaining the degree of activity of the control cells is to measure the absorbance using an MMT reagent. This method draws upon a phenomenon that as the activity of living cells decreases, the absorbance also decreases. In this manner, since the absorbance and the degree of activity of living cells are correlated, the degree of activity of the living cells can be obtained from the absorbance. For this reason, the activity monitoring unit 18 using this measuring method preferably includes at least a light source, an optical system, and a photodetector (CCD, PD, or photomultiplier tube) so as to measure the absorbance. Furthermore, it is also preferable that an arithmetic section be provided since arithmetic operations are required to obtain the degree of activity from the absorbance. This arithmetic section may be provided in the activity monitoring unit 18. Alternatively, this arithmetic section may be realized by the arithmetic section used to obtain the activity based on living specimen information and fluorochrome information.

The reagent may be, for example, the Live/Dead Reagent. The measuring method may differ depending on the drug used. Therefore, the specific structure of the activity monitoring unit 18 differs depending on the drug used.

In this manner, the degree of activity can be obtained using, for example, a reagent.

Another method for measuring the degree of activity of control cells is to obtain the degree of activity based on observation of the morphology of the living cells. To observe the morphology of living cells, observation techniques such as the phase contrast technique and the differential interference technique can be used. For this purpose, the activity monitoring unit 18 using this measuring method also preferably includes at least a light source, an optical system, and a photodetector (CCD, PD, or photomultiplier tube) in order to image the control cells.

The degree of activity can be obtained from the thickness or the shape of the living cells. For example, as the activity decreases, the thickness of living cells becomes smaller. Furthermore, as the activity decreases, the overall shape of living cells becomes round and the area of the living cells becomes smaller. For this reason, information, such as the thickness, area, profile, and so forth, about the living cells is pre-stored. The morphology of the living cells is observed, as required, in the course of observation. Subsequently, the thickness, area, and profile of the living cells are obtained from an observation result and are compared with the stored information to obtain the degree of activity based on respective differences.

At this time, it is sufficient to check a change in the morphology by analyzing an image of the living cells through the use of a system (e.g., image processing apparatus) and allow the system to automatically determine the degree of activity based on the analysis result. Alternatively, the operator may obtain (estimate) the degree of activity based on his/her experience from the morphology image. Furthermore, both approaches may be used. In addition, the degree of activity may be obtained based on an abnormality in cell cycle recognized in the course of long-term observation. Also in this case, an arithmetic section is preferably provided. This arithmetic section may be provided in the activity monitoring unit 18. Alternatively, this arithmetic section may be realized by the arithmetic section used to obtain the activity based on living specimen information and fluorochrome information. Alternatively, for example, an image processing apparatus may be used in place of this arithmetic section.

In this manner, the degree of activity can be obtained by observing the morphology of the living cells.

As described above, control cells are cultured in the culture area B and irradiated with (exposed to) light under the same observation conditions (irradiation conditions) as those for the living cells serving as the object to be observed, and the actual degree of activity is measured in the activity monitoring unit 18. An actual measurement can be regarded as a result representing the degree of activity of the living cells serving as the object to be observed. In this manner, the degree of activity of the living cells can be obtained more accurately.

In order to match observation conditions between the living cells serving as the object to be observed and the control cells, it is preferable that, for example, the living cells serving as the object to be observed and the control cells be irradiated with light at the same time. For this purpose, two (one pair of) structures for emitting irradiation light are required. In fact, a single structure for emitting irradiation light may be used by moving the living cells serving as the object to be observed and the control cells to the same radiation area sequentially. In this case, although simultaneous irradiation is not accomplished, part of the activity monitoring unit 18 can advantageously be used as a component for observing the living cells (e.g., the objective lens 14). Therefore, substantially the same observation conditions can be controlled for both the living cells serving as the object to be observed and the control cells without making the system structure complicated.

Two culture vessels may be prepared so that one culture vessel serves for the culture area A and the other for the culture area B, and the activity monitoring unit 18 may be provided adjacent to the other culture vessel.

The stage 20 supports the culture unit 19. The stage 20 also includes a movement mechanism. With this movement mechanism, the culture vessel 17 can be moved in two orthogonal axial directions. Through this movement, the living cells can be positioned within the field of view of the objective lens 14.

The wavelength selection unit 13 includes optical filters with different spectral transmittance characteristics. More specifically, for example, a plurality of optical filters is disposed outside the light path and along the light path. Irradiation light having wavelengths (spectral band) required for observation can be obtained by inserting at least one optical filter into the light path. Furthermore, a plurality of optical filters is disposed along the circumferential direction of the disc. The disc is disposed so that the axis passing through the center of this disc is parallel to the light path. An optical filter is inserted into or removed from the light path by rotating the disc. Irradiation light having wavelengths required for observation can be obtained also in this manner.

The user interface 3 is used by the operator to control desired observation conditions related to observation and culturing. The user interface 3 includes, as required, input devices, such as a keyboard and a mouse, and a display device for screen display.

The data storage memory 9 saves images acquired by the imaging unit 12. Furthermore, the data storage memory 9 saves observation conditions input via the user interface 3. The data storage memory 9 may include a database. The position of the data storage memory 9 may be fixed or may be specified by the operator.

The database can be built in a component residing physically independently of this system (e.g., remotely disposed database server) by providing the system 1 with a communication function.

Furthermore, the data storage memory 9 may be provided with an analysis function for analyzing acquired images of the living cells.

The database registers the degrees of contribution or coefficients corresponding to observation condition values, separately for each observation condition. Phototoxicity values may also be registered in the database. If an observation condition value input via the user interface 3 does not exist in the database, the degree of contribution or the coefficient corresponding to the input value can be obtained by interpolation using numerical values stored in the database. Consequently, whatever value is input, a corresponding phototoxicity value can be obtained based on observation conditions.

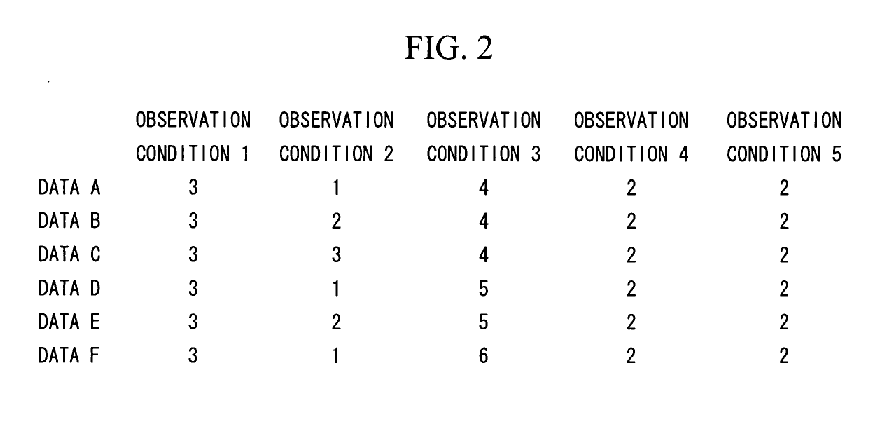

If the database is used, the database can be built assuming that no combinations of observation conditions (combinations of degrees of contribution) degrade the activity of the living cells. This database includes five types of observation conditions (observation conditions 1 to 5), as shown in, for example, FIG. 2. Although observation conditions 1 to 5 are combined in FIG. 2, no particular combinations are specified. For example, a combination of three observation conditions 1, 3, and 5 or a combination of six observation conditions 2, 3, 4, 7, 8, and 9 is also acceptable.

A degree of contribution is assigned to each of the observation conditions 1 to 5. Here, the degree of contribution is a numerical value ranging from 1 to 6, and each observation condition is assigned a value from 1 to 6. Therefore, a total of 6⁵ combinations of the degrees of contribution are available. It should be noted, however, that the database in this example does not register a combination of the degrees of contribution that degrades the activity of the living cells because the database assumes that no observation conditions degrade the activity. For example, a combination of degrees of contribution 3, 1, 4, 2, and 2 is specified for data A, whereas a combination of degrees of contribution 3, 1, 6, 2, and 2 is specified for data F.

Since these observation conditions and degrees of contribution are registered in the database, the operator only has to select a combination of observation conditions registered in the database. In this case, whatever combination is selected, the activity of the living cells is not degraded. Therefore, it is not necessary to make a determination as to phototoxicity.

In the case of this database, the operator cannot enter observation conditions or degrees of contribution via the user interface 3 if he or she does not know the contents of the database. Therefore, it is necessary to prepare the contents of the database in a list separately from the system or to display the contents of the database on the display device of the system so that the operator can select observation conditions or degrees of contribution on the display device.

A determination as to phototoxicity may also be made using the database in FIG. 2.

For example, assume that the input combination of observation conditions is as shown in Table 1. In this case, the input combination of observation conditions matches a combination of observation conditions registered in the database. However, the input combination of degrees of contribution matches none of the combinations for data A to F. Comparing FIG. 2 and Table 1, the degrees of contribution for observation conditions 1, 3, 4 and 5 are the same among data A, data B, data C, and the data entered by the operator. On the other hand, with respect to observation condition 2, the degree of contribution (a value of 5) set by the operator is larger than the maximum value of 3 (data C) from among data A, B, and C. Therefore, the central control section 2 determines that the entered observation conditions are “phototoxic.”

TABLE 1

| Observation | Observation | Observation | Observation | Observation |
|---|---|---|---|---|
| Condition 1 | Condition 2 | Condition 3 | Condition 4 | Condition 5 |
| 3 | 5 | 4 | 2 | 2 |

Then, assume that the input combination of observation conditions is as shown in Table 2. In this case, the input combination of observation conditions and the input combination of degrees of contribution match data E registered in the database. Therefore, the central control section 2 determines that the observation conditions are “non-phototoxic.”

TABLE 2

| Observation | Observation | Observation | Observation | Observation |
|---|---|---|---|---|
| Condition 1 | Condition 2 | Condition 3 | Condition 4 | Condition 5 |
| 3 | 2 | 5 | 2 | 2 |

Furthermore, assume that the input combination of observation conditions is as shown in Table 3. In this case, the input combination of observation conditions matches a combination of observation conditions registered in the database. However, the input combination of degrees of contribution matches none of the combinations for data A to F. Comparing FIG. 2 and Table 3, the degrees of contribution for observation conditions 1, 3, 4 and 5 are the same among data D, data E, and the data entered by the operator. On the other hand, with respect to observation condition 2, the degree of contribution (a value of 1.5) set by the operator is smaller than the maximum value of 2 (data E) from among data D and E. Therefore, the central control section 2 determines that the entered observation conditions are “non-phototoxic.”

TABLE 3

| Observation | Observation | Observation | Observation | Observation |
|---|---|---|---|---|
| Condition 1 | Condition 2 | Condition 3 | Condition 4 | Condition 5 |
| 3 | 1.5 | 5 | 2 | 2 |

In the above-described example, a degree of contribution is input as a numerical value representing an observation condition. In general, however, observation conditions are represented as numerical values (e.g., a laser output value of 5 mW) associated with parameters of components. Therefore, these numerical value associated with parameters of components should be input. In this case, a numerical value associated with a parameter of a component is automatically converted into a degree of contribution (or a coefficient).

The activity arithmetic section 23 includes a function for obtaining the degree of activity from the living cells serving as the object to be observed. The degree of activity of living cells can be obtained from living specimen information, fluorochrome information, or observation of the living cells. Such living specimen information and fluorochrome information are not only input via the user interface 3 but also pre-stored in the data storage memory 9. Therefore, the activity arithmetic section 23 is connected to the user interface 3 and the data storage memory 9 via the central control section 2.

The activity arithmetic section 23 is connected to the activity monitoring unit 18 so that the degree of activity can be obtained through observation of the living cells. Although a threshold can be obtained in the activity arithmetic section 23, a threshold can also be obtained in the central control section 2.

The phototoxicity-value arithmetic section 22 includes a function for obtaining a phototoxicity value from observation conditions. A phototoxicity value can be obtained from observation conditions. Such observation conditions are controlled via the user interface 3 or are pre-stored in the data storage memory 9. Therefore, the phototoxicity-value arithmetic section 22 is connected to the user interface 3 and the data storage memory 9 via the central control section 2.

The phototoxicity-value arithmetic section 22 obtains a phototoxicity value based on a unique expression D using observation conditions (λ: the wavelength of irradiation light, t: the duration of a single irradiation, I: the amount of light radiated onto the living specimen, b: the irradiation interval, n: the number of irradiations, p: continuity of irradiation light) or based on information registered in the database. If a phototoxicity value is obtained based on information registered in the database, the database assumes no particular conditions. More specifically, it is not assumed (demanded) that combinations of observation conditions (combinations of degrees of contribution) do not cause the activity of living cells to decrease.

Although a threshold may be obtained or observation conditions may be set again in the phototoxicity-value arithmetic section 22, these operations can also be performed in the central control section 2. The operator first inputs desired observation conditions via the user interface 3. This constitutes the initial setting of observation conditions. The observation conditions are stored in the data storage memory 9 via the central control section 2. The process of obtaining a phototoxicity value is carried out immediately based on the stored conditions.

This process is described below.

(1) Representing Phototoxicity in the Form of a Numerical Value

Irradiation conditions of irradiation light that cause the activity of living cells to deteriorate include the wavelength of the irradiation light, the irradiation interval, the number of irradiations, and the dose of a single irradiation. Therefore, a phototoxicity value can be represented as a function including these factors in the form of parameters. For example, a phototoxicity value can be calculated using the following unique expression D:
Phototoxicity value=wavelength of irradiation light×irradiation interval×number of irradiations×dose of a single irradiation.

In the unique expression D, the values for the wavelength of irradiation light, the irradiation interval, the number of irradiations, and the dose of a single irradiation can be represented in the form of numerical values representing observation conditions, degrees of contribution, or coefficients. Furthermore, for example, one parameter may be a function of another parameter (e.g., the number of irradiations may be represented as n(λ), in which case the number of irradiations is a function of the wavelength of irradiation light).

If the degree of contribution or the coefficient is to be used, the degree of contribution or the coefficient is retrieved from the database. Furthermore, if an observation condition has no corresponding numerical value registered in the database, a numerical value representing the degree of contribution or the coefficient may be calculated using an interpolation or extrapolation technique based on numerical values registered in the database. A numerical value representing the coefficient needs to fall in the range from 0 to 1 (e.g., the coefficient corresponding to the wavelength that causes the most serious damage (the amount of change in the degree of activity) is assumed to be 1 in the case of the wavelength of irradiation light).

Of the amounts of light, all amounts except the radiant flux are based on the radiant flux. The radiant flux is the radiant energy per unit area (unit: W). Some amounts of light are represented as quantities per unit area (luminance, illuminance, exitance, etc.). In this case, the dose of a single irradiation is represented by the following expression:
Dose of a single irradiation=“amount of light radiated onto the living cells”×duration of a single irradiation.

For quantities that are not represented as values per unit area (e.g., radiant flux, intensity, luminous flux, etc.), the dose of a single irradiation is represented by the following expression:
Dose of a single irradiation=“amount of light radiated onto the living cells” per unit area×duration of a single irradiation.

The “amount of light radiated onto the living cells” per unit area is represented by the following expression:
Amount of light radiated onto the living cells per unit area=“amount of light radiated onto the living cells”/irradiation area.

The rated output of the light source differs depending on whether the light source is a continuous oscillation light source or a pulsed oscillation light source. The rated output of the light source is determined when the type of the light source is specified.

The amount of light radiated onto the living cells may be measured directly on a specimen surface or may be calculated from a monitored output value immediately after the output of the light source. In the latter case, the amount of light radiated onto the living cells, as measured at a specimen surface, can be calculated by the following expression:
Amount of light, at specimen surface, radiated onto the living cells=rated output of the light source×transmittance of the optical system.

The transmittance of each component of the optical system is pre-registered as internal data in the data storage memory 9. Therefore, when each component of the optical system (condenser lens, objective lens, optical filter) is selected, the total transmittance of the entire optical system is automatically obtained.

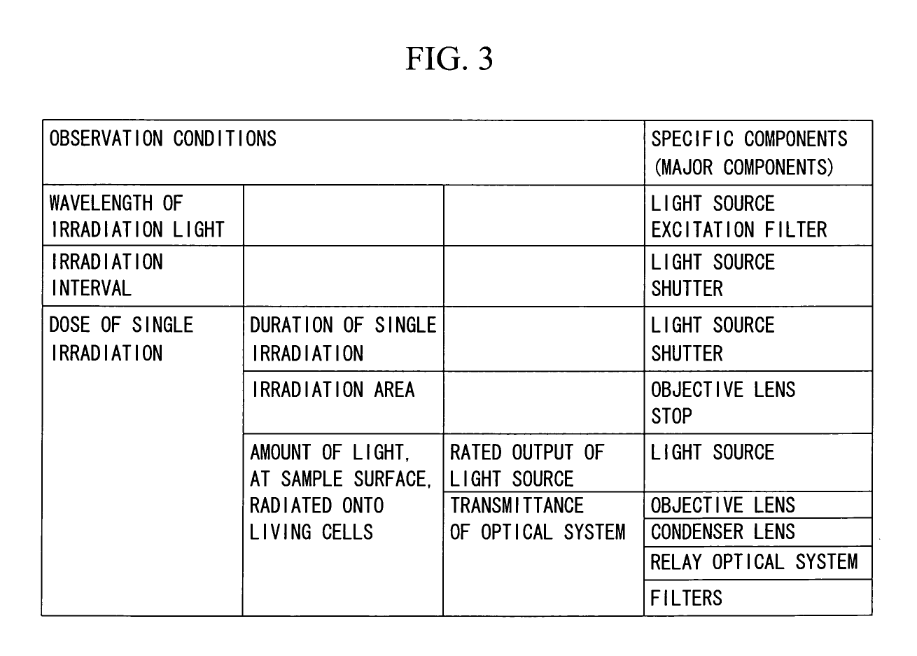

The irradiation area is determined by the illumination optical system (condenser lens and objective lens). The relationship between these observation conditions for obtaining a phototoxicity value and specific components related to these observation conditions is shown in FIG. 3.

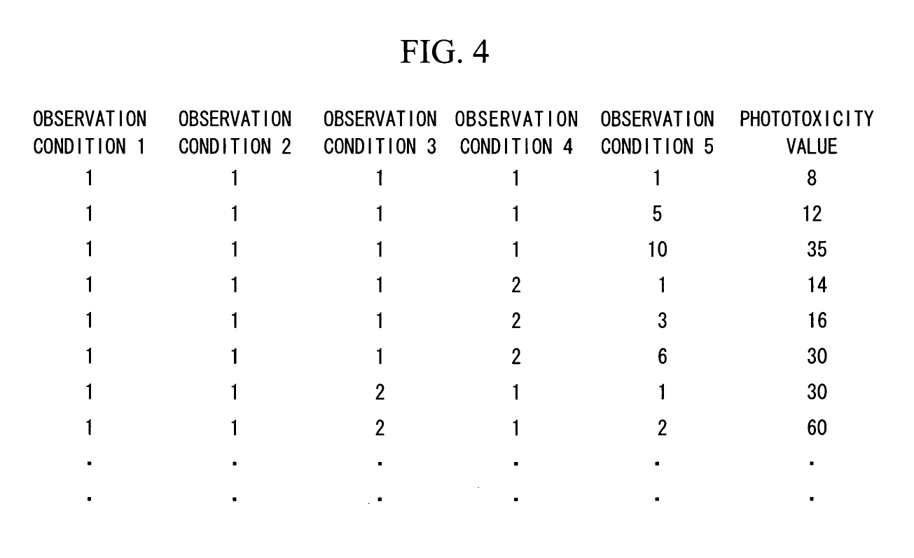

The method of obtaining a phototoxicity value in the phototoxicity-value arithmetic section 22 is not limited to the calculation method based on the unique expression D. For example, phototoxicity may be obtained using the database. In this case, the database pre-registers observation conditions and their degrees of contribution, as well as a phototoxicity value corresponding to each combination of the degrees of contribution. In short, the correspondence between observation conditions and phototoxicity values is registered in the database as shown in FIG. 4. By doing so, a phototoxicity value can be obtained easily merely by inputting a combination of observation conditions and numerical values via the user interface 3.

If the input numerical value representing an observation condition is not registered in the database, a phototoxicity value can be obtained using an interpolation or extrapolation technique.

The phototoxicity-value arithmetic section 22 may include a function for updating phototoxicity values based on the history of observation conditions and phototoxicity values associated with observation carried out in the past. Phototoxicity values may be accumulated and updated by the operator himself/herself or may be automatically accumulated and updated. This function may be provided in the central control section 2.

(2) Representing the Activity in the Form of a Numerical Value

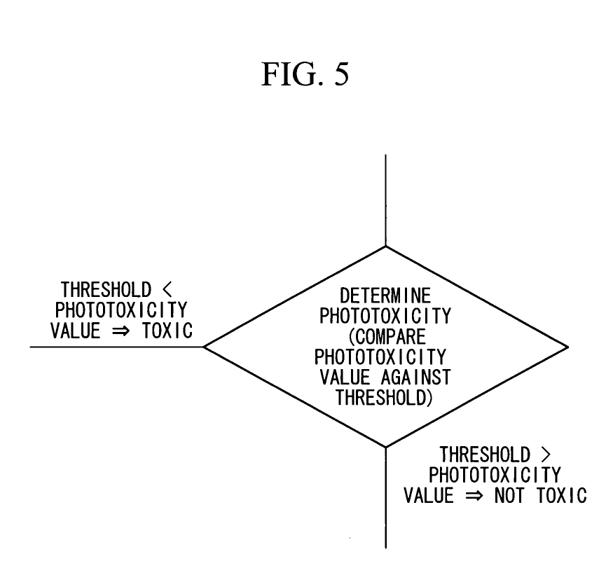

Referring to FIG. 5, a determination as to phototoxicity is made by determining whether the phototoxicity value exceeds a threshold. A threshold can be obtained based on the degree of activity. Therefore, it is necessary to represent the activity of living cells in the form of a numerical value, that is, to pre-calculate the degree of activity in the activity arithmetic section 23.

Representing the degree of activity in the form of a numerical value will be described below.

The degree of activity of living cells depends on, for example, the time period from seeding to measurement. The degree of activity of living cells depends also on an adhesive state. For example, non-adherent cells are weaker than adherent cells. Therefore, measurement sensitivity in a non-adhesive state is affected more than measurement sensitivity in an adhesive state.

Factors affecting the activity of living cells include the cell density (number of cells per unit area) and the seeding density. If the cell density or the seeding density is lower than necessary, the activity is more sensitive to phototoxicity.

Other conceivable living specimen information (parameters related to living cells) includes the following items:

Cell type (type of living specimen),

Cell density (represented as the tissue density of the living specimen: number of cells per unit area),

Culture environment (environment in which the living specimen is cultured: temperature, humidity, pH of the culture medium, carbon dioxide concentration, etc.),

Adhesive state (adhesive state of the living tissues),

Cultured cells or noncultured cells (whether the living specimen is formed of cultured tissues or noncultured tissues),

Presence of a delivered drug (whether a drug is administered to the living specimen),

Seeding concentration (concentration of the living specimen when it is seeded), and

Time elapsed since seeding (time that has passed since the living specimen was seeded).

Conceivable fluorochrome information (parameters related to fluorochrome) includes the following items:

Fluorochrome type, and

Fluorochrome concentration.

As described above, the degree of activity of living cells can be obtained based on living specimen information and fluorochrome information.

The activity of living cells may be registered in the database as shown in Table 4.

TABLE 4
Living cell A: fluorochrome X

| Fluorochrome concentration | | | | |
|---|---|---|---|---|
| 0.1% | 0.5% | 1% | 5% | 10% |

Culture environment 1
(temperature 36° C., humidity 90%, pH 7, CO₂ concentration 5%)

| | | | | | |
|---|---|---|---|---|---|
| Degree of activity | 105 | 52 | 14 | 8 | 2.5 |

Culture environment 2
(temperature 37° C., humidity 90%, pH 7, CO₂ concentration 5%)

| | | | | | |
|---|---|---|---|---|---|
| Threshold | 100 | 50 | 10 | 5 | 1 |

Culture environment 3
(temperature 38° C., humidity 90%, pH 7, CO₂ concentration 5%)

| | | | | | |
|---|---|---|---|---|---|
| Degree of activity | 98 | 45 | 8 | 4.5 | 0.75 |

By doing so, the degree of activity of living cell A can be obtained from the culture environment, fluorochrome name, and fluorochrome concentration. It is assumed that the degree of activity in Table 4 is represented as the degree of contribution.

Values not registered in the database (lookup table: LUT) can be estimated through interpolation or extrapolation.

### EXAMPLE 1

The degree of activity corresponding to a fluorochrome concentration of 0.3% in culture environment 1 can be estimated from the values of the degrees of activity corresponding to fluorochrome concentrations of 0.1% and 0.5% through, for example, interpolation.

### EXAMPLE 2

The degree of activity corresponding to a fluorochrome concentration of 0.5% at an incubation temperature of 39° C. can be estimated from the values of the degrees of activity at temperatures of 37° C. and 38° C. (temperature of 36° C. in some cases) through, for example, an extrapolation technique.

A method of obtaining the degree of activity of living cells from living specimen information and fluorochrome information will now be described. These items of information can be represented in the form of numerical values derived from the specifications of components themselves, the degree of contribution, or the coefficient. Here, these items of information are assumed to be represented as coefficients.

For the adhesive state and the cell density, their respective coefficients are obtained according to the adhesive state and the cell density under predetermined conditions (in the same culture environment and with the same fluorochrome concentration). Thereafter, with respect to the maximum value of the adhesive state or the cell density, other values can be normalized.

For example, the completely separate state can be assigned to 0.1, whereas the completely adhesive state can be assigned to 1 (adhesion coefficient). Alternatively, the separate state may be assigned to 1, and the completely adhesive state may be assigned to 0.1. The separate state is not likely to depend on a change in other conditions (culture environment or fluorochrome concentration) and, therefore, can be regarded as constant under any conditions.

The adhesive state greatly depends on the time elapsed after cell seeding and, therefore, may be represented as a coefficient simply by using the time elapsed after seeding. Furthermore, a difference between cultured cells and noncultured cells and the presence of a delivered drug can be represented in the form of numerical values (cultured-cell coefficient and delivered-drug coefficient) in the same manner.

As a result, the degree of activity is obtained by the following relational expression:
Degree of activity=cell-density coefficient×adhesion coefficient (elapsed-time-after-seeding coefficient)×cultured-cell coefficient×delivered-drug coefficient.

It is sufficient that this arithmetic operation is carried out in the activity arithmetic section 23.

It is needless to say that the adhesion coefficient, cell-density coefficient, cultured-cell coefficient, and delivered-drug coefficient are not the only factors that determine the expression for obtaining the degree of activity. Furthermore, the above-described arithmetic expression is not the only one that determines the degree of activity. Thus, living specimen information, fluorochrome information, or an arithmetic operator is added, deleted, or changed in some cases.

If the degree of activity is to be obtained from the morphology of living cells, the degree of activity can be obtained from the ratio between the morphology of the living cells before the start of observation and the morphology of the living cells after the start of observation. Furthermore, the rate of change in the morphology may differ depending on the type of living cells. Therefore, instead of using only the ratio, the ratio and a coefficient representing the living specimen information may be combined.

For example, the cell area is expressed by the following expression:
Degree of activity=area of living cells after the start of observation/area of living cells before the start of observation, or
Degree of activity=area of living cells after the start of observation/area of living cells before the start of observation×cultured-cell coefficient.

In this case, the cell-density coefficient, the adhesion coefficient, the cultured-cell coefficient, and the delivered-drug coefficient may be represented as a function of another coefficient (e.g., the cell-density coefficient is represented as a function whose variable is the cultured-cell coefficient).

The activity arithmetic section 23 can obtain a new degree of activity based on the result of degree-of-activity measurement carried out in the past and the history of observation results.

(3) Setting a Determination Criterion (Threshold)

A determination criterion (threshold) is set in the central control section 2. The central control section 2 sets a threshold for the degree of activity (FIG. 33B) or sets a threshold for the phototoxicity value (FIG. 34).

If a threshold is set for the degree of activity, the threshold is (1) the degree of activity before the start of observation or (2) a value smaller than the degree of activity before observation is started. The value of the threshold can be determined comprehensively based on the history of observation results, the objective of observation, operator's experience, and so forth. The central control section 2 preferably includes a function for automatically recording the results of degree-of-activity measurements carried out in the past, history of observation results, and the objective of observation. The central control section 2 preferably includes a function for updating the determination criterion (threshold). The data for the threshold may be accumulated and updated by the operator himself/herself or may be automatically accumulated and updated.

The foregoing embodiment has been described by way of an example where the central control section sets a threshold. In contrast, the operator may directly input and set a threshold based on his/her experience.

(4) Initial Setting Parameters

The types and values of living specimen information and fluorochrome information are determined at the time of observation. Therefore, these basically are parameters not used to control the initial observation conditions. However, these parameters can be changed during observation and, therefore, may be included in the observation conditions.

The initial setting parameters are observation conditions controlled (e.g., input and set) via the user interface 3 before observation. Setting of initial parameters is described below in detail.

For the initial setting operation, the following three items of information are set. These items of information may be set in any order:

3-1 Hardware information (observation conditions),

3-2 Fluorochrome information, and

3-3 Living specimen information.

An example of a setting procedure is described below. In the example of FIG. 6, the apparatus structure of this system is shown as a graphic image. When a certain component is clicked, information that can be set in relation to the component is displayed.

The operator performs setting in response to the displayed information.

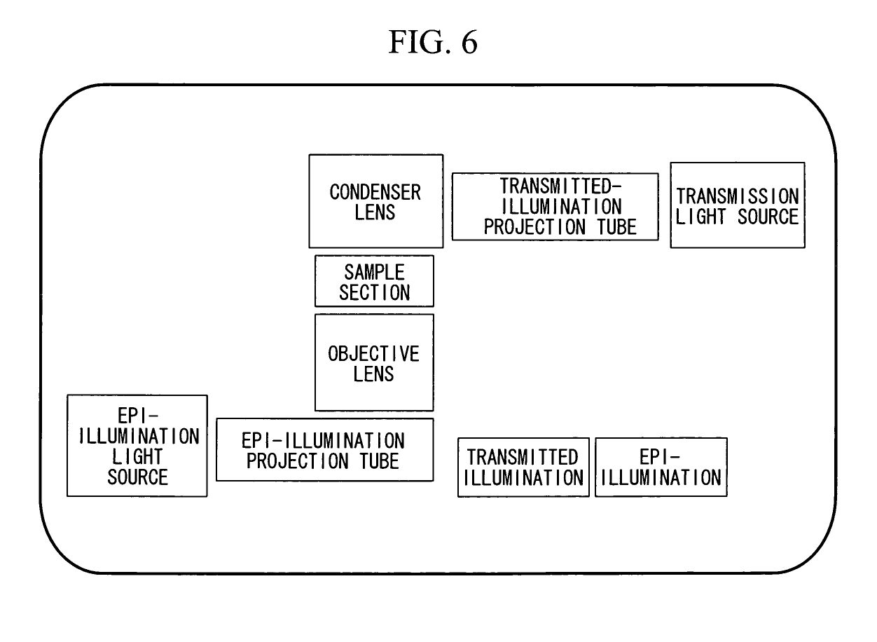

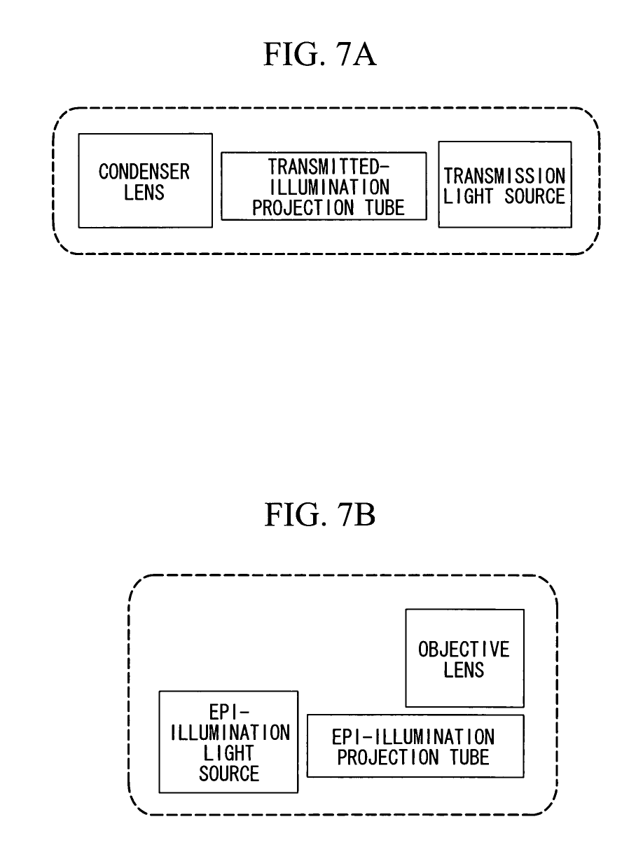

First, the irradiation method is set (the term “irradiation” has the same meaning as the term “illumination” in the current description). In the above-described example, a block for selecting transmitted illumination or epi-illumination is displayed at a predetermined position on the screen. As shown in FIGS. 7A and 7B, a block containing the condenser lens, transmitted-illumination projection tube, and transmission light source and a block containing the objective lens, epi-illumination projection tube, and epi-illumination light source may be displayed so that these blocks can be selected.

In either case, the blocks are designed to disappear upon completion of selection.

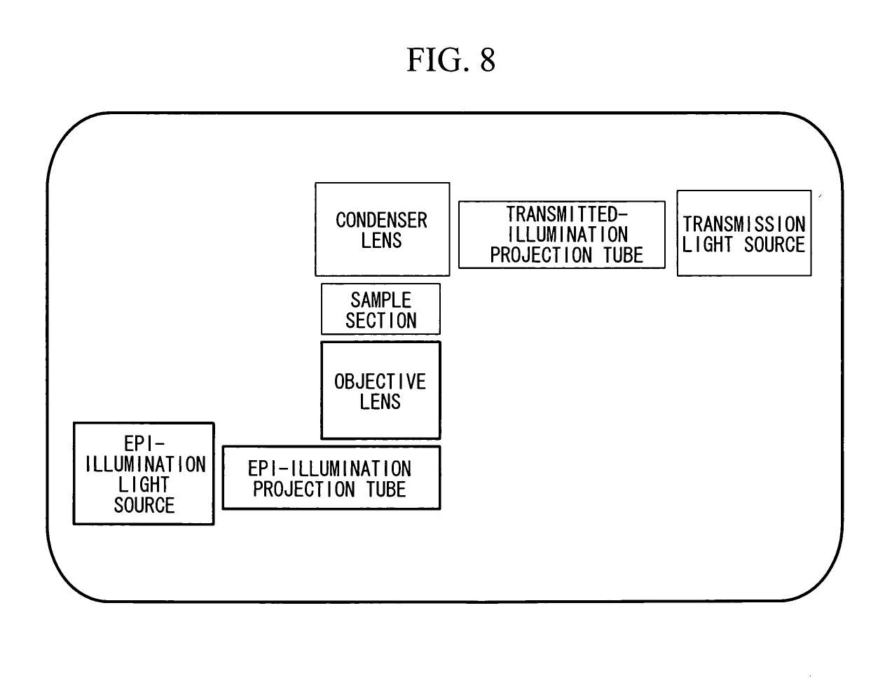

FIG. 8 is a diagram showing an apparatus structure assuming that the epi-illumination method is selected. In this case, the blocks containing the objective lens, epi-illumination projection tube, and epi-illumination light source are highlighted.

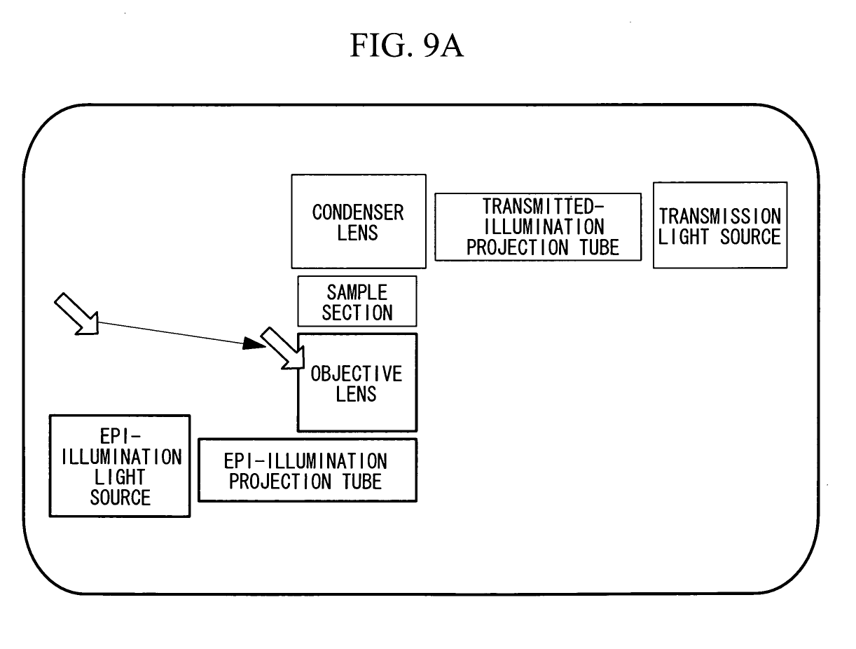

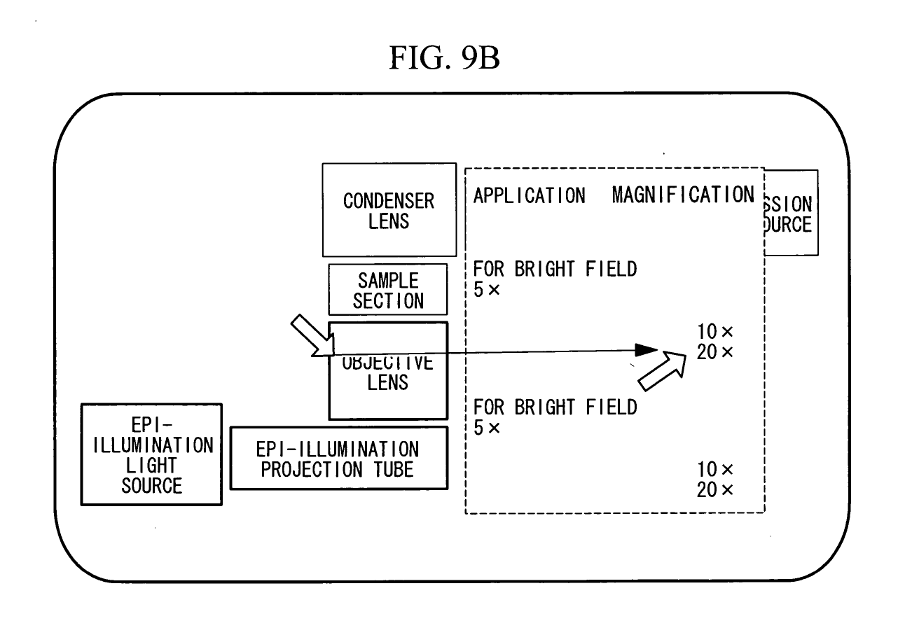

Next, as shown in FIGS. 9A and 9B, the operator performs setting for each block.

For example, when the cursor is moved to the block enclosing the objective lens, a list of objective lenses is displayed. In response to this displayed list, the operator moves the cursor to select a type and a magnification of objective lens suitable for observation. Upon completion of selection, the list automatically disappears. At the same time, the block containing the objective lens is de-highlighted.

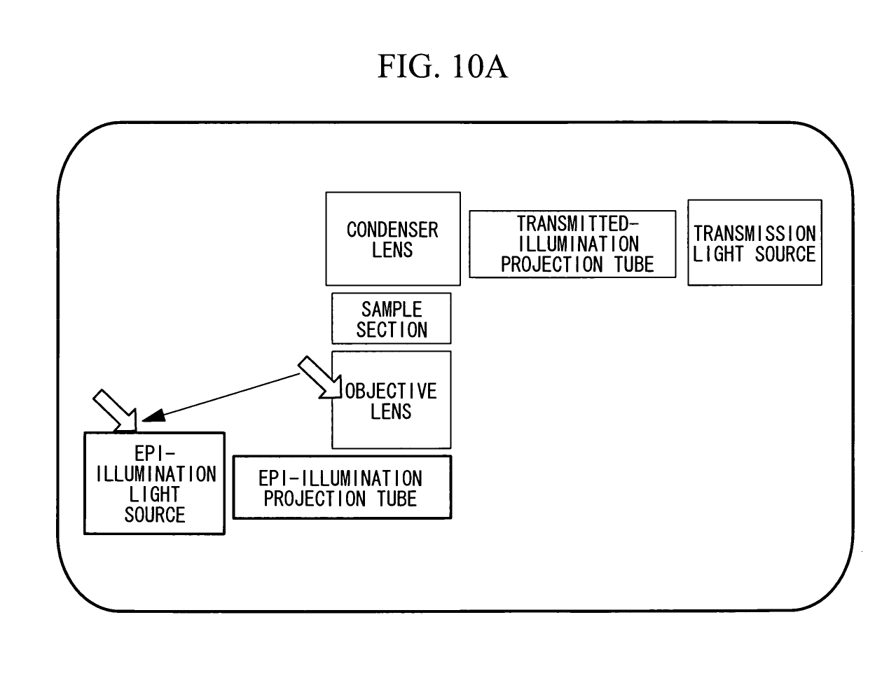

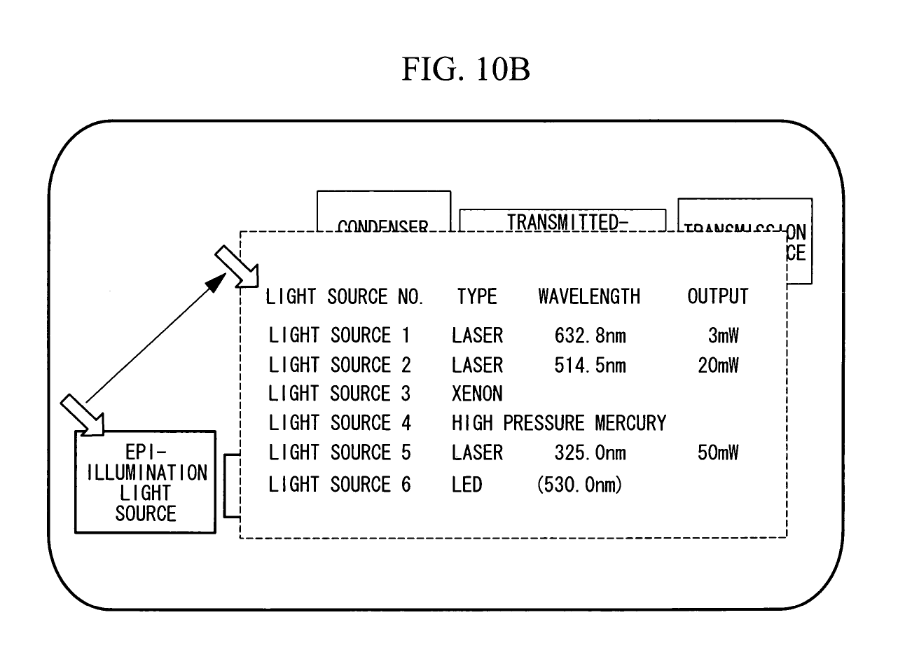

Next, as shown in FIG. 10A, the cursor is moved onto the block enclosing the epi-illumination light source. Then, a list of available light sources is displayed as shown in FIG. 10B. In response to this displayed list, the operator selects a light source suitable for observation. Upon completion of selection, the list automatically disappears. At the same time, the block containing the epi-illumination light source is de-highlighted.

For fluoroscopy, the type of the light source is restricted by the fluorochrome. This is because the excitation wavelength differs depending on the fluorochrome type.

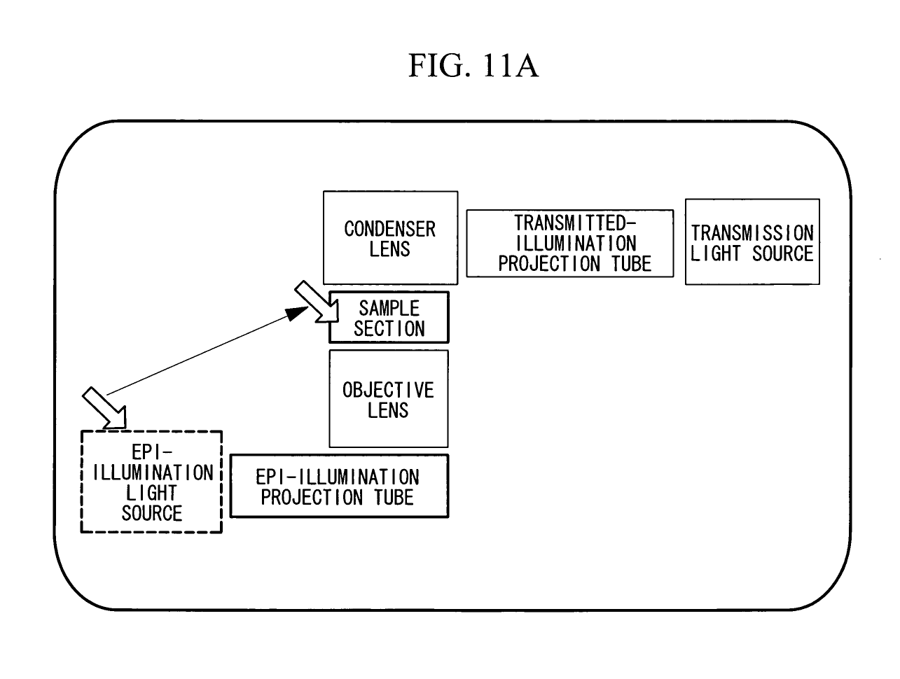

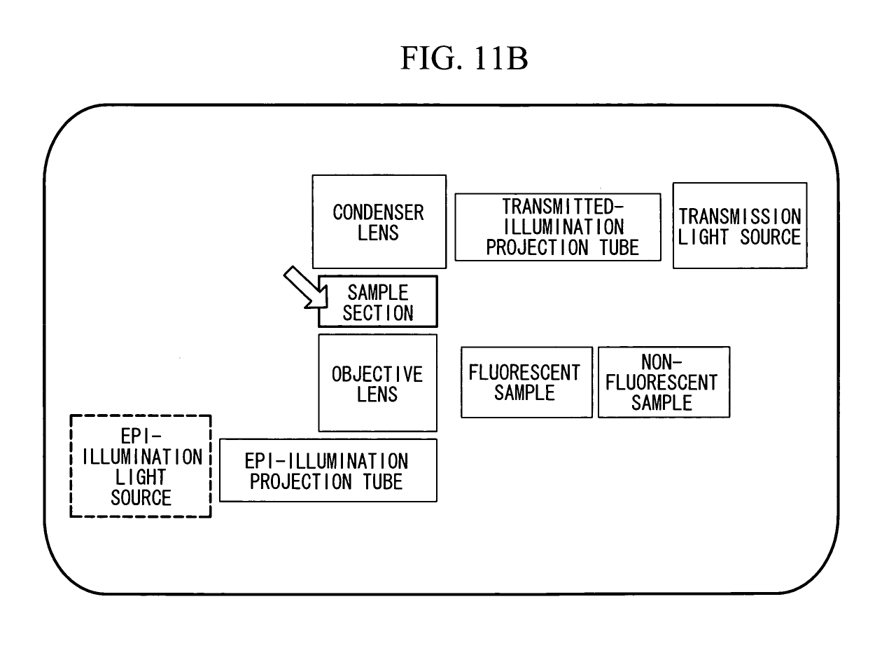

For this reason, when the block containing the epi-illumination light source is selected, an observation method may be set instead of displaying a list of light sources. For example, as shown in FIGS. 11A and 11B, when the block containing the epi-illumination light source is selected, the block containing the sample section is highlighted (the term “sample” is used to indicate living cells, that is, a living specimen). At the same time, the block containing the epi-illumination light source changes to indicate that setting is in progress (more specifically, the frame of the block is indicated by broken lines in the figure). When the operator moves the cursor onto the block containing the sample section, sample types are displayed. (The cursor may be automatically moved to the block containing the sample section as soon as the block containing the sample section is highlighted.)

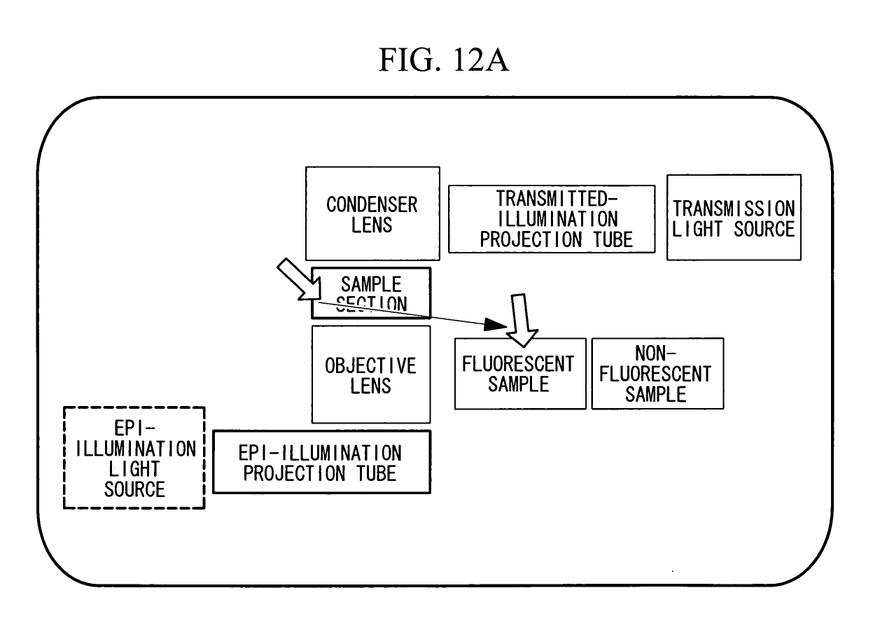

If the fluorescent sample is selected as a sample, a list of fluorochrome names is displayed as shown in FIGS. 12A and 12B. (A fluorochrome name may be entered.) The operator selects the fluorochrome that was used when the sample was generated.

Upon completion of selection, the list automatically disappears.

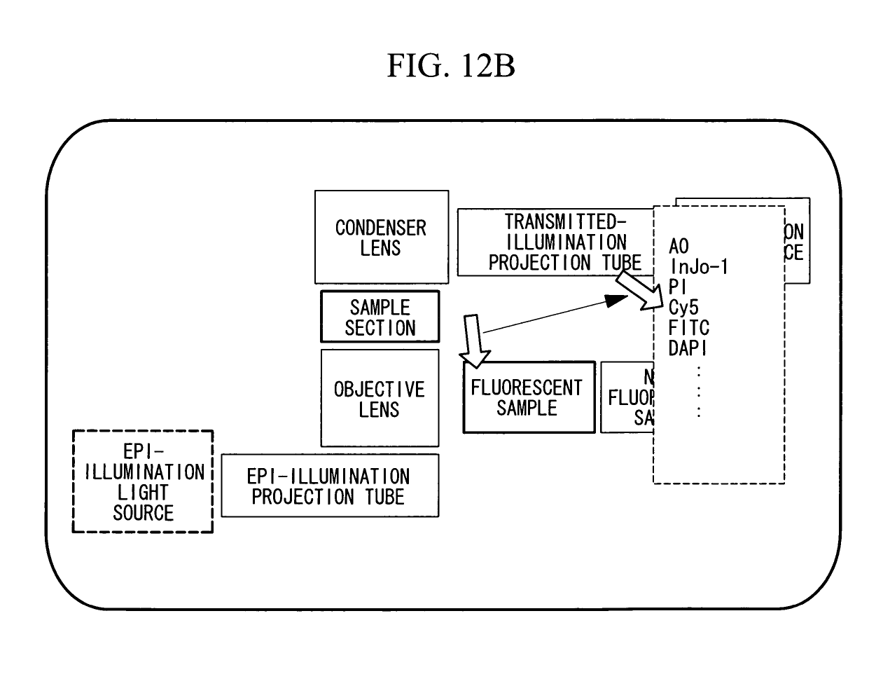

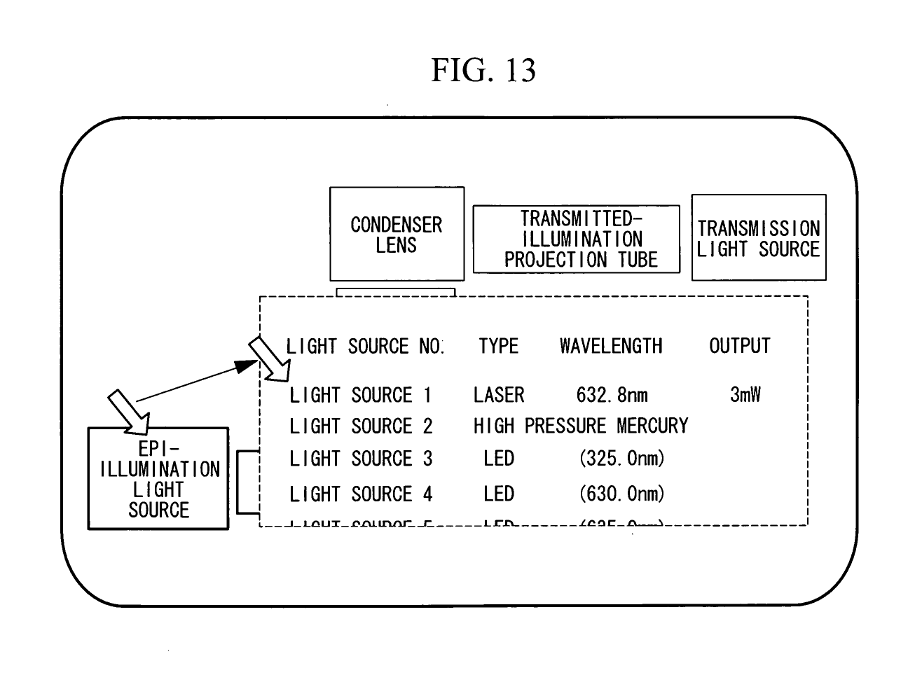

Subsequently, a list of epi-illumination light sources is displayed. Here, only light sources suitable for the selected fluorochrome are displayed. FIG. 13 shows an example where a fluorochrome that is excited in the wavelength region corresponding to red is selected. By doing so, the operator can quickly and easily set the light source to be used from among many light sources.

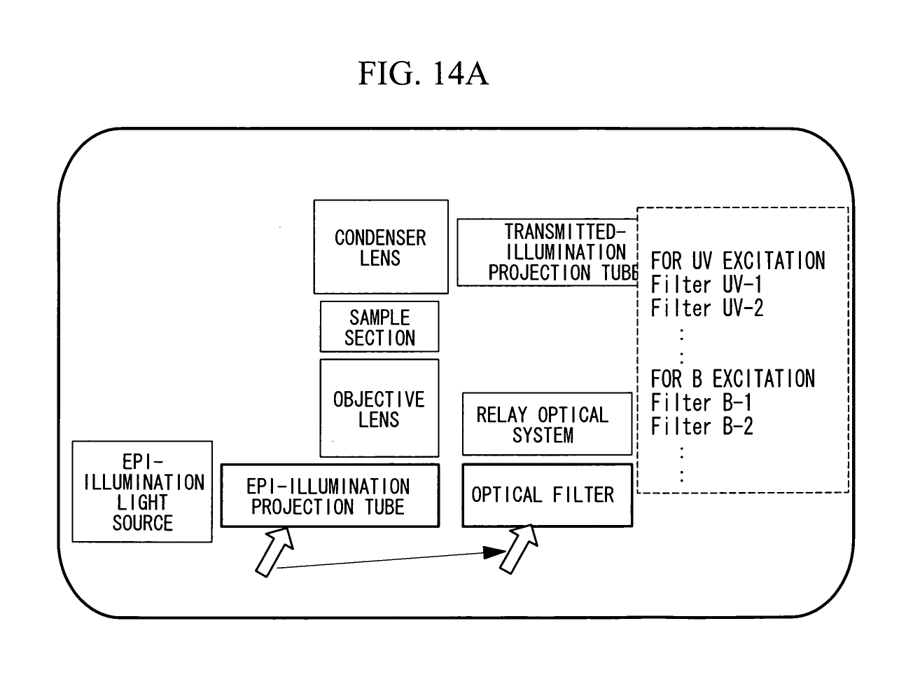

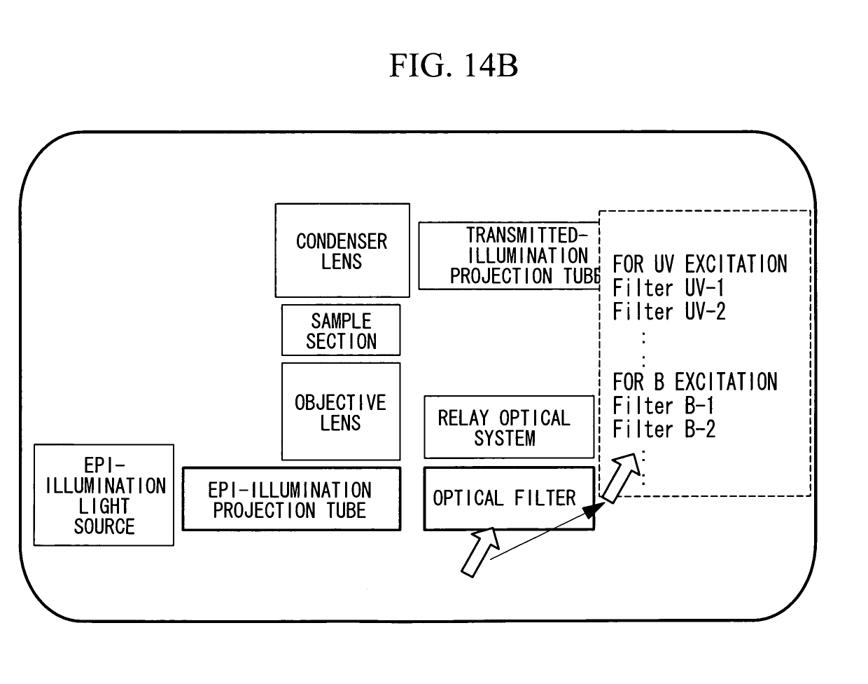

Next, the epi-illumination projection tube is selected as shown in FIGS. 14A and 14B. For the epi-illumination projection tube, a relay optical system and various types of optical filters (in particular, excitation filter) are set. If the epi-illumination light source has a one-to-one correspondence with the epi-illumination projection tube, setting may be performed automatically as soon as the epi-illumination light source is selected. If only one relay optical system is available, selection of a relay optical system is not performed. If a fluorochrome type has been determined, the excitation wavelength is determined, and therefore, an excitation filter can also be set automatically.

However, in case similar excitation filters are available or because a particular relay optical system is sometimes used intentionally, the operator is preferably allowed to select an excitation filter freely.

In the following example, a procedure for setting an excitation filter is described.

As shown in FIG. 14A, when the cursor is moved onto the block containing the epi-illumination projection tube, the block containing the relay optical system and the block containing the optical filter are displayed. When the optical filter is selected as shown in FIG. 14B, a list of optical filters is displayed. (An optical filter may entered.) The operator selects an optical filter to be used. Upon completion of selection, the list automatically disappears. When a plurality of optical filters is to be used, it is sufficient that the number of optical filters to be used is allowed to be input first, and then optical filters are set one by one as described in the above example.

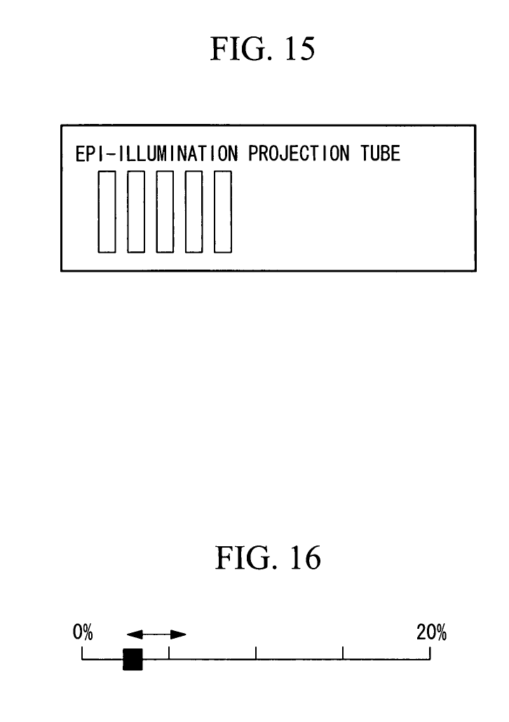

Alternatively, as shown in FIG. 15, a plurality of blocks indicating optical filters are displayed in the block containing the epi-illumination projection tube. Thereafter, the type of optical filter may be set for each block.

In this manner, setting of hardware information is completed.

If transmitted illumination is selected, setting is performed for each of the blocks containing the condenser lens, transmitted-illumination projection tube, and transmission light source.

Next, setting of fluorochrome information is performed. For setting of fluorochrome information, a fluorochrome type and a fluorochrome concentration are set. Setting of both the fluorochrome type and the fluorochrome concentration is achieved by selecting the sample section in this example. In the above-described example, when the block containing the epi-illumination light source is selected, the sample section is automatically selected. However, if the sample section is allowed to be selected independently from the epi-illumination light source, setting of fluorochrome information can be performed first. Setting of a fluorochrome type has been described above. Setting of a fluorochrome concentration can be carried out in the same manner as with the fluorochrome type. More specifically, it is sufficient to display a list of concentrations instead of a list of fluorochrome names. However, because continuous numerical values are used for the concentration, a method of entering a numerical value is preferable. Alternatively, a selectable range may be displayed, as shown in FIG. 16, so that the cursor is moved to any value for selection.

Furthermore, setting of living specimen information is carried out. Living specimen information includes the following items. The following items of information can be set using the above-described setting method:

Cell type,

Culture environment (temperature, humidity, pH of culture medium, carbon dioxide concentration),

Adhesive state,

Cultured cell or noncultured cell,

Presence of delivered drug,

Seeding concentration,

Cell density, and

Time of period from seeding to the start of observation.

It is needless to say that before setting these items of information, observation conditions (light source, relay optical system, optical filter, fluorochrome name, cell type, and so forth) need to be pre-registered in the database. Of the observation conditions, the output value and the spectral luminous characteristics of the light source can be derived from the specification values described in, for example, a light source catalogue. However, actual output values and spectral luminous characteristics may differ from such specification values. Therefore, actual measurements are preferably registered in the database by carrying out observation. For the relay optical system, the objective lens, the condenser lens, and various types of optical filters, not only their types but also spectral transmittance characteristics, are pre-registered. The spectral transmittance characteristics are required to calculate the rate of loss in irradiation light in the optical system when a phototoxicity value is to be calculated.

(4) Setting Observation Conditions

As described above, the following observation conditions 1 to 11 are available:

1: Type of light source,

2: Type of excitation filter,

3: Type of relay optical system,

4: Type of objective lens,

5: Type of condenser lens,

6: Types of various filters (including an ND filter and absorption filter),

7: Duration of a single irradiation,

8: Number of irradiations,

9: Total observation time,

10: Irradiation interval, and

11: Continuity of irradiation light (whether the irradiation light is continuous oscillation (luminescence) or pulsed oscillation (luminescence), and the pulse frequency or pulse width in the case of pulsed oscillation).

Of the above observation conditions, observation conditions 1 to 6 are also used at the time of initial setting.

Next, a procedure for setting observation conditions will be described.

1. Examples where no observation result is fed back

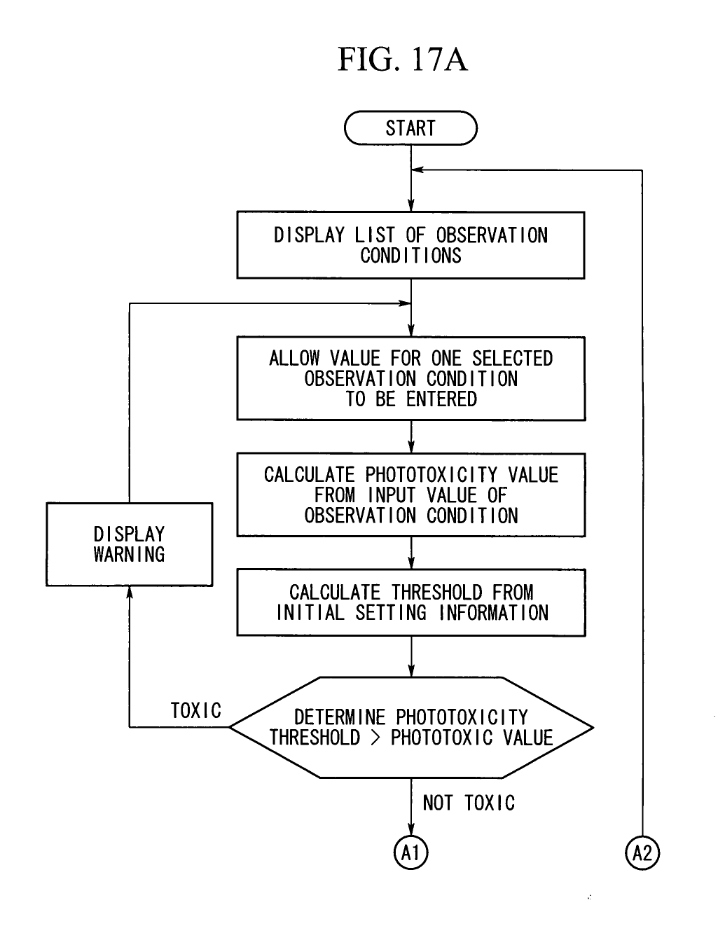

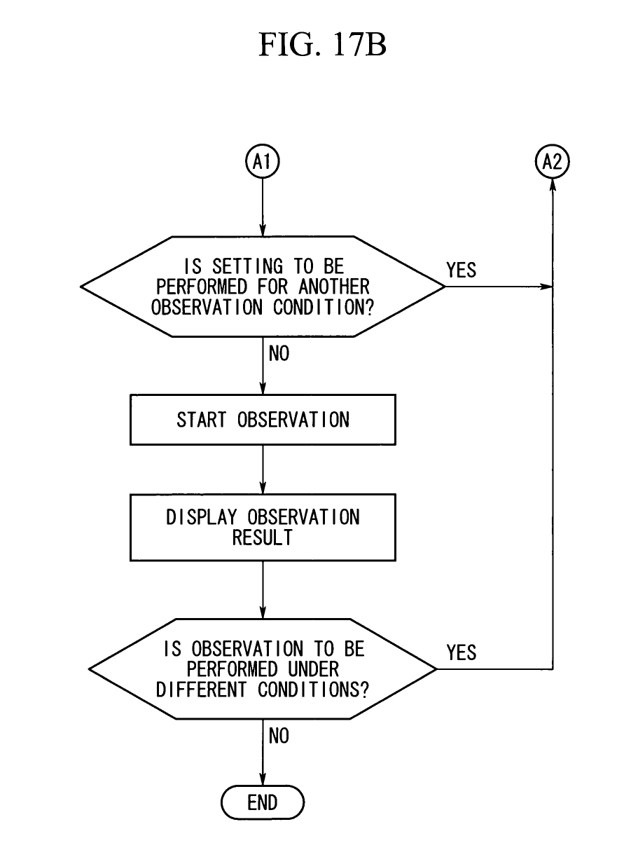

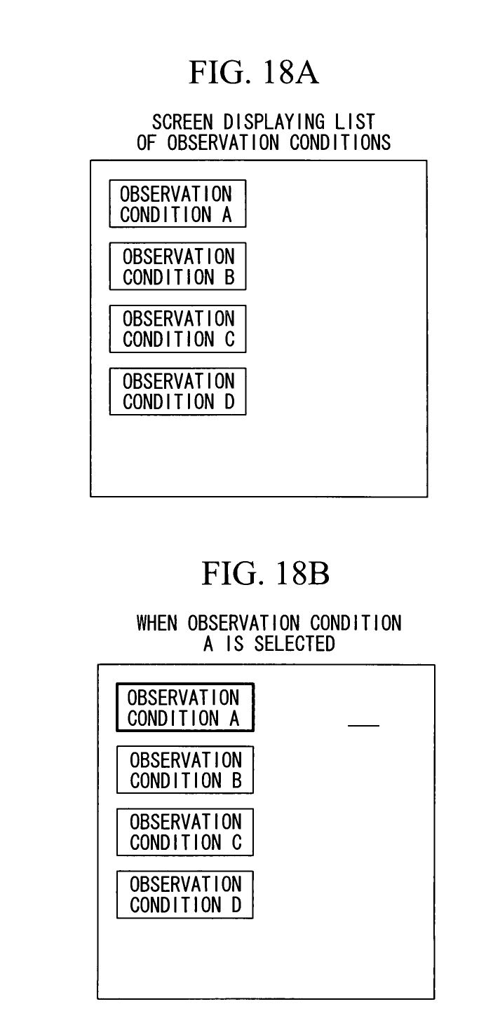

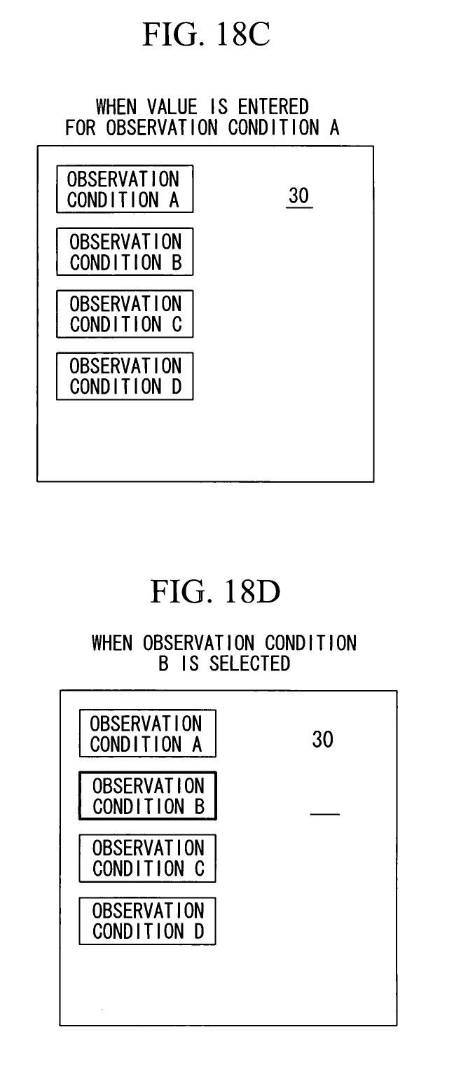

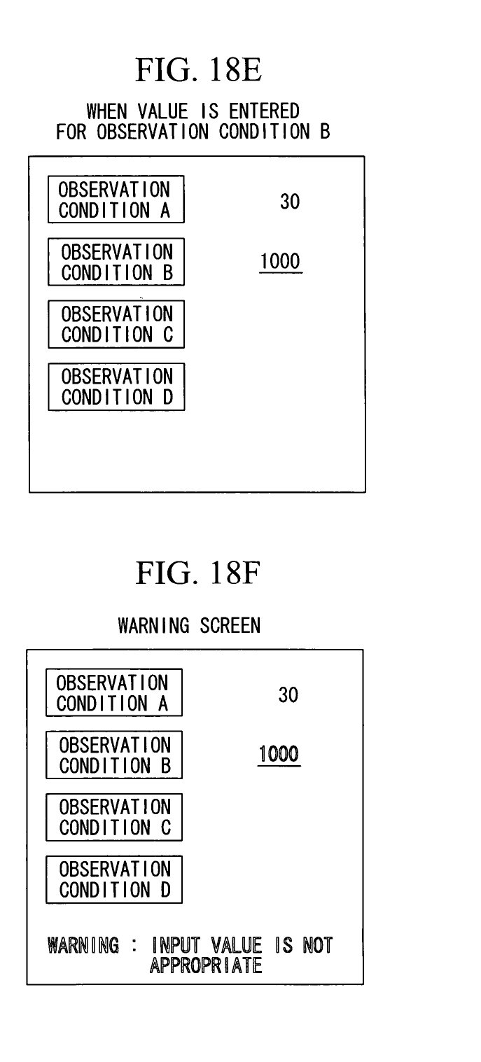

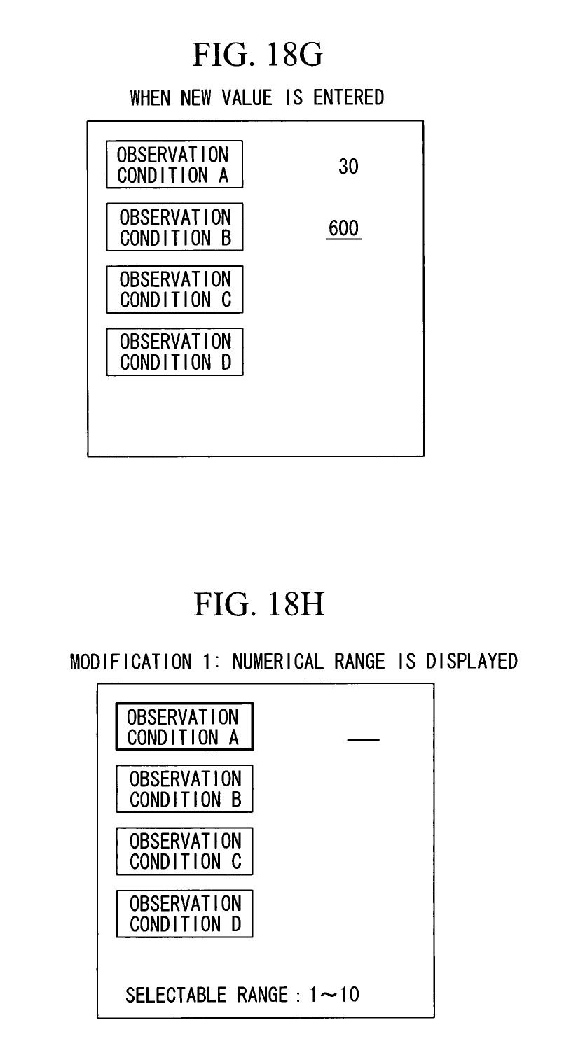

(1) Example where all numerical values for observation conditions are input freely (FIGS. 17A, 17B, and 18A to 18H)

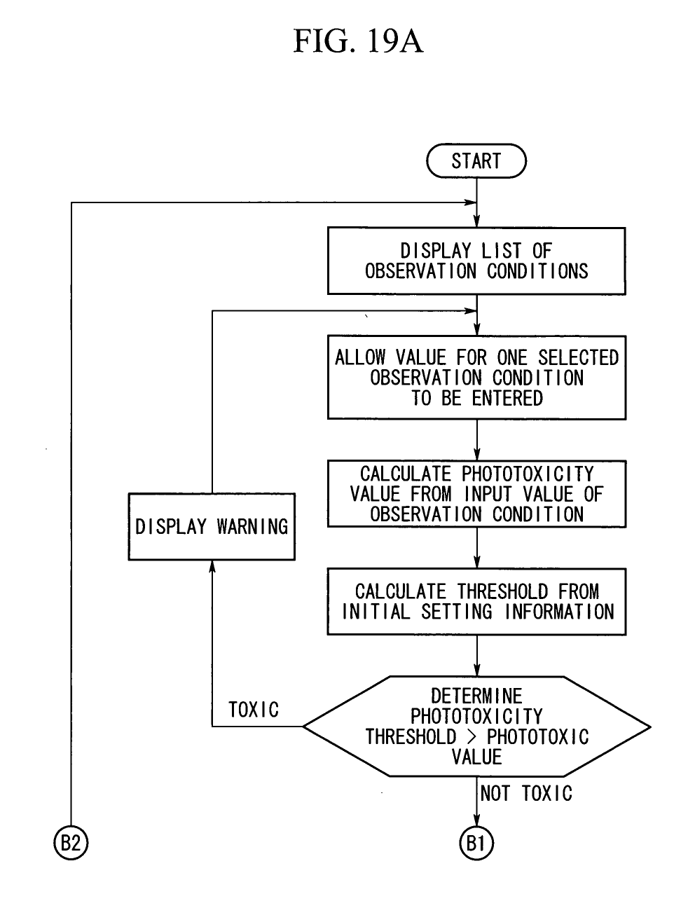

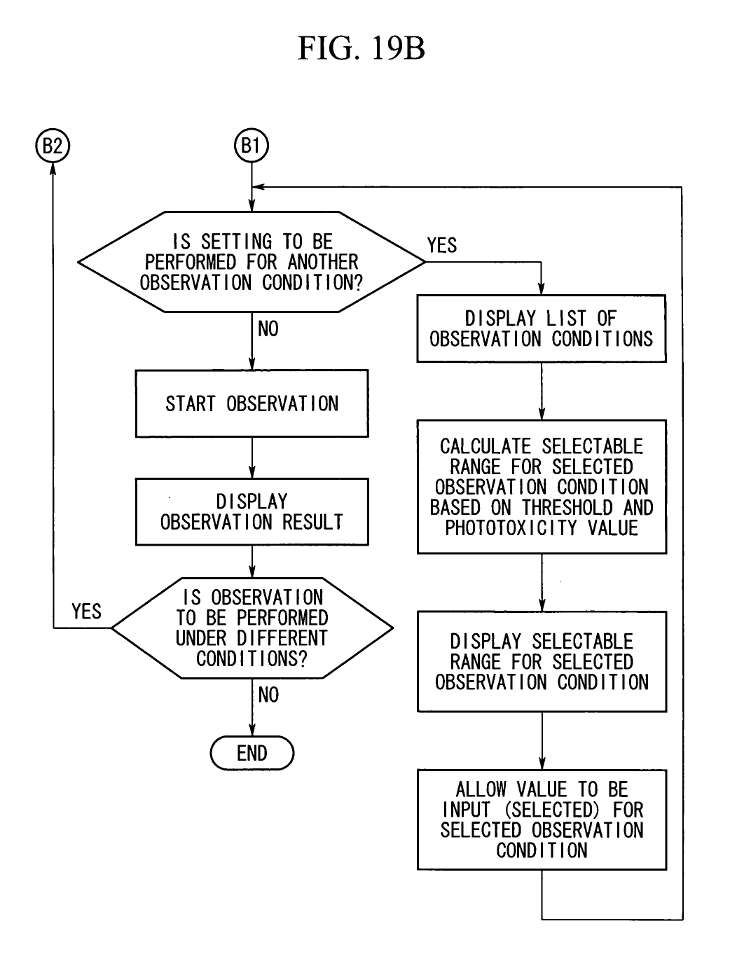

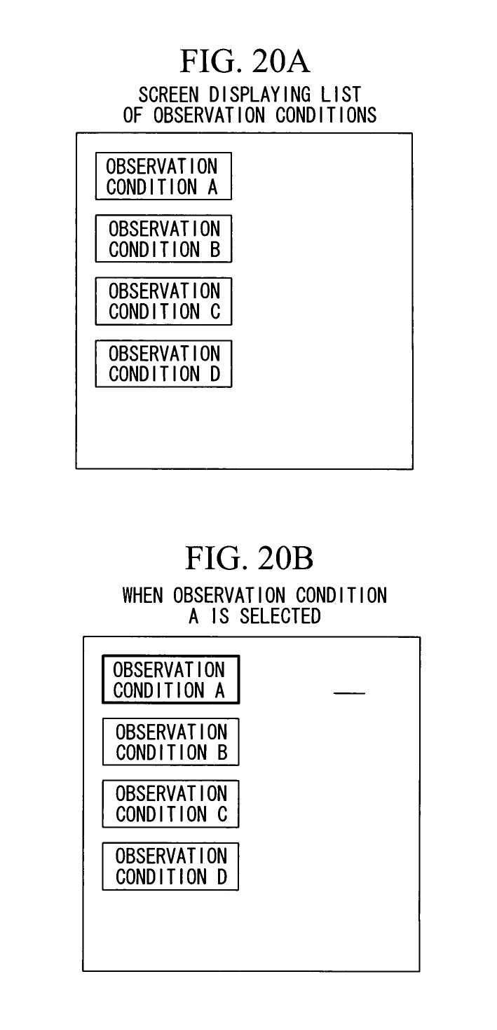

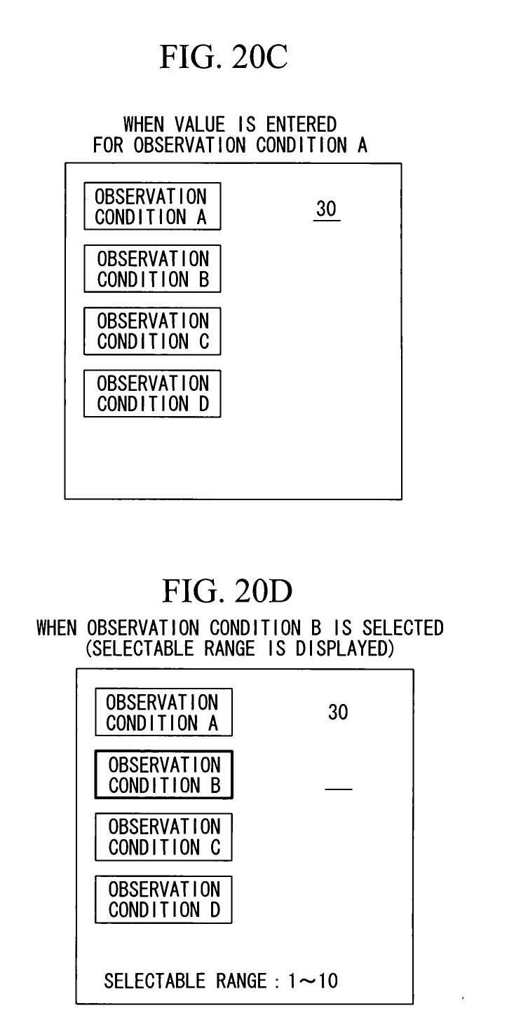

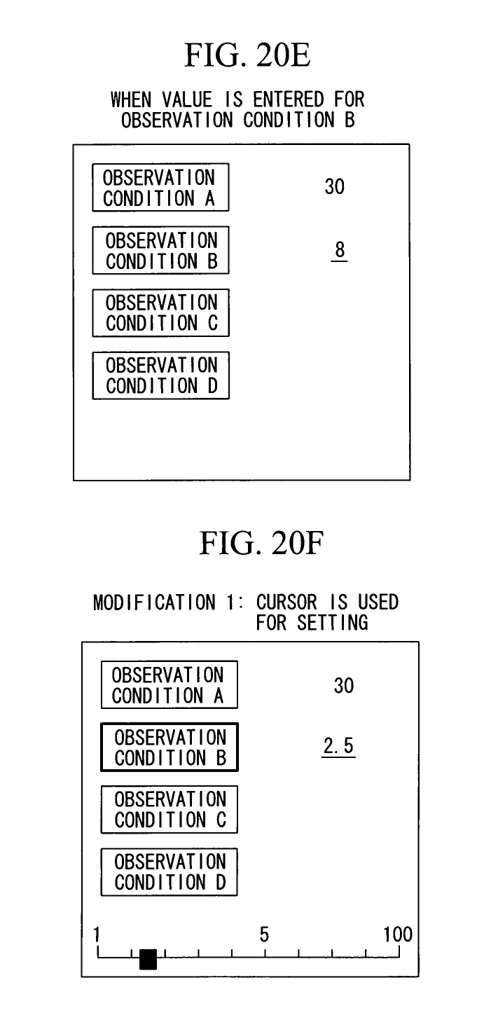

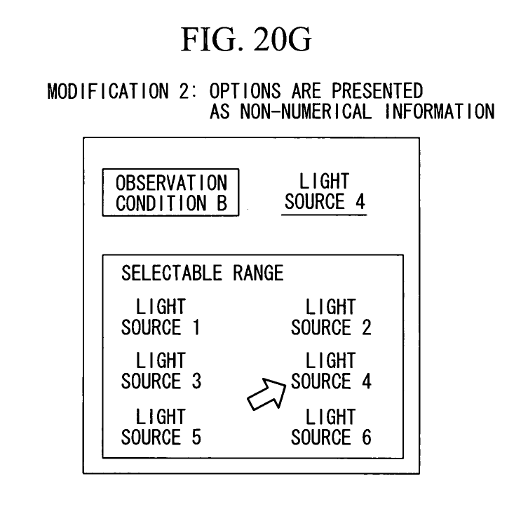

(2) Example where some numerical values for observation conditions are input freely, and other numerical values are selected (FIGS. 19A, 19B, and 20A to 20G)

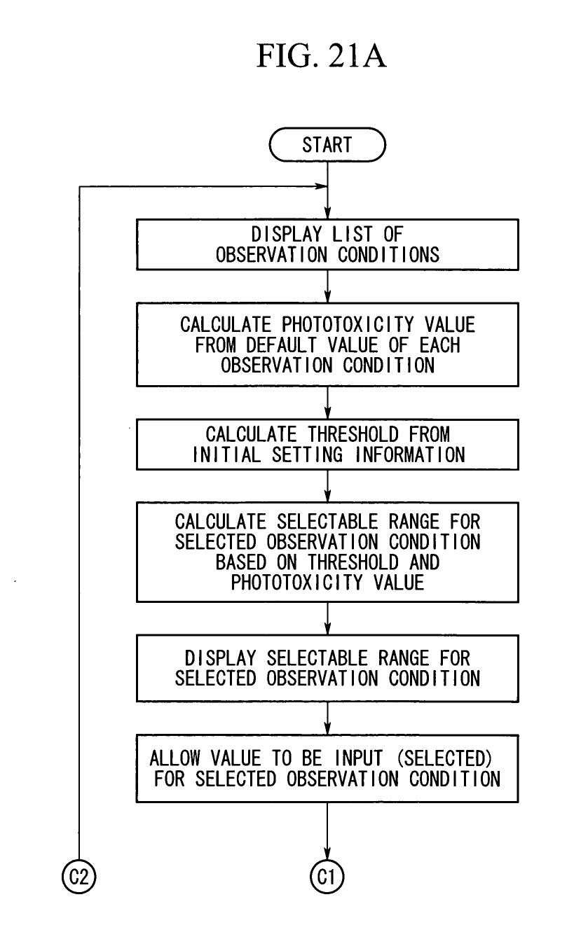

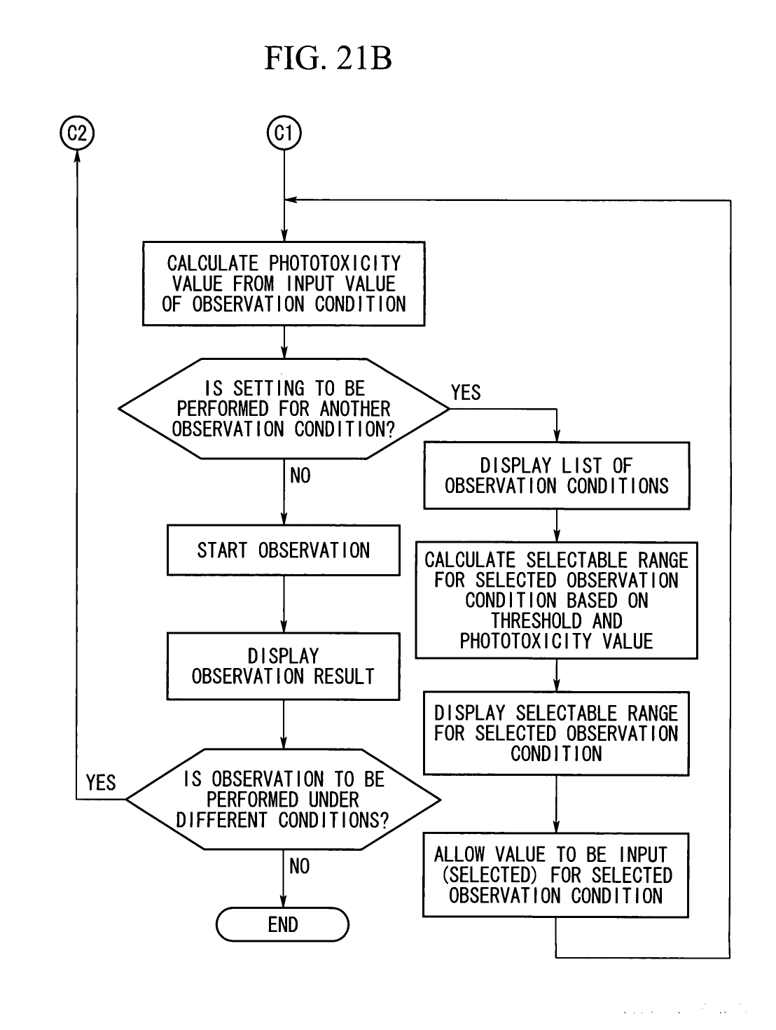

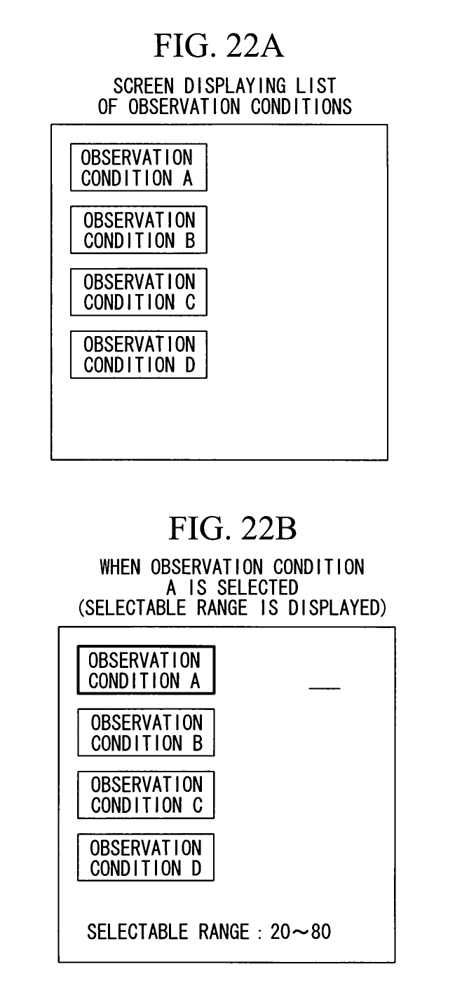

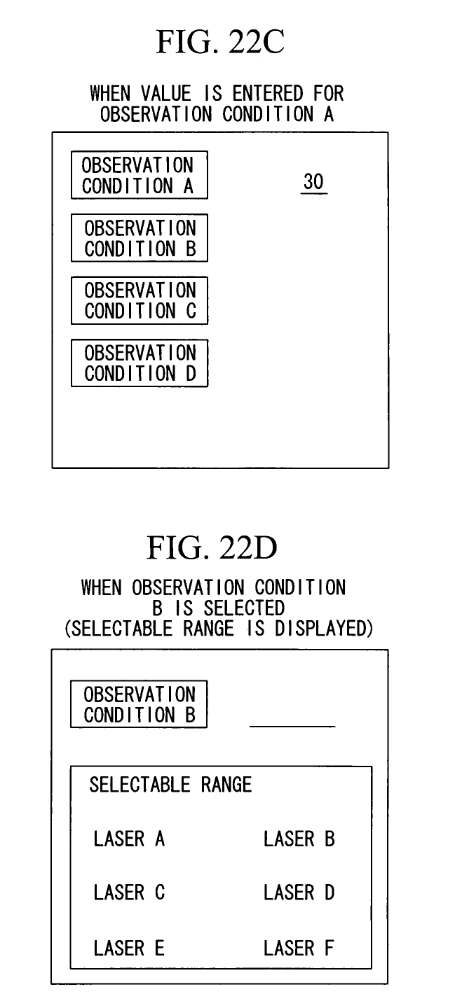

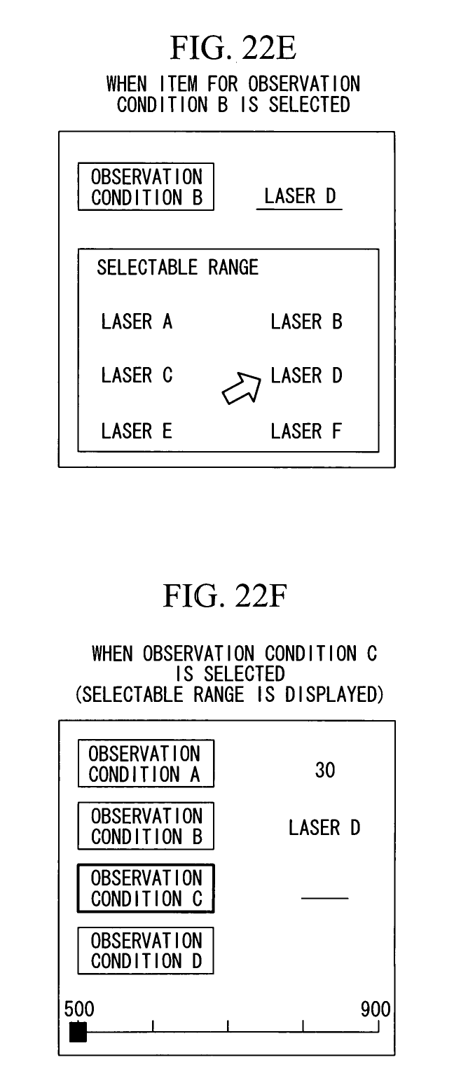

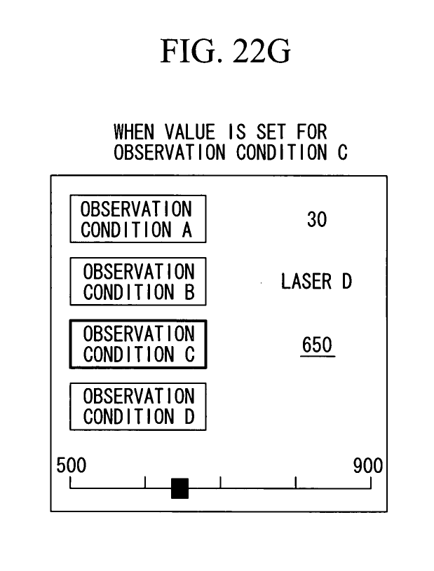

(3) Example where all numerical values for observation conditions are selected (FIGS. 21A, 21B, and 22A to 22G)

2. Examples where an observation result is fed back (optical information)

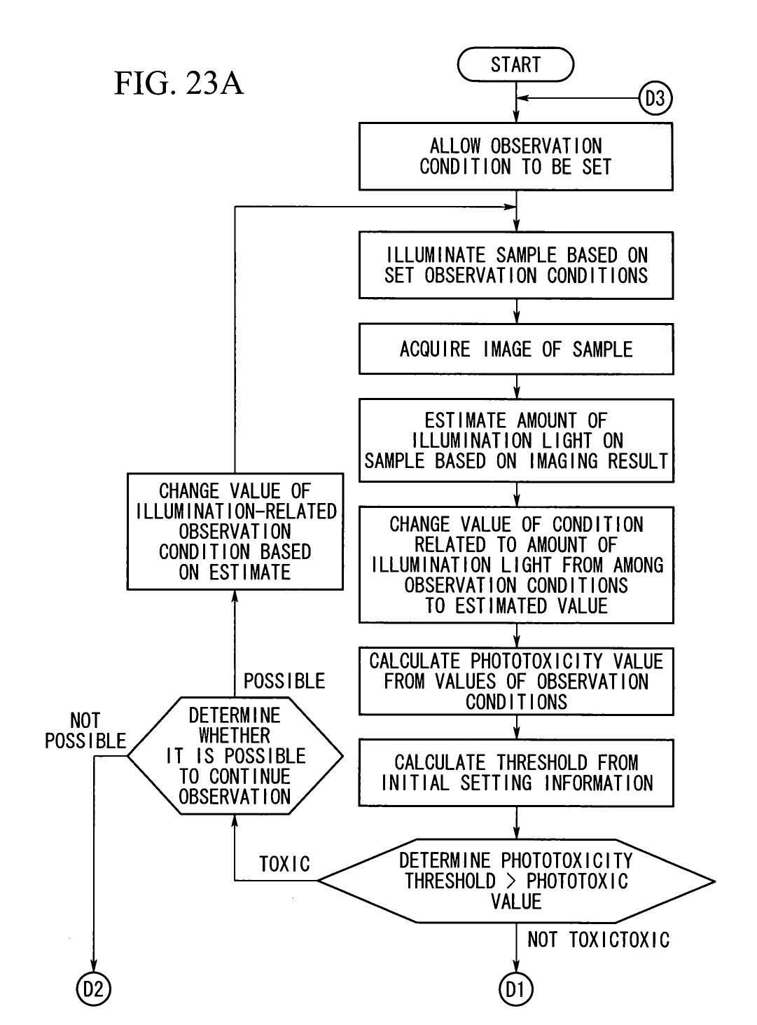

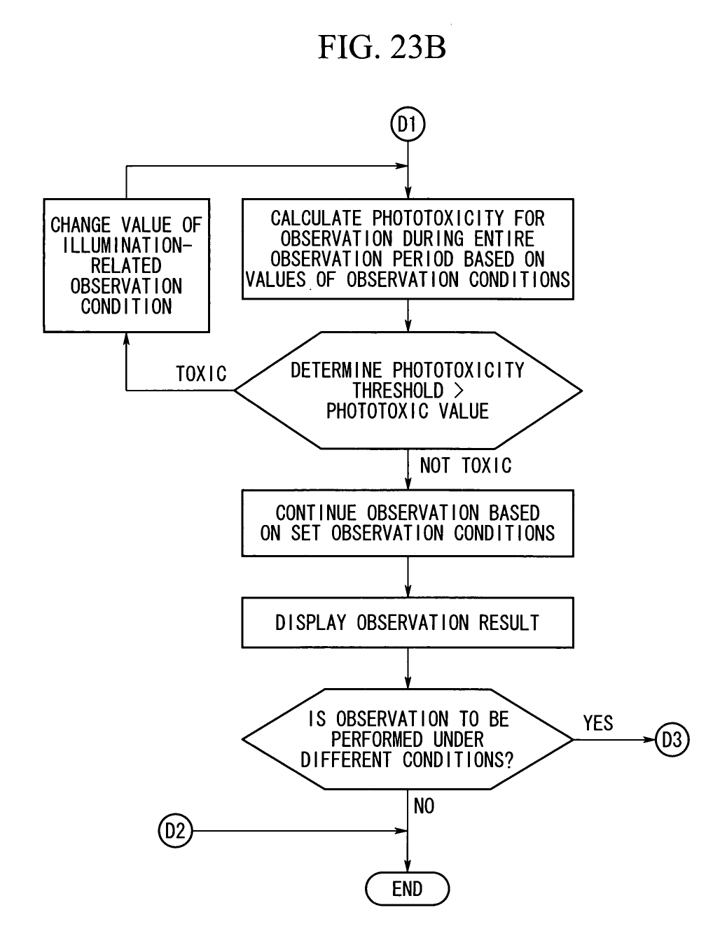

(1) Only the initial observation result is fed back (effective for techniques other than fluoroscopy) (FIGS. 23A and 23B)

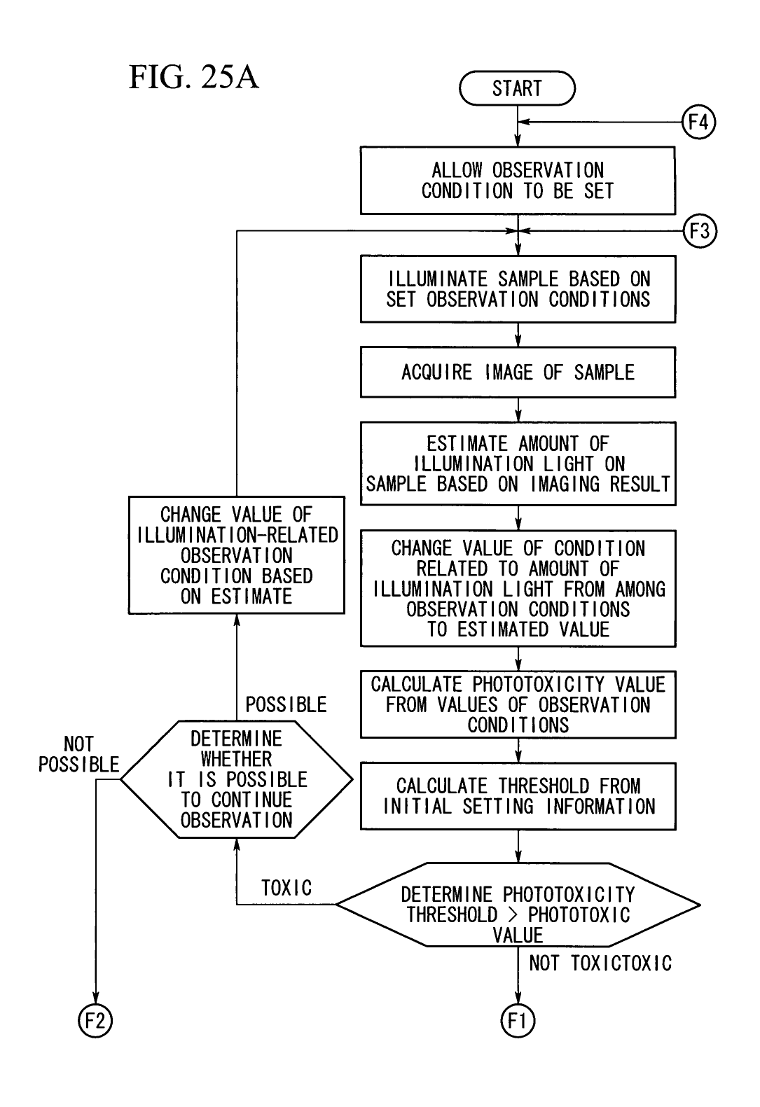

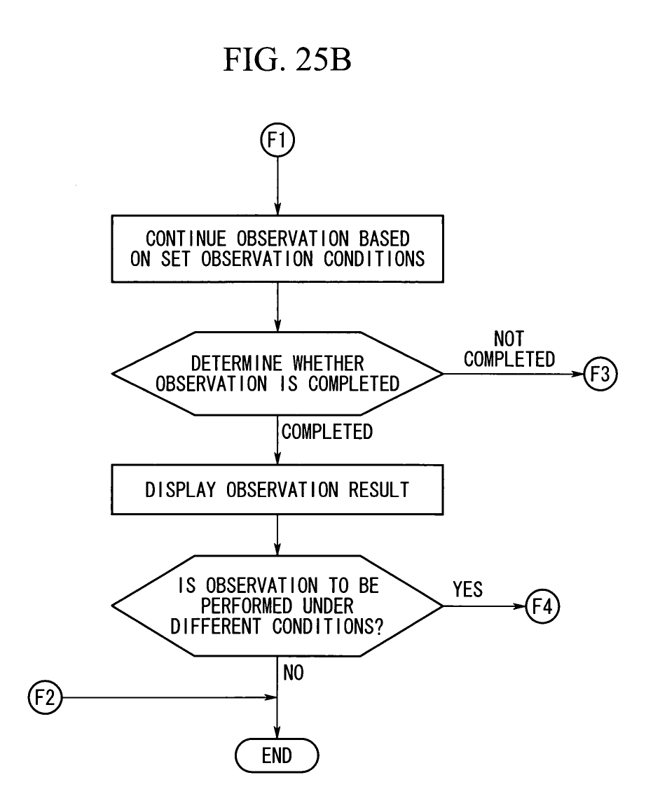

(2) An observation result is fed back every time (FIGS. 25 to 27)

3. Example where an observation result is fed back (cell activity information)

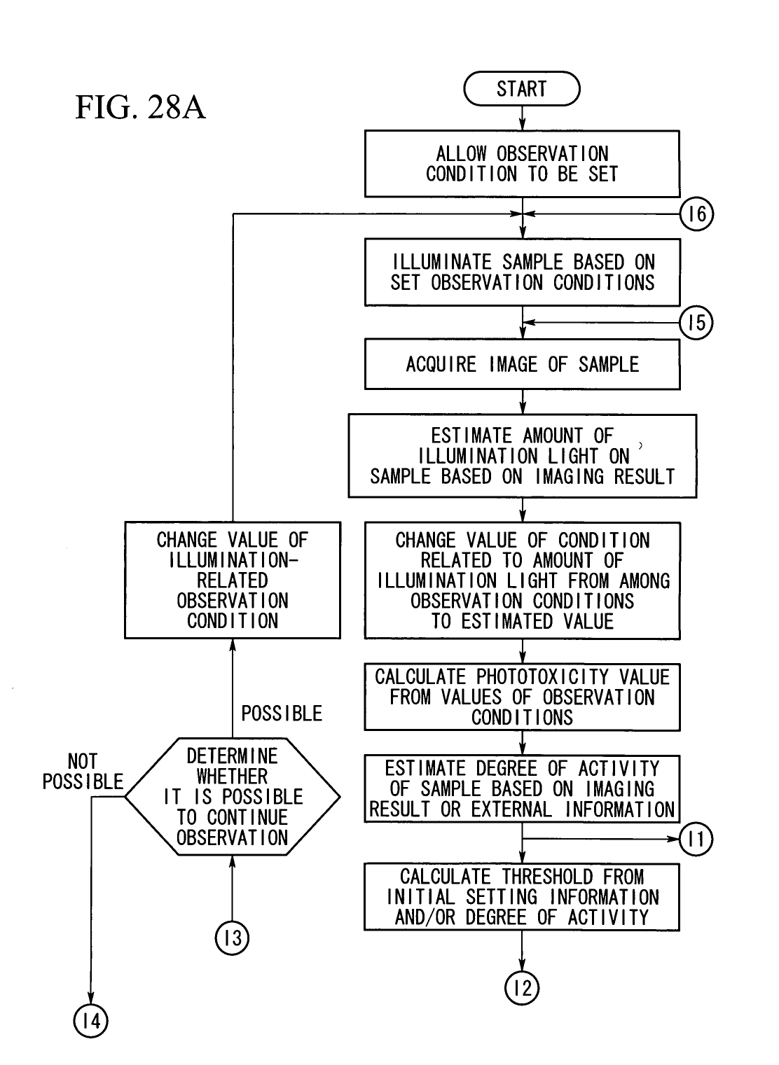

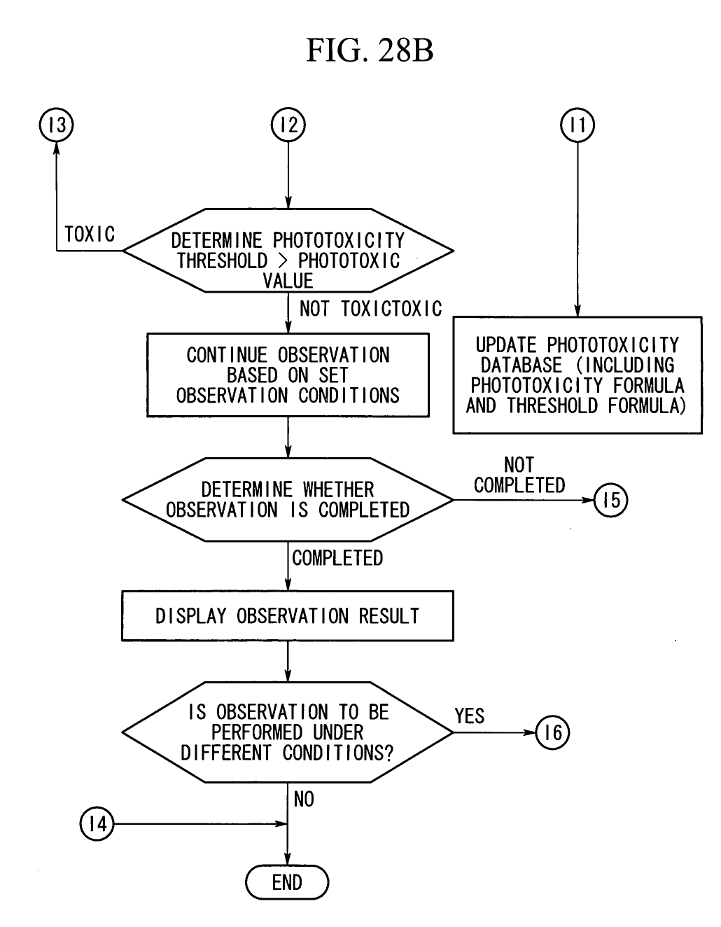

(1) An observation result is fed back every time (FIGS. 28A and 28B)

4. Example where an observation result is fed back (fluorescence fading information)

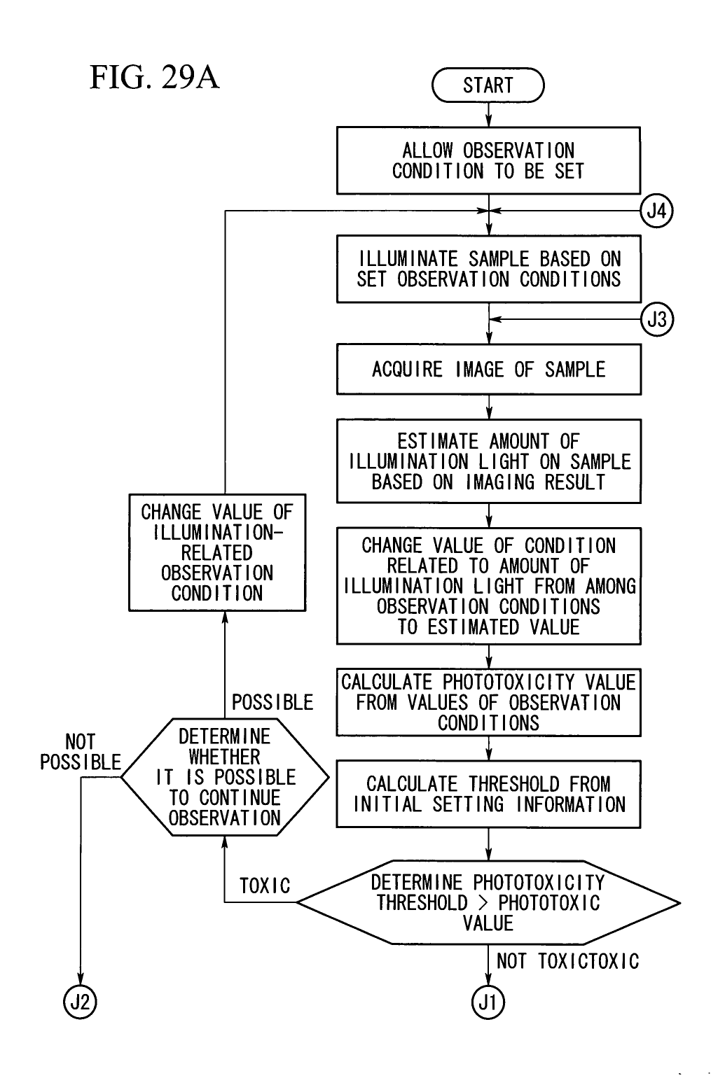

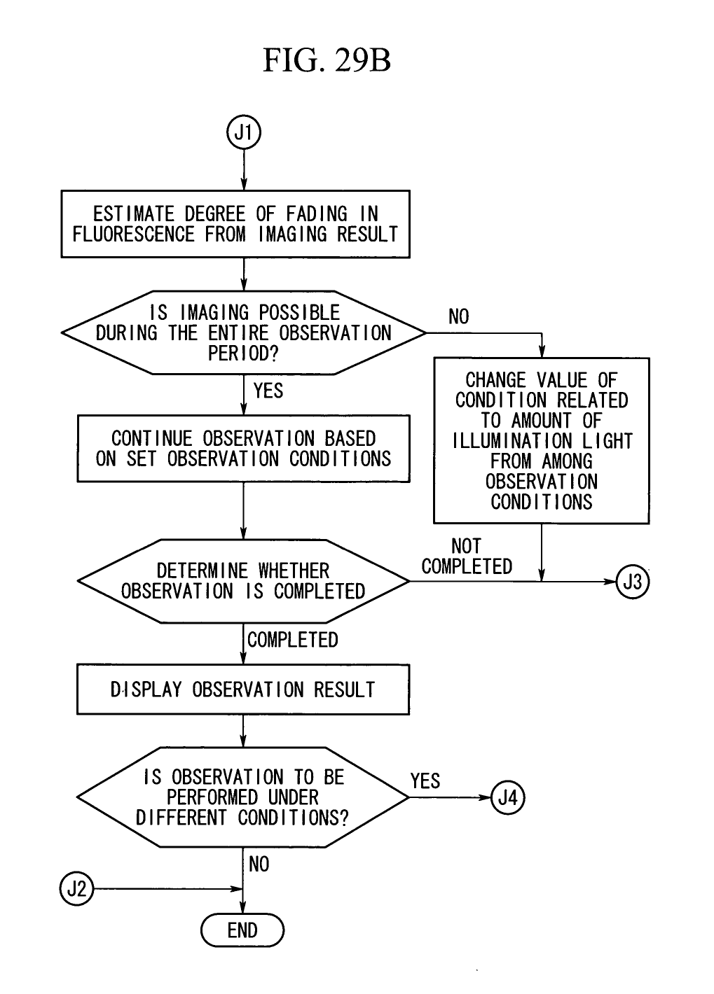

(1) An observation result is fed back every time (FIGS. 29A and 29B)

1. Examples Where No Observation Result is Fed Back

(1) Example Where All Numerical Values for Observation Conditions are Input Freely (FIGS. 17A, 17B, and 18A to 18H)

FIGS. 17A and 17B show a flowchart. Initial setting of hardware information, fluorochrome information, living tissue information, etc. is assumed to have been completed before setting of observation conditions (initial setting information: hardware information, fluorochrome information, living tissue information, etc. whose setting is completed before the setting of observation conditions).

First, the operator starts setting of observation conditions via the user interface 3. Then, the operator inputs a numerical value for one selected observation condition. Here, default values are preset for the rest of the observation conditions. Therefore, when one observation condition value is set, a phototoxicity value is calculated based on the set value and the default values. A default value is, for example, a minimum value of each observation condition. Alternatively, a default value may be a value determined with reference to data obtained through observation carried out in the past.

The input value is sent to the phototoxicity-value arithmetic section 22, which then calculates a phototoxicity value. Calculation of a phototoxicity value may be based on the above-described unique expression or based on the database including observation conditions and phototoxicity values. Furthermore, the degree of activity is calculated in the activity arithmetic section 23. Thereafter, a threshold is set for the phototoxicity value in the central control section 2. A determination is made as to phototoxicity using the set threshold and the phototoxicity value in the determination section 21. If a toxic determination is made in the determination section 21, the central control section 2 displays a warning to request the operator to re-enter an observation condition. On the other hand, if a non-toxic determination is made in the determination section 21, the central control section 2 prompts the operator to select whether to perform setting (control) of another observation condition. If an observation condition is to be set again, the flow returns to display of a list. If setting is not to be performed, measurement is started. An observation result may be displayed by the time observation ends, or alternatively, an observation result may be analyzed and displayed in a real-time manner.

FIGS. 18A to 18G show examples of actual setting screens in order (FIG. 18H shows an example of a modification). A screen for inputting observation condition A, a screen for inputting observation condition B, a screen displayed when the determination section 21 makes the determination “toxic,” and a screen when an observation condition is input again are shown.

(2) Example Where Some Numerical Values for Observation Conditions are Input Freely, and Other Numerical Values are Selected

FIGS. 19A and 19B show a modification to the flowchart shown in FIGS. 17A and 17B. Some observation conditions are input freely, and other observation conditions are selected from a list. By allowing some observation conditions to be selected, the repeated process of setting an observation condition, determining the phototoxicity, and setting an observation condition again can be avoided. As a result, when observation conditions that do not cause deterioration in the activity of living cells are to be set, the operator can perform this operation in a shorter period of time.

When selection is performed, a selectable range, such as a list, is preferably displayed. The selectable range may be calculated based on a unique expression or calculated from a database including observation conditions and phototoxicity values. Furthermore, such a selectable range may be derived from a database that records combinations of observation conditions that do not cause deterioration in the activity of living cells.

In the current example, a determination is made as to phototoxicity each time an observation condition is set. For an observation condition to be set, a selectable range is determined based on phototoxicity values obtained from observation conditions that have been previously set. For example, assume that observation condition B (imaging interval) is set as an observation condition after observation condition A (e.g., dose of a single irradiation) has been set. In this case, a value for the dose of a single irradiation (observation condition A) is set before the imaging interval (observation condition B) is set. Therefore, a phototoxicity value associated with the dose of a single irradiation (observation condition A) can be obtained first. At this time, the phototoxicity value calculated from the dose of a single irradiation (observation condition A) is used to obtain phototoxicity for the imaging interval. More specifically, if the phototoxicity value for the dose of a single irradiation is below the threshold, a numerical range within which the imaging interval can be selected is obtained from the difference between the phototoxicity value and the threshold and is then displayed.

The dose of a single irradiation can be obtained from the duration of a single irradiation and the amount of light radiated onto the living specimen. A phototoxicity value is obtained from the dose of a single irradiation. If the phototoxicity value is larger than the threshold, the operator is prompted to change a value related to observation condition A, that is, the value for the duration of a single irradiation or the amount of light radiated onto the living specimen. If the phototoxicity value is smaller than the threshold, a selectable numerical range is obtained and displayed for the imaging interval (observation condition B). In this manner, the operator is prompted to set a numerical value for the imaging interval.

By doing so, the phototoxicity value can be evaluated for each observation condition value in association with other observation conditions the have been already set. This approach is advantageous in that the operator can easily be prompted if he or she has set an inappropriate value for an observation condition.

FIGS. 20A to 20E show examples of actual setting screens (FIGS. 20F and 20G show modifications). As shown in “WHEN OBSERVATION CONDITION B IS SELECTED,” the operator is relieved from a complicated operation as a consequence of a selectable range being displayed. In FIG. 20D, although the selection range is displayed as “SELECTABLE RANGE: 1˜10,” it may be displayed as “SELECTABLE RANGE: 1, 2, 3, . . . 10.” Alternatively, the operator may also be allowed to specify an observation condition value by sliding a pointer (black box), as shown in MODIFICATION 1 of FIG. 20F. Furthermore, if observation conditions are presented in a non-numerical form, they may be displayed in the form of characters, as shown in MODIFICATION 2 of FIG. 20G, so that an observation condition can be selected using a cursor.

(3) Example Where All Numerical Values for Observation Conditions are Selected

FIGS. 21A, 21B, and 22A to 22G are modifications to FIGS. 19A, 19B, and 20A to FIG. 20G, respectively. In these modifications, all observation conditions are selected. By allowing all observation conditions to be selected, the repeated process of setting an observation condition, determining phototoxicity, and setting an observation condition again can be avoided. As a result, when observation conditions that do not cause deterioration in the activity of living cells are to be set, the operator can perform this operation in an even shorter period of time.

2. Examples Where an Observation Result is Fed Back (Optical Information)

(1) Only the Initial Observation Result is Fed Back (Effective for Techniques Other Than Fluoroscopy)

FIGS. 23A and 23B show an example of a function for obtaining the amount of illumination light based on the initial observation result. (It is assumed that the amount of illumination light, the amount of irradiation light, and the amount of light entering the imaging device are represented as a radiant quantity or a luminous quantity, which has been defined in the earlier description of the “amount of light.”) Furthermore, the duration of a single irradiation may also be obtained.

As shown in the flowchart of FIGS. 23A and 23B, according to the present structure, a phototoxicity value is calculated after the steps “ILLUMINATE SAMPLE BASED ON SET OBSERVATION CONDITIONS,” “ACQUIRE IMAGE OF SAMPLE,” “ESTIMATE AMOUNT OF ILLUMINATION LIGHT BASED ON IMAGING RESULT,” and “CHANGE VALUE OF CONDITION RELATED TO AMOUNT OF ILLUMINATION LIGHT FROM AMONG OBSERVATION CONDITIONS TO ESTIMATED VALUE.”

If a determination is made as “NOT TOXIC” after the step “MAKE DETERMINATION AS TO PHOTOTOXICITY,” the step “CALCULATE PHOTOTOXICITY FOR ENTIRE OBSERVATION PERIOD” is carried out. If a determination is still made as “NOT TOXIC,” observation is continued. If a determination is made as “TOXIC” at any of the “determination” points, the step “CHANGE OBSERVATION CONDITION VALUE” is carried out.

The step “ESTIMATE AMOUNT OF ILLUMINATION LIGHT BASED ON IMAGING RESULT” of FIGS. 23A and 23B will be described in detail.

Basic illumination conditions required for imaging do not change particularly for transmission observation or reflected light observation. Therefore, illumination-related observation conditions of the observation conditions for the entire observation period can be applied to the entire observation period by using the result of one imaging operation.

The photoelectric conversion characteristics of the imaging device in the imaging unit 12 are known. Therefore, the amount of light entering the imaging device is found from the output and photoelectric conversion characteristics of the imaging device. Furthermore, since the transmittance of the optical system is known, the amount of illumination light on the sample can be estimated from the transmittance of the optical system and the amount of light entering the imaging device.

If the acquired entire image of the sample is not too dark or too bright, the amount of illumination light on the sample can be determined as appropriate. Therefore, from among the observation conditions that were set initially, no change is made to the “observation condition related to the amount of illumination light.” On the other hand, if at least part of the acquired image is too dark or too bright, no accurate observation is expected. If this is the case, the amount of illumination light that would be appropriate is estimated from the entire acquired image. Thereafter, the value of the observation condition related to the amount of illumination light is changed to the estimate.

By doing so, an appropriately bright image (an image taking full advantage of the dynamic range of the imaging device) can be produced. The observation condition related to the amount of illumination light that has been obtained in this manner does not always exhibit a low phototoxicity value. For this reason, a phototoxicity value is calculated including other observation conditions to make a determination as to phototoxicity.

The amount of illumination light on the sample is “the amount of light radiated onto the living specimen.” Therefore, the amount of illumination light on the sample constitutes the observation conditions and is therefore one of those to be controlled. The observation conditions that were set initially are assigned values that can produce a certain level of image. Thus, it is assumed that only images that allow the amount of illumination light to be estimated are produced.

Although the amount of illumination light has been estimated using the imaging device itself in this example, the amount of light emitted from the light source or the amount of light on the sample surface may be monitored directly in another light path.

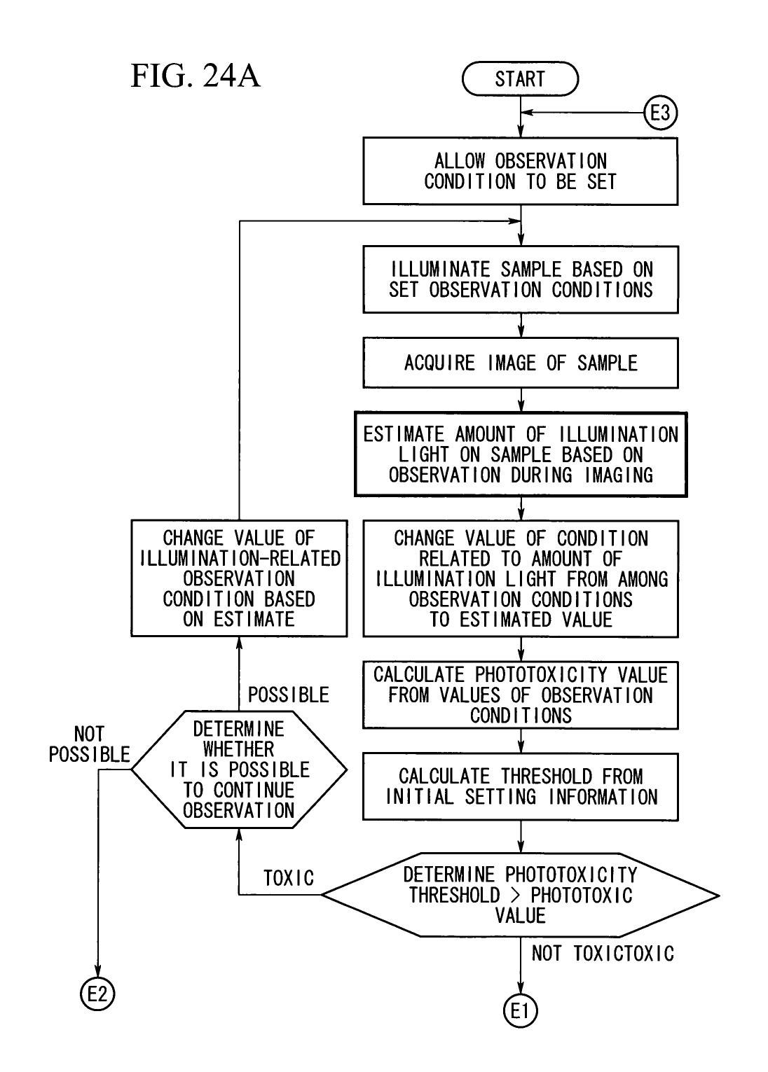

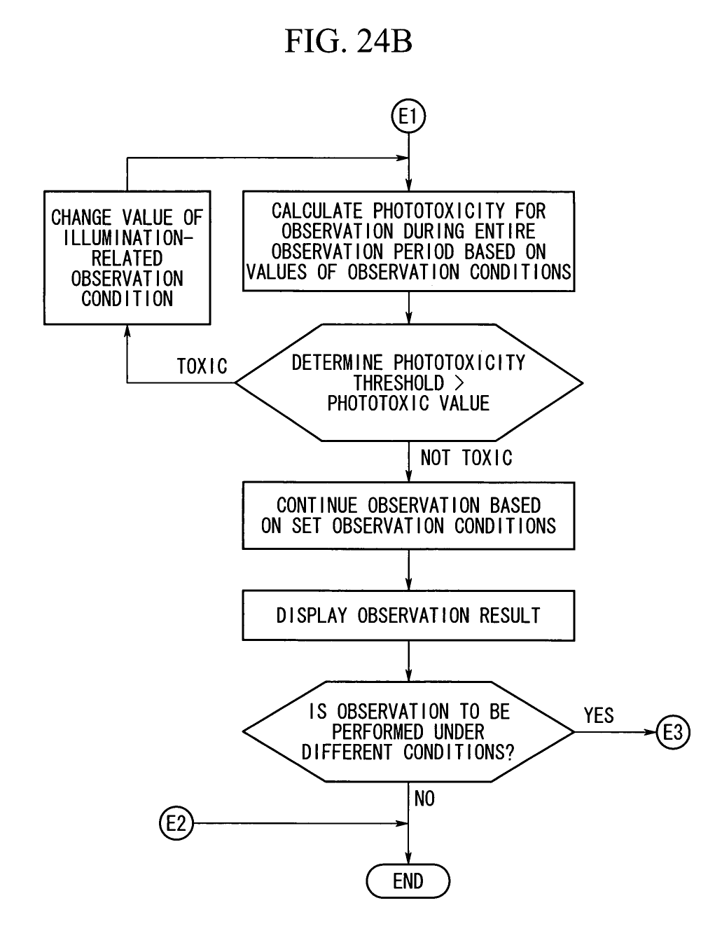

Although the foregoing example has been described by way of the step “ESTIMATE AMOUNT OF ILLUMINATION LIGHT BASED ON IMAGING RESULT,” the step “ESTIMATE AMOUNT OF ILLUMINATION LIGHT BASED ON OBSERVATION DURING IMAGING” shown in FIG. 24 may be carried out instead. The changed step is enclosed by a thick frame.

The imaging device of the imaging unit 12 is used to acquire an image of the sample. However, the imaging device of the imaging unit 12 can be used for photometry, as well as for imaging. For example, assume that the imaging device is realized by a CCD. The time to (output) read charge from the CCD is appropriately selected and charge is read at that charge-readout time. By doing so, a change in charge over time can be found out. Then, the time until an appropriately bright image is obtained or the amount of light entering the CCD can be estimated from the change in charge over time. As a result, an irradiation time and the amount of light that would be appropriate can be estimated.

By doing so, an irradiation time and the amount of light that would be appropriate can be estimated without completing photometry, and therefore, observation conditions can be set in a short period of time. If it is all right to take time, photometry may be continued to the end. If this is the case, an irradiation time and the amount of light that would be appropriate are not estimated but are actually determined. Therefore, the observation condition related to the amount of illumination light can be set more accurately than in the case of FIGS. 23A and 23B. In the above-described example, the imaging device itself has been used for photometry. A photodetector may be provided separately from the imaging device, however.

The amount of illumination light on the sample is determined according to the transmittance of the optical system and the light source. The amount of light emitted from the light source changes over time due to, for example, deterioration in the filament and arc. Therefore, it is preferable that data for a time-lapse change in the amount of light emitted from the light source be prepared. Observation is carried out using this data and the above-described estimate. By doing so, the observation condition related to the amount of illumination light can be estimated more appropriately during the entire observation period. As a result, an observation result with high reliability can be obtained.

Through the above-described approach, illumination conditions can be predicted and phototoxicity can be estimated for the entire observation period by the use of one imaging operation. Therefore, the activity of the living specimen can be maintained for observation at such a level that does not adversely affect the observation result. Consequently, an observation result with high reliability can be obtained.

This example may also be used for fluoroscopy, assuming that no fading occurs and the intensity of excitation light is directly proportional to the intensity of fluorescence.

(2) An Observation Result is Fed Back Every Time

FIGS. 25A and 25B show a modification to the flowchart in FIG. 23. In this example, the step “ESTIMATE AMOUNT OF ILLUMINATION LIGHT BASED ON IMAGING RESULT” in FIGS. 23A and 23B is carried out every time during the entire measurement period. Since an imaging result is used every time, the observation condition related to the amount of illumination light can be estimated more accurately than in the example shown in FIGS. 23A and 23B. As a result, an observation result with even higher reliability can be obtained.

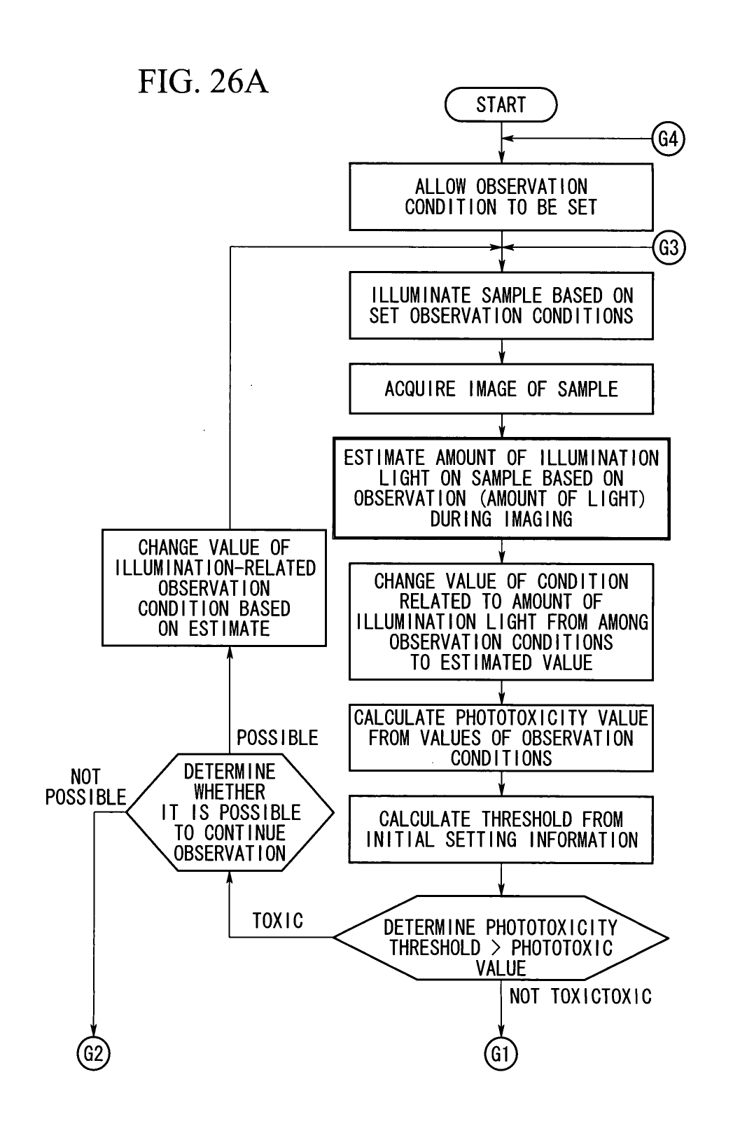

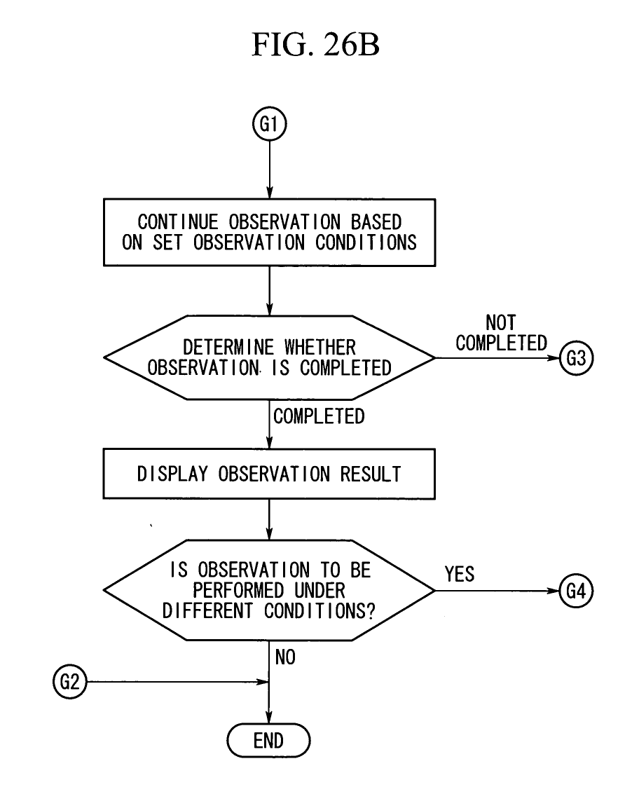

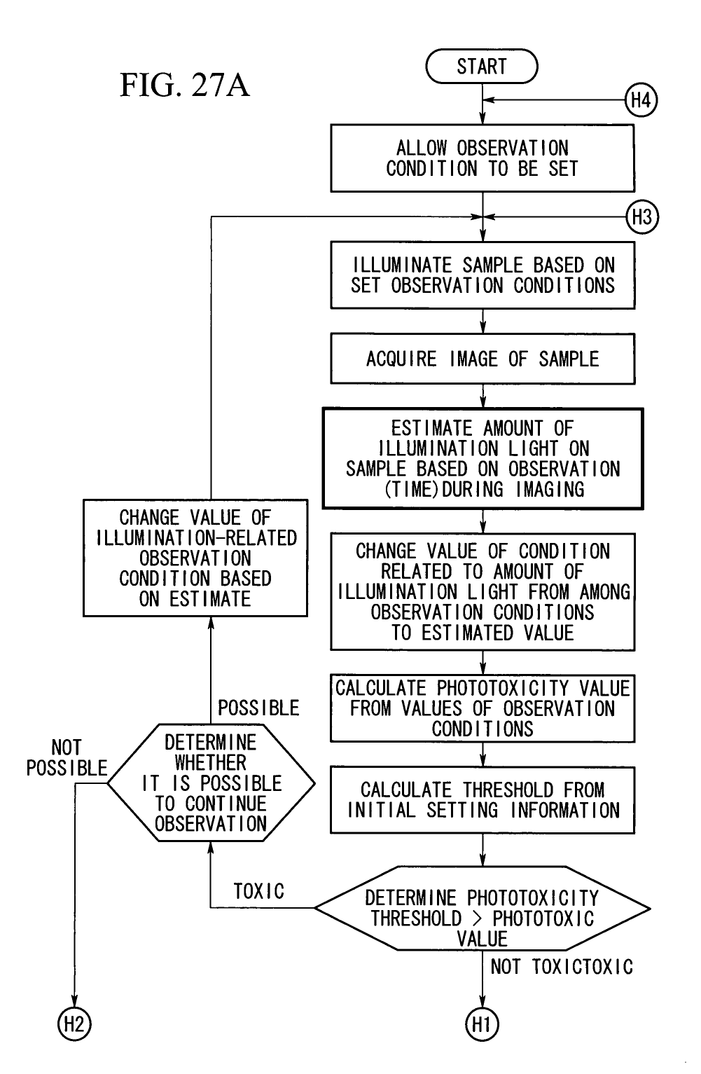

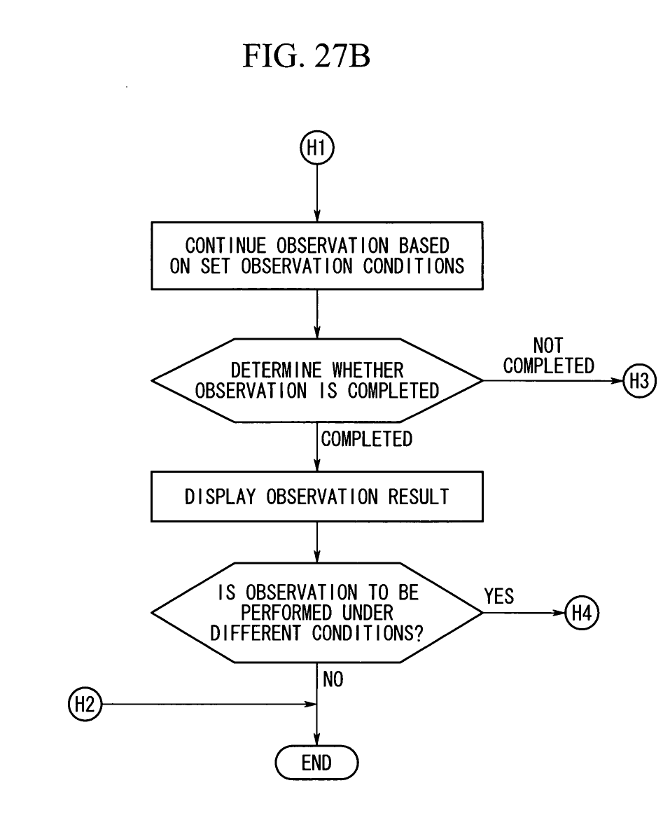

FIGS. 26 and 27 are modifications to the flowchart in FIGS. 25A and 25B. The changed steps are enclosed by a thick frame.

The modification shown in FIGS. 26A and 26B is effective particularly for fluoroscopy. In fluoroscopy, the amount of fluorescence emitted from the living cell changes greatly over time. Therefore, the following approaches are conceivable to take full advantage of the dynamic range of the imaging device:

The duration of a single observation is changed during the entire observation period.

The amount of illumination light is changed during the observation period based on observation during imaging.

Particularly in fluoroscopy, it is not recommended to estimate an optimal amount of illumination light from an imaging result (a result after imaging is completed) as shown in FIGS. 25A and 25B. This point will be described below. In fluoroscopy, the amount of fluorescence may change greatly over time, as described above. In observation for the purpose of obtaining an estimate under this condition, the amount and the time of light radiated onto the living cells need to be restricted to minimum required values. Otherwise, there is possibility of a large difference occurring in the degree of activity of living cells between observation for the purpose of obtaining an estimate and the subsequent observation (formal observation). Furthermore, irradiation light may cause fading of fluorescence. Irradiation during observation for the purpose of obtaining an estimate may advance fading too considerably to achieve sufficient fluorescence in the subsequent observation.

Modifications to avoid this drawback, as shown in FIGS. 26 and 27, allow the amount and time of light radiated onto the living cells to be minimized. The time until an appropriately bright image is obtained (the duration of a single observation in FIGS. 27A and 27B) or the amount of light entering the CCD (the amount of illumination light in FIGS. 26A and 26B) can be estimated. Therefore, the activity of the living specimen can be maintained for observation at such a level that does not adversely affect an observation result. Furthermore, since the observation condition related to the amount of illumination light is estimated every time, observation can be carried out under more appropriate observation conditions. Therefore, an observation result with high reliability can be obtained.

By doing so, the operator is prevented from providing unwanted settings, and therefore, living cells can be imaged under optimal observation conditions. In addition, observation can be carried out without worrying about, for example, a change in morphological characteristics of living cells due to unwanted photostimulation.

3. Example Where an Observation Result is Fed Back (Sample Activity Information)

FIGS. 28A and 28B show an example where the activity of a sample is actually measured and the measurement result is fed back to the observation conditions. The example of FIGS. 28A and 28B differs from the example of FIGS. 25A and 25B in the following three points:

The step “ESTIMATE DEGREE OF ACTIVITY OF SAMPLE BASED ON IMAGING RESULT OR EXTERNAL INFORMATION” is additionally provided between the step of calculating a phototoxicity value and the step of calculating a threshold.

The step of calculating a threshold is changed to the step “CALCULATE THRESHOLD FROM INITIAL SETTING INFORMATION AND/OR DEGREE OF ACTIVITY.”

The step “UPDATE PHOTOTOXICITY DATABASE (INCLUDING PHOTOTOXICITY FORMULA AND THRESHOLD FORMULA)” is added.

Means for obtaining external information will be described below.

The culture unit 19 includes the activity monitoring unit 18 (refer to FIG. 1). This activity monitoring unit 18 is disposed near a particular cell culture area. The particular cell culture area in the current description refers to a culture area provided separately from the living cells to be measured. This particular cell culture area is irradiated with light under the same conditions as those for the living cells to be measured.

In evaluating the activity, a determination may be made based on observation of the morphology or using an activity reagent. For morphology observation, a technique such as the phase contrast technique or the differential interference technique can be used. In representing the activity in the form of a numerical value, the operator may determine a numerical value based on the morphology of the sample or the system may determine a numerical value by analyzing a time-lapse change in the morphology of an acquired image through image processing. If a reagent is used, the degree of activity can be represented in the form of a numerical value by converting the absorbance into the degree of activity (e.g., a value from 0 to 1).

The activity monitoring unit 18 outputs observation information to the activity arithmetic section 23. The activity arithmetic section 23 “estimates the degree of activity of the sample” based on the input information. Then, the central control section 2 performs the step of “calculating a threshold from the degree of activity.” This threshold may be a threshold for the degree of activity. In this example, however, a determination as to phototoxicity is made based on a threshold and a phototoxicity value in the subsequent step. Therefore, a threshold for the phototoxicity value is eventually calculated.

As described above, in this example, the degree of activity can be estimated based on external information to calculate a threshold. Therefore, the degree of activity can be obtained more accurately than in the case where the degree of activity is obtained only from the initial setting information. This leads to a more accurate threshold. Consequently, a determination as to phototoxicity can be made more accurately. Therefore, an observation result with high reliability can be obtained. Furthermore, observation conditions can be reviewed, as required, at an intermediate point during the period of measurement to control the observation conditions more appropriately.

The numerical data of evaluated activity may be fed back to update the database (including the phototoxicity formula and the threshold formula) stored in the data storage memory 9.

In addition, observation may be continued according to the determination by the operator, irrespective of whether a “phototoxic” determination is made. A determination as to whether or not to continue measurement is made by the operator. For example, at the time of setting of the imaging interval, whether or not to abort measurement if a permissible value is exceeded can be specified.

4. Examples Where an Observation Result is Fed Back (Fluorescence Fading Information)

(1) An observation result is fed back every time (FIGS. 29A and 29B)

Fluorochrome fades due to light. As a result, in many cases, the amount of fluorescence (the amount of light) emitted from the sample decreases over time. Although fading itself is not related directly to phototoxicity, fading sometimes makes it difficult to acquire a fluorescence image. To overcome this drawback, it is preferable to make observation possible during the entire observation period by checking the degree of fading in fluorescence.

The embodiment shown in FIGS. 29A and 29B includes the loop of estimating the degree of fading from an imaging result and changing observation conditions based on the estimation result. The degree of fading can be represented as follows, for example:
Degree of fading=amount of fluorescence during observation/initial amount of fluorescence.

The initial amount of fluorescence is estimated from the initial setting conditions and observation conditions. It should be noted, however, that a more accurate initial amount of fluorescence can be obtained by acquiring an image before observation is started and determining an initial amount of fluorescence based on the acquired image.

Alternatively, the degree of fading may be represented as follows:

Degree of fading=amount of fluorescence in the n-th observation/amount of fluorescence in the (n−1)-th observation. If this expression is applied, the amount of fluorescence in the 0-th observation (used for the first observation)=the initial amount of fluorescence.

Observation conditions (relationship between the amount of illumination light and the duration of a single irradiation, the continuity of irradiation light (pulse length or frequency), etc.) are changed from the observed degree of fading so that observation conditions that less adversely affect fading are achieved.

Although a threshold and a phototoxicity value are set by the apparatus in the above-described example, these items may be set by the operator. By doing so, measurement in accordance with the operator's objective can be carried out.

As described above, according to the living-cell observation and measurement system of this embodiment, the living specimen can be observed and measured for an extended period of time without damaging cell activity by controlling factors that damage the activity of the living specimen.

What is claimed is:

1. A living-specimen observation and measurement system configured to store a predetermined observation condition and control the predetermined observation condition based on an activity of a living specimen.

2. The living-specimen observation and measurement system according to claim 1, wherein the predetermined observation condition and a degree of contribution thereof are included in a database.

3. The living-specimen observation and measurement system according to claim 2, wherein a combination of a plurality of the predetermined observation conditions is included in the database.

4. The living-specimen observation and measurement system according to claim 3, wherein the database further includes a phototoxicity value.

5. The living-specimen observation and measurement system according to claim 1, further comprising a function for obtaining a phototoxicity value based on the stored predetermined observation condition.

6. The living-specimen observation and measurement system according to claim 5 configured to obtain the phototoxicity value based on a unique expression.

7. The living-specimen observation and measurement system according to claim 6, wherein the unique expression includes a function having at least two of a wavelength of irradiation light, a duration of a single irradiation, an amount of light radiated onto the living specimen, an irradiation interval, a number of irradiations, and continuity of irradiation light.

8. The living-specimen observation and measurement system according to claim 1, further comprising a function for converting the activity into a numerical value.

9. The living-specimen observation and measurement system according to claim 1, further comprising a function for determining phototoxicity.

10. The living-specimen observation and measurement system according to claim 9 configured to determine the phototoxicity based on a determination criteria set by an operator.

11. The living-specimen observation and measurement system according to claim 9, wherein a measurement history of a previous observation condition and a value of the phototoxicity is stored, and a criteria for determining the phototoxicity is updated based on the measurement history.

12. The living-specimen observation and measurement system according to claim 1, wherein the predetermined observation condition includes observation-related information.

13. The living-specimen observation and measurement system according to claim 1, wherein the predetermined observation condition includes a combination of a dose of a single irradiation and a total irradiation dose.

14. The living-specimen observation and measurement system according to claim 1, wherein the predetermined observation condition includes an irradiation time.

15. The living-specimen observation and measurement system according to claim 1, wherein the predetermined observation condition includes an irradiation interval.

16. The living-specimen observation and measurement system according to claim 1, wherein the predetermined observation condition includes illuminance.

17. The living-specimen observation and measurement system according to claim 1, wherein the predetermined observation condition includes a pulse frequency or a pulse width of irradiation light.

18. The living-specimen observation and measurement system according to claim 1, wherein the predetermined observation condition includes an irradiation area.

19. A living-specimen observation and measurement system comprising:
a culture unit configured to hold a living specimen;
an illumination unit configured to guide irradiation light to the culture unit;
an imaging unit configured to acquire an image of the culture unit; and
a processing unit including a storage section for storing an acquired image or a predetermined observation condition, an arithmetic section, and a control section for controlling the culture unit, the illumination unit, and the imaging unit, wherein
the arithmetic section executes the step of obtaining a degree of activity of the living specimen, the step of obtaining a phototoxicity value based on the predetermined observation condition, and the step of obtaining a threshold, and
the control section controls at least one of the culture unit, the illumination unit, and the imaging unit based on the threshold.

20. The living-specimen observation and measurement system according to claim 19, wherein the predetermined observation condition includes at least one of information about the culture unit, information about the illumination unit, and information about the imaging unit.

21. A living-specimen observation and measurement system for observing a living specimen by controlling a predetermined observation condition, wherein
the predetermined observation condition is set so as to produce a phototoxicity value smaller than a threshold obtained from an activity of the living specimen.

22. A living-specimen observation and measurement method comprising storing a predetermined observation condition and controlling the predetermined observation condition based on an activity of a living specimen.

23. The living-specimen observation and measurement method according to claim 22 comprising:
obtaining a degree of activity of the living specimen;
obtaining a phototoxicity value based on the predetermined observation condition;
controlling the predetermined observation condition based on the degree of activity and the phototoxicity value; and
observing the living specimen.
